(19) United States
(12) Patent Application Publication
(10) Pub. No.: US 2010/0159427 A1
(43) Pub. Date: Jun. 24, 2010

(54) Gates of Power™ Method

(76) Inventor: Nomi Bachar, Peekskill, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/637,603

(22) Filed: Dec. 14, 2009

Related U.S. Application Data
(60) Provisional application No. 61/203,545, filed on Dec. 23, 2008.

(51) Int. Cl. G09B 19/00

(52) U.S. Cl. 434/236

(57) ABSTRACT

A curriculum and method for self-transformation and self-actualization comprising a body of information, processes and exercises that cover several of life's most important aspects, called gates, comprising gates of the body, of emotions, of dialog, of creative expression, of life path, of silence, and of knowledge and each gate provides a series of processes and exercises that deepen the awareness of that aspect and its potential to promote well-being, the method serves to identify, understand, and release feelings, attitudes, behaviors, habits, and beliefs that diminish inner power and wholeness, and having a purpose to identify, understand, and reclaim feelings, attitudes, behaviors, habits and beliefs that enhance inner power and wholeness.

### CROSS REFERENCE TO RELATED APPLICATIONS

This application claims priority to U.S. provisional patent application Ser. No. 61/203,545, filed on Dec. 23, 2008, which is fully incorporated herein by reference.

### GENERAL NOTES ABOUT THE METHOD

Gates of Power™ is a curriculum and a method for self-transformation and self-actualization. The term self-actualization is defined as the achievement of one's full potential through creativity, independence, spontaneity, and a grasp of the real world. Self-transformation is the process of transforming psychological, spiritual, and physical limitations into a freer, healthier, life-affirming state of being.

Gates of Power Method is a body of information, processes, and exercises that cover all seven of life's most important aspects. These life aspects are referred to in the Method as “Gates.” The Method is a multi-dimensional learning tool that effectively supports and maximizes the process of self-transformation and self-actualization.

The overall purpose of Gates of Power Method is twofold. On one hand it serves to identify, understand, and release all feelings, attitudes, behaviors, habits, and beliefs that diminish inner power and wholeness. On the other hand, its purpose is to identify, understand, and reclaim all feelings, attitudes, behaviors, habits, and beliefs that enhance inner power and wholeness.

There are seven life aspects defined by the Gates of Power Method. Their chosen names and their order are as follows:

1. The Gate of the Body

2. The Gate of Emotions

3. The Gate of Dialogue

4. The Gate of Creative Expression

5. The Gate of Life Path

6. The Gate of Silence

7. The Gate of Knowledge

In the Method, the seven Gates are organized in a specific order, from the most dense to the most abstract or ethereal. The processes under each Gate build on each other and the knowledge and understanding of each Gate serves as a platform to the next, one. For example, the Gate of the Body leads to a better understanding of the Gate of Emotions. These two lead to the Gate of Dialogue. These three in turn are the basis for the Gate of Creative Expression, etc.

All the Gates are interconnected and complement each other, and their order is crucial to their function. The Gates can also be understood as seven channels or pathways of inner power through which our psyches find expression. A gate is a portal; our inner being flows through these seven Gates and express itself. Since the Gates are also portals for receiving, they are the sites for an exchange between our inner selves and life. Through these Gates we learn, expand, and experience the world around us.

Each Gate provides a series of processes and exercises that deepen the awareness of that aspect and its potential to promote well-being. The exercises and processes within each Gate serve a double purpose: one, to eliminate limiting, negative emotional, mental, and physical patterns; and two, to establish a personal framework that supports self-caring, self-empowerment, and an ability to take full responsibility for all the areas of one's life. The framework is tailored to fit each person and their own specific needs. It helps with building self-esteem, positive outlook, and a sense of purpose.

Gates of Power Method is different and unique in that it is multidimensional. Most psychological or educational processes that deal with self-development use only one to three aspects. By contrast, Gates of Power is a much wider frame of work that involves the use of many more elements, and the result is a total workout for mind, body, and life. Most people tend to dabble first in one method, then another. For example, if they are in therapy, they might not get coaching on achieving their life goals or any training in developing their creativity and expression. They might also go to the gym to cultivate body awareness. What they are actually seeking is a method that integrates deep emotional healing, body work and body awareness, creativity and expression, spiritual connection and life goals achievement. This kind of integrated program is not presently available to the public. The Gates of Power Method was created to answer this need. This Method saves participants time, energy and resources and gives them a complete and thorough workout of mind, body, soul, and life goals, healing the very root of their problems rather than the mere accompanying symptoms.

The seven Gates are interwoven into a holistic process of transformation, the effects of which are powerful due to the method's multifaceted approach. No other cutting-edge self transformation method exists that effectively combines all of these seven approaches into one program. While each aspect has been independently used (or at least combined with one or two other aspects), there has been no mix of all elements working together and attacking the root of the “problem”, healing it from multiple angles, and ultimately having effectively coped with the very source rather than temporarily relieving certain symptoms that will inevitably re-emerge.

The processes used in the Gates of Power method are comprehensive and holistic. They incorporate the body and its movement, physical expression, energy, and sensations. Emotional release and expression techniques are used to release negative emotions and integrate positive ones. Different patterns of inner and outer dialogue are used. All the arts are used: writing, drawing and other art making, sound, and movement. The Method also incorporates goal-achieving processes that use vision boards, time lines for choices, commitments, and actions. There are about twenty-five different exercises that use visualization, guided imagery, and meditational techniques. Different texts from spiritual, psychological, and scientific writings are used as a base for discussion and insight.

In the Gates of Power Method, the psyche is divided into three aspects: the “Emotional Self,” the “Defensive Self,” and the “Expanded Self.” The Method provides guidance in harmonizing and strengthening the self through the understanding of these three parts of the psyche. When we connect to our Expanded Self, we learn to live life from the most healthy and empowered perspective. Our connection with the Expanded Self helps us to accept the Emotional Self as a source of connection, creativity, and joy, and we learn to guide and redirect it so that difficult feelings do not become destructive to ourselves and others. In this way, our emotional power becomes a constructive force in our lives. Our connection with our Expanded Self also helps us to become aware of the Defensive Self and work towards softening its constricting influence. Gates of Power Method uses inner dialogue exercises to help establish a healthy relationship between all three inner parts.

I. Overview of the Gates

1. The Gate of the Body

Within this gate we explore the body, its expression and its energetic patterns through different processes and exercises. We gain awareness of our relationship to our body. We learn to understand the body as a minor of our consciousness. We experience the body as an instrument of creativity and expression.

We are encouraged to find a way to move freely and authentically and enjoy the body's energies and physical abilities. We investigate where and how we block our energy and constrict our aliveness. We find out where chronic tensions, trauma, or unexpressed feelings are being held. We enter these places within our body and bring forth to the surface reopened feelings, memories and beliefs. Once the feelings are expressed and guided we can release the unnecessary and embrace healthy feelings, needs and desires. We explore the connection between mind, feelings and body.

2. The Gate of Emotions

In order to become emotionally healthy and balanced, we need to be able to experience and explore our feelings and express them appropriately. Some find it difficult to stay in touch with the darker feelings like fear, pain, anger or need. Others find love, joy and peace, the lighter feelings difficult to experience or express. We cannot be whole without the ability to experience the full spectrum of our emotional self, from the darkest to the most vibrant feelings. Just as a pianist needs to know how to play all the keys, we need to know how to experience all of our feelings. Emotional integration opens and frees our energy field, removes energetic blockages and allows us to be expressive, creative, and present. The exercises within this Gate encourage emotional openness, integration, and expression.

3. The Gate of Dialogue

The exercises within The Gate of Dialogue help us explore the importance of relating consciously and constructively with ourselves, others, and all living things. Science has shown us that all life is an intricate fabric of subatomic particles, or waves continuously communicating with each other interconnected and interrelated.

Being part of and one with the fabric of life, we are naturally interconnected and interrelated. Unresolved feelings block our energy flow and create a sense of separateness and stagnation. Many of us engage in a negative dialogue with ourselves. We tend to be critical, harsh and blaming towards ourselves. It is important to transform our internal dialogue into a compassionate, creative and constructive one. A healthy and constructive inner dialogue creates clarity and confidence. These allow us to relate and communicate with others authentically and effortlessly. Healthy relating leads to effective communication. Effective and expressive communication leads to strong relationships. Strong, relationships mean productive and joyful partnerships, and a sense of connectedness and fulfillment.

4. The Gate of Creative Expression

There is much joy, power and inspiration born of our creative expression. Whether we acknowledge it or not, we are all creative and expressive. Artists are born with a heightened sense of creativity but we can all become more available to our creative abilities. Creativity and expression strengthens our sense of self, deepens our knowledge of ourselves, and frees us to share our experiences with others. Creativity and expression are present in nature, in the nature of our being, and in the whole universe. Within this gate we develop our creative and expressive abilities. We use movement, sound, writing, drawing and other forms of creating art to express and explore important life themes. Most of the time new and surprising discoveries emerge. Clarity, a sense of completion and a deeper understanding are achieved. We can see by now how the gates are interconnected. We use our body to experience and express emotions. We use our emotions and our body to create and we learn more about our body when we feel and express.

5. The Gate of Life Path

Our life path can be defined as who we are and how we choose to live our lives. How do we share our abilities and talents with others? What do we choose as our career? What is our life purpose, our inner most passionate way of contributing to and communicating with others? This gate emphasizes the importance of defining our life path clearly, having a sense of direction and focus. Our life path is born out of what we are most passionate about, what really thrills us and inspires us. It is not just some logical or intellectual choice. For many of us, the sense of true purpose and vocation is lost in the need for status and money, or is buried under socio-cultural pressures, or bogged down by our parents' expectations. With our life path uncovered, direction and focus create our vision. Our vision informs and motivates us to make choices and take on commitments followed by actions. This gate supports the process of finding your personal life path. It guides you in creating a clear vision, and then taking steps to make choices leading to commitments and actions. The exercises assist in finding the clarity and the commitment needed to fulfill your vision and your life goals.

6. The Gate of Silence

If we can find the ability to be silent, we can enter a world of insight, understanding, and possibilities Inner silence is not defined by sitting and doing nothing, but being able to achieve a sense of deep inner quiet or stillness of the mind. Our mind is mostly obsessive and compulsive. It is constantly obsessing over the past or projecting into the future. It is worried, busy, speculating, calculating, and trying to figure out life. Even when we sleep, our mind is working. It is rare to find the ability to just be. The Gate of Silence emphasizes the importance of learning how to be truly silent. It uses different kinds of meditations and silent processes to train the mind to let go. As a result, we can allow the body and the feelings to relax.

Within silence, we can experience profound clarity and peace and hear the voice of our intuition. At times, important life questions or insights reveal themselves spontaneously. A deep sense of connectedness emerges.

7. The Gate of Knowledge

The Gate of Knowledge holds a space of inquiry for the most important questions. Who are we? Why are we here? What is life all about? What is most important to us? What is the nature of reality? What happens after we die? What is the meaning of our life? Why do things happen the way they do? Is there a higher intelligence that guides the universe? The gate of knowledge does not provide answers to those questions, but encourages us to liberate and expand our minds so we can find our own answers over time. Different texts—scientific, spiritual, and psychological—are explored within this gate. A forum for open discussion is created as a fertile ground for continuous pursuit of knowledge. The chosen texts are aimed to stir the mind and bring forth new insights.

The gates, true to their name, are channels of inner power. Each one contributes a different flavor of strength to your palate, a different color for your living canvas.

II. Curriculum

The Gates of Power program is recommended as a two-year program with four stages—Beginners, Intermediate, Advanced, and Leadership. It begins with a 3-day weekend workshop that covers the basic philosophy, principles, and exercises of the method.

### Introduction to Gates of Power

1. A basic training (Level I) in each one of the seven Gates;

2. The theory of the three aspects of the self.

3. General outline of the philosophy and principles.

Each stage of the program covers all the Gates with the exercises appropriate for that level, since the study of each Gate is also divided into levels.

Each one of the Gates is divided to seven Levels, going from the easiest to the most advanced. Each stage of the curriculum goes through the study of all the Gates. Level I of all the Gates is explored in the Introduction workshop. Level II of all the Gates is explored in the Beginner's stage of the curriculum, and so forth. There are four stages—Beginners (Level II), Intermediate (Levels III and IV), Advanced (some of Level IV and V), and Leadership (Levels VI and VII).

Level I General Theme: The Inner Self:

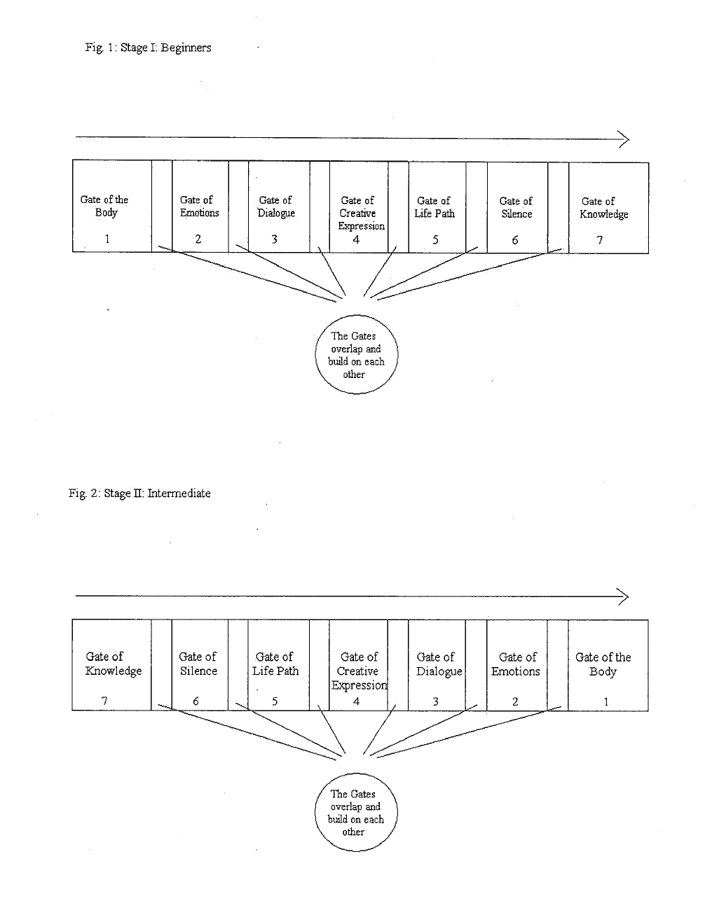

In this level, the order that the Gates are studied is the original order, from 1 to 7—the first Gate is the Gate of the Body, the second is the Gate of Emotions, etc—refer to the order of the Gates above. (See FIG. 1 for a visual representation of this order.)

1→2→3→4→5→6→7

Following the weekend introduction, beginners proceed to Level I, which includes two courses of three months each. During the six months, participants commit to two hours per week of group sessions and, twice a month, an individual session with their coach. After the first three months, there is a mid-level weekend intensive called “The Study of the Sell”. To that, they can add, if they choose, a one-day course covering a specific Gate. Each month's one-day workshop offers an in-depth study of a different Gate. Participants who are unable to commit to two hours of weekly group work have the option to choose a full-day course once a month instead of the weekly group sessions. During the six-month-long first level, each Gate is studied for the duration of three sessions. The order that they're studied is the original order, from 1 to 7.

Level II General Theme: The Self and the World:

In this level, the order that the Gates are studied is the reverse of the original order, from 7 to 1—the first Gate is the Gate of Knowledge, the second is the Gate of Silence, etc. (See FIG. 2 for a visual representation of this order.)

7→6→5→4→3→2→1

After completing six months, participants attend another 3-day workshop, called “Who Am I and Why Am I Here?” This workshop initiates them into Level II. It is an in-depth study of our relationship with ourselves and others.

Level II includes two courses of three months each, during which they commit to two hours per week of group work, plus two monthly individual sessions with their coach. After the first three months of Level II, participants attend another 3-day workshop, entitled “Cycles of Renewal,” which initiates them into Level III. This workshop will be an in-depth study of our personal power, our ability to shed old limiting, negative or unnecessary patterns and experiences and our creative power to renew, revise, and restore, so we can celebrate life in all its challenges and splendor.

After completing six months of Level II, participants take a weekend workshop dealing with communication, relationships, and intimacy. This workshop is called “Pathways to the Heart.” As in Level I, participants can choose to add a workshop on a specific Gate; they can also elect to do a full-day course instead of weekly group sessions. All the Gates are covered in Level II as in Level I, but in reverse order beginning with the seventh Gate and moving down from there to the sixth, fifth, etc.

Level III General Theme: The Power of Expression

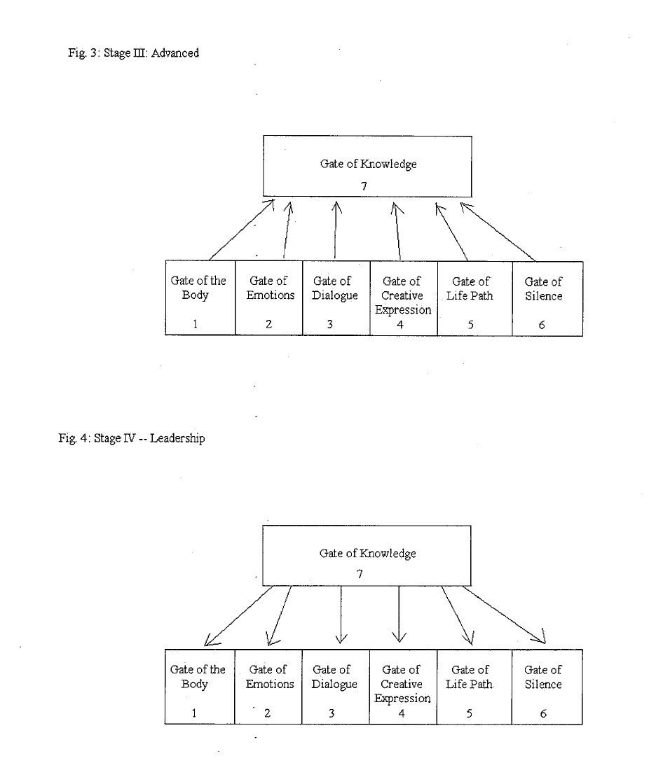

In this level, the six first Gates are studied in terms of the way they relate to the seventh, the Gate of Knowledge. (See FIG. 3 for a visual representation of this order.)

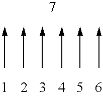

Level III includes two courses of three months each, during which they commit to two hours per week of group work, as well as two individual sessions a month with their coach, plus a weekend course, after the first three months, dealing with expression, creativity and personal power. This mid-level workshop is called “Ways of Celebration.” As in Levels I and II, participants can choose to add a workshop on a specific Gate; they can also elect to do a full-day course instead of weekly group sessions. On this Level, the participants study how each one of the first six Gates relates to the seventh, the Gate of Knowledge.

After completing Level III, participants take a weekend workshop called “The Power of Intimate Relating,” which deals successful communication and the natural ever-relatedness of life and experiencing that relatedness fully. To that, they can add, if they choose, a one-day course covering a specific Gate. Each month's one-day workshop offers an in-depth study of a different Gate. As in Level I, participants can elect to do a full-day course instead of weekly group sessions.

Level IV: The Power of Leadership

In this level, the seventh Gate (Gate of Knowledge) is applied to the other six Gates, and its influence is examined. (See FIG. 4 for a visual representation of this order.)

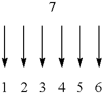

The culminating segment of the program focuses on leadership. In the middle of Level IV, participants attend another 3-day workshop, called “Authoring Your Life.” Level IV includes two courses of three months each, during which they commit to two hours per week of group work, as well as two individual sessions per month with their coach, plus a weekend, after the first three months, dealing with leadership issues and training. This weekend workshop is called “Life as a Contribution.” In Level IV, the participants study how the Gate of Knowledge affects and unifies all the other Gates.

After completing the leadership training, participants choose artistic, educational or social projects. They create teams to cultivate and bring these projects to fruition. These projects are supported by the corporation as a not-for-profit endeavor.

Ideally, the program takes an average of two years, although some people might need longer to complete the program, based on their emotional/spiritual maturity and their ability to assimilate the material, as well as personal circumstances. (Note: Average time to complete conventional therapy falls between two and four years; the presented method is more comprehensive with regard to a person's well-being and is completed in two years. The Institute also offers individually tailored programs to support members with special needs.)

Certified psychotherapists trained in the method will be leading the classes and workshops. Programs and counselors will be supervised, and each trainer will have two other assistants in any given class. The classes in the beginning will consist of groups of 15-20 people; this will later grow to 25-50 people. The classes will be held in the center and in the form of traveling programs as well.

While there is a specific central focus on the Gate that is being studied at that point, each group meeting covers three to four Gates. Every meeting starts with twenty minutes of meditation (Gate of Silence); the meditations are different each time (sitting; lying down; Movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

The curriculum begins with a 3-day weekend workshop that covers the basic philosophy, principles, and exercises of the method.

### First Workshop: Introduction to Gates of Power (3-Day Weekend Workshop)

1. A basic training (Level I) in each one of the seven Gates;

2. The theory of the three aspects of the self.

3. General outline of the philosophy and principles.

After the introductory workshop, the curriculum is as follows:

| | Stage: | | | |
|---|---|---|---|---|
| | I | II | III | IV |
| Theme: | The Inner Self | The Self and the | The Power of | The Power of |
| | | World | Expression | Leadership |
| Duration: | 2 sets of 3 | 2 sets of 3 | 2 sets of 3 | 2 sets of 3 |
| | months | months | months | months |
| Level of Gates | Level II | Levels III and | Some of Level | Levels VI and |
| covered: | | some of IV | IV and Level V | VII |
| Gates studied: | 1 to 7 (numerical | 7 to 1 (reverse | How the first 6 | How the 7th Gate |
| | order) | numerical order) | Gates relate to | relates to the first |
| | | | the 7th Gate | 6 Gates |
| Mid-Stage | The Study of the | Cycles of | Ways of | Authoring Your |
| Workshop: | Self | Renewal | Celebration | Life/The Leader |
| | | | | Within |
| Graduation | Who Am I and | Pathways to the | The Power of | Life as a |
| Workshop: | Why Am I Here? | Heart | Intimate Relating | Contribution |

Stage I (Beginners) General Theme: The Inner Self:

Following the weekend introduction, beginners proceed to Stage I. After the first three months, there is a mid-level weekend intensive called “The Study of the Self”. To that, they can add, if they choose, a one-day course covering a specific Gate. Each month's one-day workshop offers an in-depth study of a different Gate. Participants who are unable to commit to two hours of weekly group work have the option to choose a full-day course once a month instead of the weekly group sessions. During the six-month-long first stage, each Gate is studied for the duration of three sessions. The order that they're studied is the original order, from 1 to 7. The first Gate is the Gate of the Body, the second is the Gate of Emotions, etc—refer to the order of the Gates above. (Refer to FIG. 1)

1→2→3→4→5→6→7

After completing six months, participants attend another 3-day workshop, called “Who Am I and Why Am I Here?” This workshop initiates them into Stage II. It is an in-depth study of our relationship with ourselves and others.

Stage II (Intermediate) General Theme: The Self and the World:

In this stage, the order that the Gates are studied is the reverse of the original order, from 7 to 1—the first Gate is the Gate of Knowledge, the second is the Gate of Silence, etc.

7→6→5→4→3→2→1

After the first three months of Stage II, participants attend another 3-day workshop, entitled “Cycles of Renewal,” which initiates them into Stage III. This workshop will be an in-depth study of our personal power, our ability to shed old limiting, negative or unnecessary patterns and experiences and our creative power to renew, revise, and restore, so we can celebrate life in all its challenges and splendor. (Refer to FIG. 2)

After completing six months of Stage II, participants take a weekend workshop dealing with communication, relationships, and intimacy. This workshop is called “Pathways to the Heart.” All the Gates are covered in Stage II as in Stage I, but in reverse order beginning with the seventh Gate and moving down from there to the sixth, fifth, etc.

Stage III (Advanced) General Theme: The Power of Expression:

In this stage, the six first Gates are studied in terms of the way they relate to the seventh, the Gate of Knowledge.

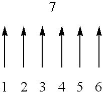

After three months, there is a weekend course dealing with expression, creativity and personal power. This mid-stage workshop is called “Ways of Celebration.” (Refer to FIG. 3)

After completing Stage III, participants take a weekend workshop called “The Power of Intimate Relating,” which deals successful communication and the natural ever-relatedness of life and experiencing that relatedness fully.

Stage IV (Leadership): The Power of Leadership:

In this stage, the seventh Gate (Gate of Knowledge) is applied to the other six Gates, and its influence is examined.

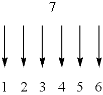

The culminating segment of the program focuses on leadership. In the middle of Stage 1V, participants attend another 3-day workshop, called “Authoring Your Life/the Leader Within”. After sox months there is a workshop dealing with leadership issues and training. This weekend workshop is called “Life as a Contribution.” (Refer to FIG. 4)

After completing the leadership training, participants choose artistic, educational or social projects. They create teams to cultivate and bring these projects to fruition. These projects are supported by the corporation as a not-for-profit endeavor.

Ideally, the program takes an average of two years, although some people might need longer to complete the program, based on their emotional/spiritual maturity and their ability to assimilate the material, as well as personal circumstances. (Note: Average time to complete conventional therapy falls between two and four years; the presented method is more comprehensive with regard to a person's well-being and is completed in two years. The Institute also offers individually tailored programs to support members with special needs.)

Certified psychotherapists trained in the method will be leading the classes and workshops. Programs and counselors will be supervised, and each trainer will have two other assistants in any given class. The classes in the beginning will consist of groups of 15-20 people; this will later grow to 25-50 people. The classes will be held in the center and in the form of traveling programs as well.

### BRIEF DESCRIPTION OF ACCOMPANYING IMAGES

FIG. 1: Stage I: Beginners

FIG. 2: Stage II: Intermediate FIG. 3: Stage III: Advanced

FIG. 4: Stage IV: Leadership

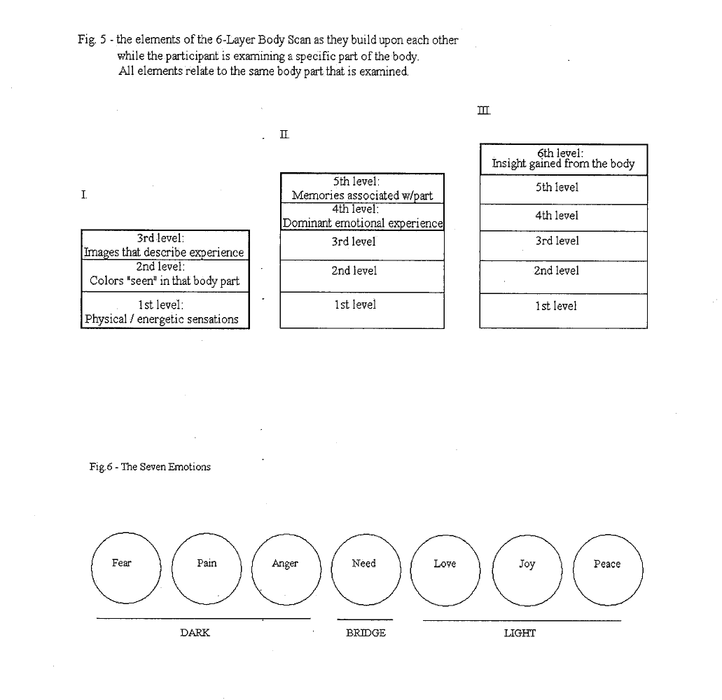

FIG. 5: The elements of the 6-Layer Body Scan as they build upon each other while the participant is examining a specific part of the body. All elements relate to the same body part that is examined.

FIG. 6: The Seven Emotions

FIG. 7: Releasing and Forgiving Traumatic Memories

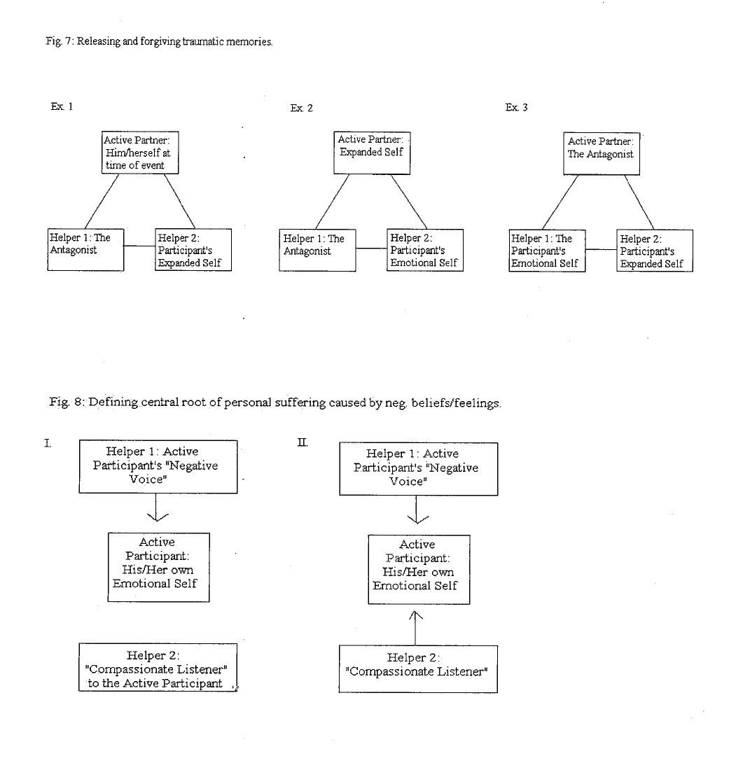

FIG. 8: Defining central root of personal suffering caused by negative feelings or emotions.

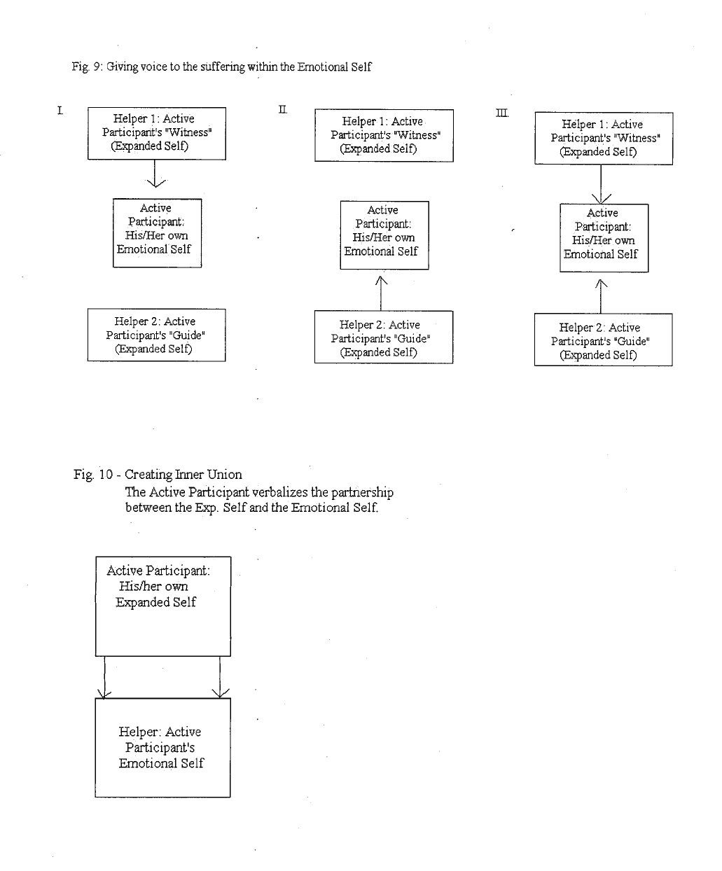

FIG. 9: Giving voice to the suffering within the Emotional Self

FIG. 10: Creating Inner Union—the Active Participant verbalizes the partnership between the Expanded Self and the Emotional Self

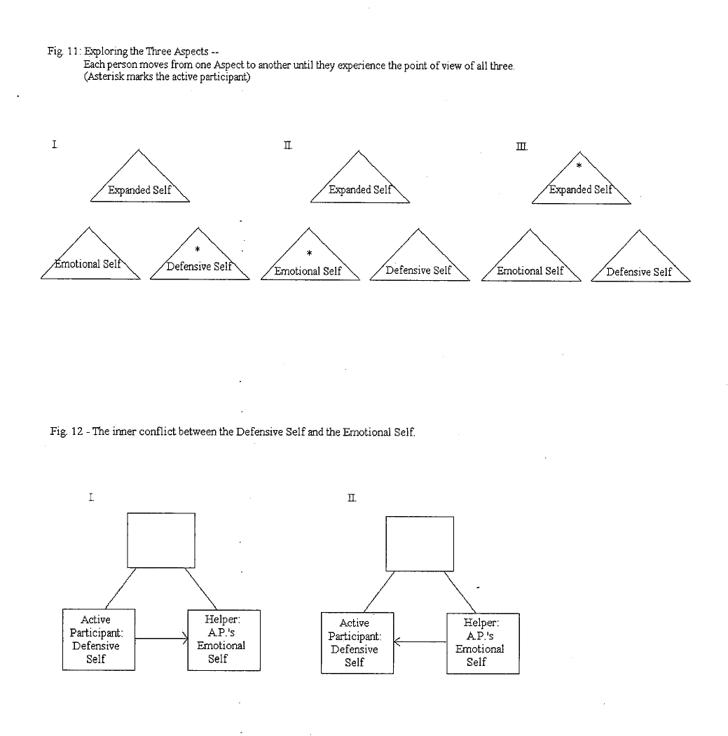

FIG. 11: Exploring the Three Aspects—each person moves from one Aspect to another until they experience the point of view of all three. (Asterisks mark the Active Participant)

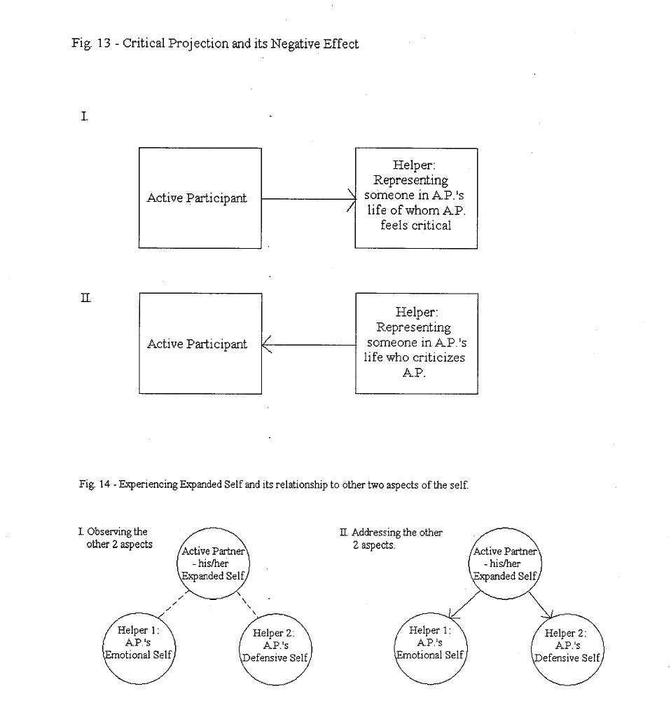

FIG. 12: The inner conflict between the Emotional Self and the Defensive Self

FIG. 13: Critical projection and its negative effect FIG. 14: Experiencing the Expanded Self and its relationship to the other two Aspects

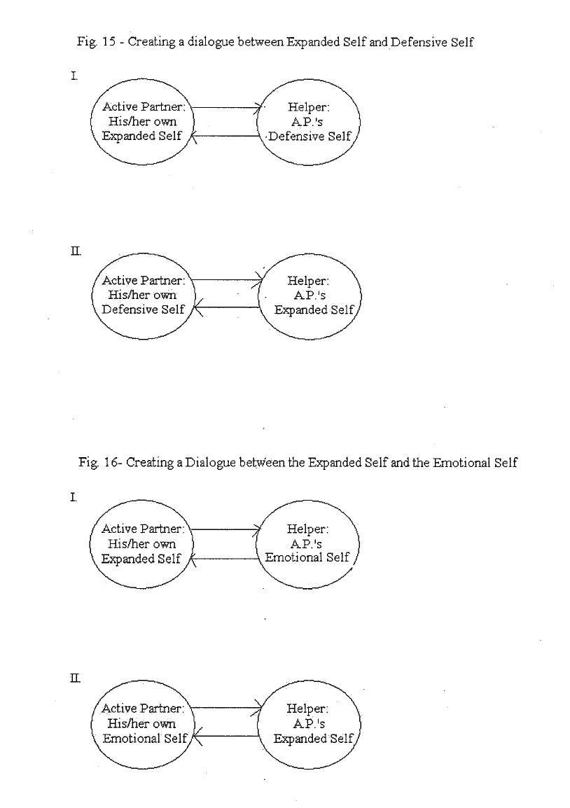

FIG. 15: Creating a dialogue between the Expanded Self and the Defensive Self

FIG. 16: Creating a dialogue between the Expanded Self and the Emotional Self

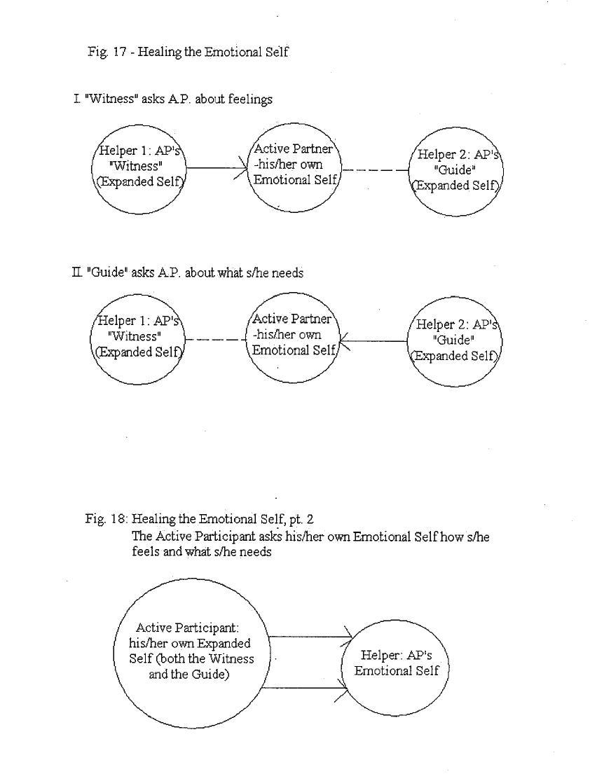

FIG. 17: Healing the Emotional Self

FIG. 18: Healing the Emotional Self part II

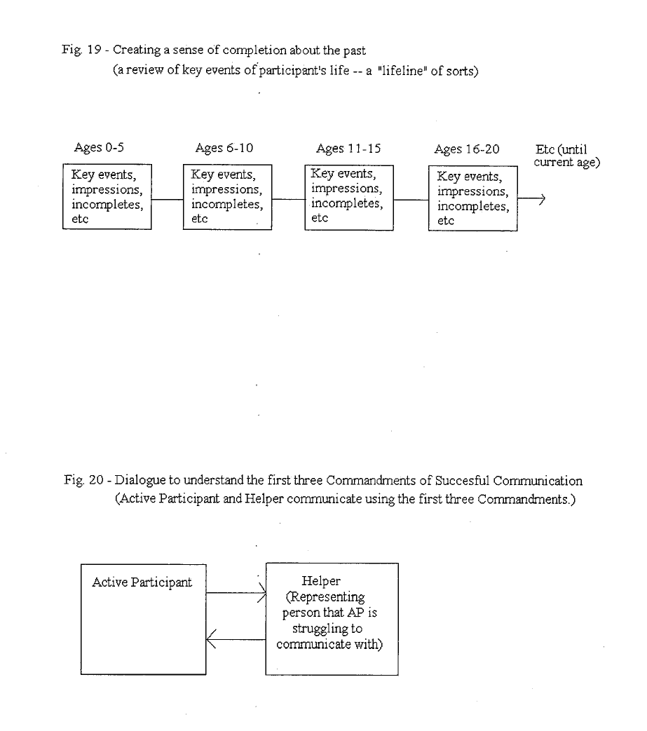

FIG. 19: Creating a sense of completion about the past

FIG. 20: Dialogue to understand the first three Commandments of Successful Communication

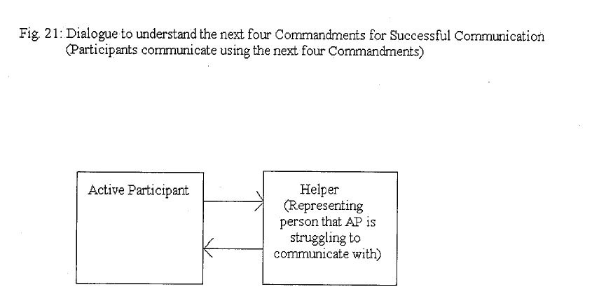

FIG. 21: Dialogue to understand the next four Commandments of Successful Communication

### THE GATE OF THE BODY

### Detailed Description of the Processes and Exercises

1. In each level, an exercise or a process can be repeated more than once if needed.
2. Any part of any process or exercise can be repeated more than once if needed.
3. An exercise or a process can be broken down to even smaller excerpts to make it clearer and easier.

General goals for the Gate of the Body:

1. Understand the body in relationship to the psyche and the energetic field.
2. Learn to listen, respect, and care for the body in order to achieve a deeper, healthier connection to oneself.
3. Enhance the ability to move, express, and enjoy the body as a way of freeing the emotional, energetic, and cognitive layers.
4. Re-organize, release, and shift limiting patterns and unify the body into wholeness.

There are commitments that participants take on connected to each level of the Gates. These commitments are like assignments to be done between weekly meetings at home. They are noted at the end of each level.

Gates of Power establishes seven different levels of inquiry, healing, and strengthening the body. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

### Level I:

Purpose: Becoming aware of our relationship to our body. What do we accept? What do we reject? What is our dialogue with our body—its positive and negative aspects? How is the relationship to our body affecting our life, our self-image, our physical health, our self-expression, our intimate relationships, and our ability to achieve our life goals?

Process: Homework. Participants are asked to take some time at home and look at themselves in a mirror. While doing that, they are asked to notice feelings, judgments, comments, and beliefs about each part of the body. They are then asked to write down: 1. All commentary that surfaced, in detail. 2. How long they have had this kind of perception of the body. 3. What effect it has had on their lives.

Exercise 1—Writing Exercise. Group or Private.

Goal: To access memories connected to the body.

Part I: Participants are asked to review the detailed list of all comments and feelings they have discovered and experienced in the previous process. Participants are asked to notice any spontaneous memories that are connected to the way they feel about their bodies, and to write those down.

Part II: Share and discuss.

Exercise 2—Drawing Exercise. Group or Private.

Goal: To visually represent the inner view of the body and confront it.

Part I: Participants are asked to draw a picture of their bodies, not realistically but experientially, as a response to the previous exercise. For example, if someone thinks that their hips are gigantic, that is the way they experience their body. When drawing it, they should be loyal to the way they experience it and draw gigantic hips, etc.

Materials: Crayons and black markers.

Part II: Share and discuss.

Exercise 3—Laying down exercise. Group or private. Guided imagery process.

Goal: To access difficult memories and release negative charge.

Part I: Painful, shameful, or difficult memories that are connected with any one of the parts of the body are fully explored in a guided imagery exercise. This exercise is done while laying on a couch (if private) or on floor mats (if in a group). As with all exercises that take place laying down, the coach facilitates a few minutes of relaxation by using relaxation techniques in the beginning of the exercise, so that the mind and body are relaxed and the focus can be directed inward. After the short relaxation time, the coach proceeds to ask participants to choose a specific experience connected to the body that was painful or disturbing. The participants are instructed to start by remembering the experience, seeing as many details as possible—who was there? When did it happen? What was around? What was said? Etc. Then the participants are encouraged to enter the memory experientially and try to re-live it in order to encourage the possible release of negative charge. They are encouraged to be expressive—make sounds, display emotions, etc.

Part II: Share and discuss.

### Commitment for Level I:

1. Participants are asked to keep daily journal entries about their discoveries.

### Level II:

Purpose: Learning to identify the map of chronic tensions or, differently put, defensive structures in the body, and the way these tensions limit expression and vitality. (Study of the expression of the Defensive Self in the body.)

Process: Homework. A second body scan that includes two parts: 1. Visual scan, and 2. energetic scan.

Visual: The participants are asked to look at themselves again, but this time with the purpose of identifying tensions and patches of blocked energy in the body. The process is done by systematically going from the feet up, part by part, visually observing the shape and structure of each part of the body.

Energetic: The participants are asked to sense the energetic quality within each part of the body. For example: are my feet comfortable? Free? Open? Do I sense the energy flowing evenly or do I feel pain? Are there parts that feel numb, constricted, uncomfortable? And so on. After the energetic scan of the body, participants are asked to zero into the parts of the body that they feel are definitely blocked. These could be painful, heavy, uncomfortable, numb, frozen, twisted, overcharged, undercharged, overdeveloped, or underdeveloped. At the end of the exercise, participants are asked to write down what they observed and discovered.

Exercise 1—Observation in couples, standing up, facing each other. Group session.

Goal: To expand the ability to give and receive feedback about the body.

Each partner takes a turn to look at the other person's body and describe the map of tensions that they experience and recognize in their partner, based on visual and energetic impressions. This is done in a kind and neutral manner to support insights.

Share and discuss the homework and how it correlates to the work done in couples (Exercise 1).

Exercise 2—Drawing exercise. Group or private.

Goal: To visually represent the defensive structure in the body and confront it.

Part I: Participants draw the outline of their bodies and fill in with patches of patterns, words, and colors the defensive structure map that was discovered in the previous exercises.

Part II: Share and discuss.

Exercise 3—Laying down exercise. Group or private. The Three Elements Meditative Body Scan.

Goal: To gain the ability to do the meditative body scans.

Part I: The exercise starts with a few minutes of meditation/relaxation techniques. This is done in order to establish calmness in the body and the mind so that intuitive insights and subconscious information surface easier. After the first few minutes of guided meditation, the coach guides the class to keep their eyes closed and mentally enter the most problematic part in their body. They are asked to scan that part on three levels.

The first is sense the physical and energetic sensations that they experience in that particular part of their bodies. For example, cold, hot, tight, loose, open, contracted, heavy, light, and/or tingling, painful, sense of pressure, sense of ease, etc. Then they move into the second level, in which they are asked what colors they see in this specific part of the body.

The third level is images. They are asked to note what images describe the experience that they have in this part of their body. For example, somebody can choose their chest as a constricted, uncomfortable area; they might have sensations of tightness, heaviness, and a certain amount of pain on the left side of the chest. They might see colors that are brown/black with a tinge of red, and the image that comes to them is of a dormant volcano with the potential to erupt again.

See FIG. 5 for a visual representation of how the levels build on each other and transition into the next Body Scan.

Part II: Allow a short time to write about the exercise. Share and discuss.

### Commitments for Level II:

1. Participants are asked to keep daily journal entries about their discoveries.
2. Participants are asked to practice the Meditative Body Scan at least twice a week.
3. Participants are asked to choose a part of the body that is constricted and experiment with moving it in as many ways as you can think of to free the energy in that part of the body.

### Level III:

Purpose: Identifying the emotional map within the defensive structure. Learning to feel and understand unresolved experiences and other difficult feelings that are connected to the observable defensive structure in the body. The aim is to aid participants in understanding their emotional history, the main stressers and challenges that created their particular defensive structure, and the way it affected their body, mind, emotions, and life.

Process: Homework.

1. Participants are asked to meditate on and write down as many early childhood memories as they can conjure and describe them in as much detail and precision as possible, including, if available, the feelings that they remember having.
2. Participants attempt to define the most stressful memories and their effect.

Exercise 1—Laying down exercise. Group or private. Meditative Six-Layer Body Scan.

Goal: To further the ability to do the body scan. (See FIG. 5, part II, for a visual representation of how the Six-Layer Body Scan builds on the 3 layers of the previous body scan.)

This exercise uses the fourth and fifth elements of six—the emotional element and the memory element. The exercise begins with a few minutes of relaxation.

Part I: Participants are guided to feel different parts of their body, looking for the emotional experience that is dominant within each part. For example, when one focuses on their stomach, they would ask themselves what feelings it would express if it were a human being, and how it would express them—would it be laughing, crying, screaming? Etc. What memories emerge from each specific part, and what feelings are identified with these memories?

Part II: Writing time. Share and discuss.

Exercise 2—Expressive exercise. Group or private.

Goal: To free the ability to feel and express.

Based on previous exercises, participants are asked to choose three places on their body that are tense, constricted, or uncomfortable. They are guided into expressing the feelings and the experiences within those parts using movement, sound, words, and giving emotional expressive voice to these parts of the body.

Exercise 3—Dialogue, working in couples. Group.

Goal: To make cognitive connections between experience and emotional history.

Sharing with their partner what was discovered and expressed in Exercise 2, with the attempt to make a connection between the experience and the main emotional stresses that have influenced their life.

Commitments for Level III:
1. Participants are asked to keep daily journal entries about their discoveries.
2. Participants are asked to find a way to move expressively, choosing one or two specific themes to move to.

### Level IV:

Purpose: Beginning to resolve, release and reorganize the emotional/physical map of stresses through the work with the body.

Process: Homework—identifying unexpressed needs that are at the root of inner stresses. Participants are asked to intuitively try to identify and write down a list of needs they find hard to feel or express.

Exercise 1—Study, discussion and expression of the Seven Emotions. Group or private.

Goal: The general study of the seven emotions.

Discussion: There are seven primary emotions (like primary colors) as defined by the Gates of Power Method—three “dark” ones: fear, pain, and anger; one that is called a “bridge emotion,” need, which bridges between the dark and the light; and three “light” ones: love, joy, and peace. See FIG. 6 for a visual representation of the order of the Seven Emotions and how they are divided into Dark, Bridge, and Light.

Expression: The coach goes through the emotions one by one. Participants attempt to find the physical, vocal, emotional experience and expression of each one of the emotions. This exercise is the emotional and physical equivalent to a musician doing scales; it frees the participants to a fuller and more flexible range of emotions and creates greater ability for participants to work with these emotions later.

Exercise 2—Expression. Groups of five.

Goal: To expand the ability to express feelings through the body.

Part I: One at a time, each participant chooses one of the emotions that they feel they need to express the most, and personalizes it to give it full expression—movement, sound, words, feelings. The four other ones mirror back the feeling expressing them in their own way; they pick up on whatever feeling is being expressed, but they create their own version of it.

Part II: Share and discuss:

Exercise 3—Expression in couples. Group. Completing Unfinished Business.

Goal: To learn to witness others' expression and mirror it.

Two participants take turns; one sits on a chair and acts as the “witness”. The witness does not say anything until the very last moment of the exercise. The active partner chooses somebody from their history to whom they feel the need to express something serious and important that was never fully expressed. The active partner then designates the witness as that person. The witness silently plays the part of the person, listening and allowing the active partner to say anything they need to say. At the end of the exercise, the witness responds in a positive, loving way, for example, “I′m sorry, I didn't know you felt that way.” There is a brief discussion and a moment to cool down and neutralize. After this, the partners switch roles: the former active partner becomes the silent witness, and vice versa.

### Commitments for Level IV:

1. Participants are asked to keep daily journal entries about their discoveries.
2. Participants are asked to think of two more people in their life with whom they need to complete unresolved business, and write letters to each of them. The letters are not to be sent.

### Level V:

Purpose: Second stage of resolving, releasing, re-organizing the energetic and emotional flow in the body.

Process: Homework. Participants are asked to meditate on and identify their healthy needs, boundaries, and natural rights, and look at how they have compromised them in order to feel accepted, loved, and safe. They are asked to write down two lists:

One, the list of compromises they recognize they made concerning their healthy needs, boundaries, and natural rights;

Two, the list of healthy needs, boundaries, and natural rights.
Exercise 1: Two-part exercise. Group.
Goal: To discover and learn to voice needs.

Part I: Partners. Partners take turns in sharing with the other their needs in the form of a declaration: “I need, deserve, and want . . . ” and then proceed with the list of healthy needs, boundaries and rights that they discovered in the previous process. The listening partner responds with a question: “Do you?” The active partner needs to re-declare “I need, deserve, and want . . . ” three times.

Part II: Group. One by one, each participant stands in front of the group, declaring their list of needs and wants. The group responds: “No you don't.” The participant needs to assert his/her needs to the group three times.

Part III: Share and discuss.
Exercise 2: Laying down. Group or private. Full Six-level Meditative Body Scan and Release.
Goal: To be able to do the full Meditative Body Scan.

Part I: The exercise begins with a few minutes of relaxation techniques. During the Full Meditative Body Scan, the participants are asked to scan each part of the body, checking for six different levels:

1. Physical, energetic sensations;

2. Color or colors;

3. Image or images;

4. Feelings;

5. Memories;

6. Insight.

Refer to FIG. 5 for a visual representation of how all these levels build on each other.

Part II: After the full scan is done, a part of the body that feels problematic is chosen, and the participants are invited on a guided journey of images, sensations, and experiences as they enter with their “mind's eye” the particular area of the body that they have chosen. The coach suggests that the participants enter the specific part of the body as if they were entering an unknown country, landscape, or environment. They are asked to see what images and feelings come to them as they step into that environment. From there the participants are guided on a journey that unfolds spontaneously and intuitively within that environment (very much like in a lucid dream). Most of the time, the journey is extremely revealing and results in a higher sense of wellbeing.

Part III: Share and discuss.
Exercise 3: Group or private. Moving exercise. Breath work.
Goal: To create a connection with breath and movement.

Part I: Four different patterns of breath are established, different in the rhythms of the inhales and exhales. Participants are guided to close their eyes and choose one color to designate the inhale and another to represent the exhale; they are then asked to move spontaneously, doing each one of the breathing patterns and observing how the breath informs the movement and vice versa. For example, the coach guides them in the first rhythm, which can be inhale to the count of three and exhale to the count of three, and imagine the color of the breath is yellow on the inhale and blue on the exhale. After a couple of minutes of establishing the breath and the color, participants are asked to move, keeping the breath and color in mind. They are given a few minutes and then the coach moves to the second rhythm, etc. At the end of the exploration, participants are asked to move together in a group, eyes still lightly closed, synchronizing their breaths.

Part II: Share and discuss,

Commitments for Level V:
1. Participants are asked to keep daily journal entries about their discoveries.
2. Participants are asked to try the Six-Level Meditative Body Scan twice.
3. Have a discussion/sharing with two people in their life that they feel close with about their needs.

Level VI:

Purpose: Embracing, accepting, and taking responsibility for the body as a mirror of the inner self.

Process: Homework. Two parts.

One: Participants are asked to write a list of all that they acknowledge and appreciate in regard to their body: all the benefits and positive aspects that they see and feel, the ways the body is helpful and expressive, etc.

Two: The “Personal Agreement” to honor the body. This agreement is written very much like a loving contract between you and your body, and it lists all the ways that you are willing, ready, and able to enhance, care, listen to, and cherish your body.
Exercise 1: Drawing exercise. Group or private. Creating a 3D art piece describing the body from the point of view of appreciation and acceptance.
Goal: To create a visual expression of a positive connection the body.

Participants are asked to bring in small objects, colored paper, pieces of material, and any other supplies they choose to create a three-dimensional collage of their body. They can also write promises, affirmations, feelings, thoughts, etc and include them within the collage.
Exercise 2: Couples exercise. Group.
Goal: An expression of gratitude toward the body.

One partner is designated to “be” or act like the other person's body; the working partner addresses the body to express gratitude. They are given 3-5 minutes to acknowledge out loud their appreciation and care. The partners then switch. The exercise is sincere but done with a spirit of humor and playfulness.
Exercise 3: Laying down. Group or private. Experiential study of the Chakra system.
Goal: To be able to locate and understand the Chakra system.

Part I: The exercise begins with a few minutes of relaxation techniques. After this, the coach guides the participants through the seven centers of energy, starting from the bottom of the spine and going all the up to the crown to the head. The coach stops in each center and explains a few words about the exact location as well as the emotional and spiritual themes that are reflected in that chakra/center. Participants are given time to sense into each center and meditate on how they might be dealing with the theme that is present in each center. For example, the lowest chakra is connected to survival, so if the participant experiences strain or heaviness there, the sensation might be connected to physical survival issues. Participants are asked to notice shapes, colors, memories, images, etc that present themselves spontaneously to them.

Part II: Share and discuss.

### Commitments for Level VI:

1. Participants are asked to keep daily journal entries about their discoveries.
2. Participants are asked to begin to cultivate an attitude of caring and gratitude toward their body, choosing practical daily moments to practice this kind of attitude.

Level VII:

Purpose: In-depth study of the energetic centers as a map of one's spiritual evolution. A map that charts the different levels of personal power and spiritual/emotional life lessons connected to them.

Process: Homework. Personal research about the energetic centers in the body and reading recommended material, such as Anatomy of Spirit or Energy Anatomy by Caroline Myss.
Exercise 1: Lecture by the coach about the energetic centers. Group or private.
Goal: To get more information about the energetic centers of the body.

This lecture covers more details than the first introduction. In specific, what are the personal lessons of power and growth that can be understood through these centers and what they represent? Participants are asked to write down their answers.

Each participant shares their understanding of the centers and what might be the most important lesson for them, based on their research and current level of understanding themselves.
Exercise 2: Writing. Group or private. My Life Lived from Choice, Responsibility and Inner Power.
Goal: To cultivate the ability to see and experience life from the point of view of the Expanded Self.

Part I: The writing exercise is a description of the potential of the participants' life as envisioned if it is lived out of choice, responsibility and inner power. It is a life lived from the place of being one's Expanded Self. How would that life feel and look? What would that person be doing? How would they be feeling? How would their body feel?

Part II: Share and discuss the writings.
Exercise 3: Group.
Goal: To cultivate the ability to share experiences expressively.

All seven levels of the Gate of the Body culminate into a creative presentation. Participants can choose how they want to present; they are encouraged to fuse a few elements together, for example, writing, speaking, and music, or movement, objects, and poetry. The presentation expresses their personal transformation achieved through the work on the Gate of the Body, their insights into their vulnerability, their lessons, and their power.

Commitments for Level VII:
1. Participants are asked to keep daily journal entries about their discoveries.
2. Participants are asked to practice an attitude of caring and responsibility toward the body by paying attention to food, rest, movement/exercises, as well as by meditative listening to the body and cultivating a sense of enjoyment and play.

### The Gate of Emotions

### Detailed description of the Processes and Exercises

1. In each level, an exercise or a process can be repeated more than once if needed.
2. Any part of any process or exercise can be repeated more than once if needed.
3. An exercise or a process can be broken down to even smaller excerpts to make it clearer and easier.

General Goals for the Gate of Emotions
1. To be able to identify and understand our emotions
2. To gain the capacity to experience explore and express them
3. To resolve, release and reintegrate any repressed, denied or disturbing emotional patterns or blockages
4. To learn to guide the emotional self so that emotions become a source of joy, communication, connection and creativity
5. To learn to experience emotions as a guiding tool in understanding our healthy needs and the ways to fulfill them.

There are commitments that participants take on connected to each level of the Gates. These commitments are like assignments to be done between weekly meetings at home. They are noted at the end of each level.

Gates of Power establishes seven different levels of inquiry, healing, and strengthening the emotions. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

### Level I:

Purpose: Understanding the seven (7) primary emotions.

The GOP Method identifies seven primary emotions similar to primary colors, three of them are called “dark emotions”, three “light emotions”, and the one in between is called the “bridge emotion”. The three “dark emotions” are fear, pain, anger, the bridge between the dark and the light is the emotion, need; the three “light emotions” are love, joy and peace. (Refer to FIG. 6)

Process: Participants are asked to write, at home, a personal description of each one of these seven emotions, using five categories, giving examples for each:

1. Describe the experience of each one of the seven emotions.
2. Where in the body do they most feel each one of the emotions?
3. When does each of the particular emotions arise for them?
4. How do or don't they express each emotion?
5. What is the influence and effect of each emotion on their life (relationships, work, ability to enjoy life, etc.)?
Exercise 1—Group or private:
Goal: To cultivate a sense of ease with the experience and expression of the seven emotions.

Part I—Five to ten minute increments of music are provided for each of the emotions.

Participants are asked to work with each segment using movement and sound; they improvise first and proceed to create words, sounds, gestures or sentence describing each one of the emotions. Five to seven gestures; connected into a fluent sentence accompanied with sound and words that fully convey that particular emotion, the way they understand it.

Part II—Each person chooses two emotions, one the easiest emotion for them to work with, and one the most difficult. One by one they present their word/sound/gesture sentences to the group. The group mirrors the expression back to them, using spontaneous word/sound/gesture reactions.

Part III: Share and Discuss.
Exercise 2—Group or private.
Goal: To identify and understand emotions that are difficult to deal with.

Part I—Writing—Participants are asked to write which ones of the seven emotions are most difficult for them to experience or express and why.

Part II—Sharing in Couples—Each participant shares with their partner, their discoveries about the emotions that were most difficult for them, and gives examples from their daily lives.

Part III: Share and discuss.
Exercise 3—Drawing. Group or private.
Goal: To create a visual map of the emotions in the body.

Participants draw an outline of their body and within it they color spaces to show where each one of the seven emotions registers. They use colors and shapes to express the intensity and the amount of space each emotion claims within the body.

Part III: Share and discuss.

### Commitments for Level I:

1. Participants are asked to keep daily journal entries about their emotions and the effect of each emotion on their daily life.
2. Participants are asked to notice emotions that are difficult to experience or express and choose one situation or relationship in their lives where emotions are difficult, and commit to be more direct and communicative about their emotions.

Level II:

Purpose: Freeing, releasing and integrating the “Dark Emotions” (fear, pain, and anger)

Process: Participants do the process at home. It is a deeper level of investigation of the seven emotions.

Part I: Participants are asked to meditate on and write about, in as much detail and honesty as possible, all the fears that they are aware of, within themselves.

Part II: They are asked to meditate and write about all the ways that they are avoiding, masking or repressing those fears.

Part III: Participants are asked to meditate on and write about the ways their fears affect their feelings about themselves, their relationships, their work life and their self expression.
Exercise 1—Sharing and discussion, laying down exercise. Group or private. “Visiting the Room Of Fear”
Goal: To thoroughly explore the emotion of fear and cultivate the ability to witness it.

Part I. Participants are asked to share some of the examples and discoveries from their homework process.

Part II. Emotional visualization. Before the exercise, the coach explains about the rooms. Like all laying down exercises it begins with a few minutes of relaxation techniques to quiet the mind and relax the body. The coach guides the participants to enter what is called “the Room of Fear”. The Room of Fear is an imaginary place in the psyche that holds memories, impressions, images and sensations connected to fear. When asked to enter that room, participants should not anticipate what they will find there. They may do this exercise several times and find that each time different things will be revealed. As they enter (with their minds' eyes) their Room of Fear, they begin to notice colors, shapes, people and things The coach guides them to pay attention to the details by asking questions like, “What do you see there? How do you feel there? What happens to you there?” The coach leads them to discover, within the Room of Fear, their personal scariest memories, situations, and moments. As they go through this process they are encouraged to allow sounds, words, spontaneous moments, and emotions to be expressed and possibly released.

There are two important elements in this exercise. One involves the Emotional Self and the release of feelings. The other one involves the Expanded Self, which comforts, supports, guides, and acts as a healing agent. After the release that happens at the end of the exercise, the coach guides participants to invite their Expanded Self into the Room to make a connection with the Emotional Self, since the Emotional Self will at that point be quite raw. The connection is a soothing, comforting, reassuring connection that helps to integrate the feelings. It stabilizes and reorganizes the emotional material.

Comment—The goal is to experience the fear, and at the same time, be able to witness yourself experiencing it.

Part III: Share and discuss.
Exercise 2—Writing exercise followed by laying down exercise. Group or private. “Visiting the Room Of Emotional Pain”
Goal: To thoroughly explore the emotion of pain and cultivate the ability to witness it

Part I—Writing Exercise at home
1. Participants are asked to meditate on and write about, in as much detail and honesty as possible, all the emotional pain (grief, sadness, despair, hopelessness, loneliness, disappoint, shame, sense of being unlovable, etc) that they are aware of, within themselves.
2. They are asked to meditate and write about all the ways that they are avoiding, masking or repressing their pain.
3. Participants are asked to meditate on and write about the ways their emotional pain affects their feelings about themselves, their relationships, their work life and their self expression.

Part II—This is exercise is done laying down. Like all laying down exercises it begins with a few minutes of relaxation techniques to quiet the mind and relax the body. The coach guides the participants to enter what is called “the Room of Emotional Pain”. The Room of Emotional Pain is an imaginary place within the psyche that holds memories, impressions, images and sensations connected to Emotional Pain. When asked to enter that room, participants should not anticipate what they will find there. They may do this exercise several times and find that each time different things will be revealed. As they enter (with their minds' eyes) their Room of Emotional Pain, they begin to notice colors, shapes, people and things. The coach guides them to pay attention to the details by asking questions like, “What do you see, there? How do you feel, there? What happens to you, there?” The coach leads them to discover, within the Room of Emotional Pain, their most painful memories, situations, and moments. As they go through this process they are encouraged to allow sounds, words, spontaneous moments, and emotions to be expressed and possibly released.

There are two important elements in this exercise. One involves the Emotional Self and the release of feelings. The other one involves the Expanded Self, which comforts, supports, guides, and acts as a healing agent. After the release that happens at the end of the exercise, the coach guides participants to invite their Expanded Self into the Room to make a connection with the Emotional Self, since the Emotional Self will at that point be quite raw. The connection is a soothing, comforting, reassuring connection that helps to integrate the feelings. It stabilizes and reorganizes the emotional material.

Part III: Share and discuss (small groups).

Comment—The goal is to experience the emotional pain, and at the same time, be able to witness yourself experiencing it.
Exercise 3—Writing exercise followed by laying down exercise. Group or private. “Visiting the Room Of Anger.”
Goal: To thoroughly explore the emotion of anger and cultivate the ability to witness it.

Part I—Writing Exercise at home.
1. Participants are asked to meditate on and write about, in as much detail and honesty as possible, all the emotional anger (old or recent resentments, rage, annoyance, impatience, bitterness, vengefulness, aggression, the need to hurt someone, etc.) that they are aware of, within themselves.
2. They are asked to meditate and write about all the ways that they are avoiding, masking or repressing their anger.
3. Participants are asked to meditate on and write about the ways their anger affects their feelings about themselves, their relationships, their work life and their self expression.

Part II—This is exercise is done laying down. Like all laying down exercises it begins with a few minutes of relaxation techniques to quiet the mind and relax the body. The coach guides the participants to enter what is called the “Room of Anger”. The Room of Anger is an imaginary place within the psyche that holds memories, impressions, images and sensations connected to Anger. When asked to enter that room, participants should not anticipate what they emotions to the light ones. This is why identifying your needs and taking care of them responsibly is one of the most important elements in self-healing and self-actualization.

Process: Homework.

Part I. Participants are asked to meditate and write a list of needs and to categorize these needs under Physical, Emotional, Professional/Educational, Fun/Adventurous, Spiritual, and Other. Then they are asked to look at the list and differentiate which ones of their needs they respect, honor, and fulfill, and which ones they neglect, ignore, and deny. Once they have categorized their needs, they are asked to write the reasons they respect certain needs and do not respect others.

Part II. Participants are asked to write two (2) specific examples from two situations and two relationships in their lives, describing needs that are fulfilled and needs that are ignored.

Part III. Participants are asked to choose one significant relationship and one important situation where they are not being responsible in that they aren't expressing, taking care of, or defining their needs. Then, they are asked to write about that situation and that relationship.
Exercise 1: Discussion followed by laying down exercise. Group or private. “Visiting the Room of Need”
Goal: Learning to differentiate between healthy needs and unhealthy needs, and understanding the importance of acknowledging healthy needs.

Part I: Discussion. How do we distinguish between healthy and unhealthy needs? The coach opens the floor to this question.

Comment: Unhealthy approach to needs: When we put too much expectation and responsibility for the fulfillment of our needs on others, or when we do not reach out to others and let them contribute to us, our needs will get frustrated and will not be met. Healthy needs: All desires, longings, wishes, and needs that enhance our well-being and personal growth and are fulfilled by us taking responsibility for them and/or reaching out to others. When reaching out to give and receive, we should do so constructively, appropriately, and communicatively to assure that our needs are fulfilled.

Part II: Like all laying down exercises it begins with a few minutes of relaxation techniques to quiet the mind and relax the body. The coach guides the participants to enter what is called the “Room of Need”. The Room of Need is an imaginary place within the psyche that holds memories, impressions, images and sensations connected to need and registers with the energy field and the body. When asked to enter that room, participants should not anticipate what they will find there. They may do this exercise several times and find that each time different things will be revealed. As they enter (with their minds' eyes) their Room of Need, they begin to notice colors, shapes, people and things. The coach guides them to pay attention to the details by asking questions like, “What do you see, there? How do you feel, there? What happens to you, there?” The coach leads them to discover, within the Room of Need their deepest yearnings and needs, as well as memories, situations, and moments connected to these needs. As they go through this process they are encouraged to allow sounds, spontaneous moments, words and emotions to be expressed and possibly released.

There are two important elements in this exercise. One involves the Emotional Self and the release of feelings. The other one involves the Expanded Self, which comforts, supports, guides, and acts as a healing agent. After the release that happens at the end of the exercise, the coach guides participants to invite their Expanded Self into the Room to make a connection with the Emotional Self, since the Emotional Self will at that point be quite raw. The connection is a soothing, comforting, reassuring connection that helps to integrate the feelings. It stabilizes and reorganizes the emotional material.

Part III: Share and discuss.
Exercise 2: Couples exercise. Group.
Goal: To learn to clearly and communicatively verbalize needs to another person.

Part I: One is the passive partner; one is the active partner. The active partner shares with the listening partner their answers to the following questions: “What I Need Most From Myself is”, “What I Need Most from Others is”, and “The Ways I can Take Care of These Needs Are”. The listening partner mirrors the active partner after each question and answer. At the end, the partners switch.

Part II: Share and discuss with the group.
Exercise 3: Group exercise.
Goal: To enhance the ability to give and receive.

Part I: The Trust Exercise. (Maximum group of six.) The group holds each others' arms and encircles one person. The person who is in the center is instructed to “fall” on the others, trusting them and letting them completely support him or her. This goes on for two to three minutes. Eventually, the person is instructed to fall all the way, so that he or she is completely off the ground and being supported (head, arms, hands, legs, and feet) by the rest of the group. The group rocks the individual, then gently puts him or her down on the mat and allows time to relax. Once the individual is down, one person of the group supports the back of the head; two people hold the person's hands; and two people hold the person's feet. After this, each member of the group asks the individual to express what it is that he or she needs in the following terms: “(individual's name), we are here to support you. What is it that you need?” The question repeats around the circle, and the group allows the individual time to answer. The exercise ends with a group affirmation addressed to the individual: “Your needs and wants can be fulfilled.”

Part II: Homework. Participants are asked to view their life and choose the areas in which they feel the need to expand their ability to give and receive. They write a letter from themselves (the Expanded Self) to themselves. In this letter, they assert their ability to give and receive in abundance in those areas of their lives. They describe and emphasize their innate inner generosity, loving kindness, compassion, and empathy as an abundant source for giving and receiving using specific examples from the past and desires for the future. For example, someone might write this letter: “My dear ______: You're loving, sensitive, and kind and you love to express yourself and have fun with others. You know how to listen to yourself and others. Remember the time that . . . ” and so forth, describing some previous examples.

Part III: The Circle of Giving and Receiving. (Group size approx. 10.) Participants go around in a circle; each participant acknowledges something beautiful, moving, inspiring, and positive about the others. In this way, every member of the group both gives and receives positive feedback.

### Commitments for Level III:

1. Participants are asked to be aware of their needs and the ways that they can fulfill them in their daily lives. They are asked to choose two specific needs each week and attend to those needs as much as possible.
2. Participants are asked to write in their journals their progress with the process of defining and supporting their needs.
3. Participants are asked to choose three situations in which they are communicating, thinking, and acting like the giver, and to choose three situations in which they are communicating, thinking, and acting like the receiver, and to document the experience in their journals.

### Level IV:

Purpose: Freeing, releasing, and integrating the “Light Emotions”: Love, joy, and peace.

Process: Homework.

Part I: Participants are asked to write three different journal entries, describing in as much detail as possible the moments, relationships, and situations in which they experienced and expressed the Light Emotions—love, joy, and peace.

Part II: Participants are asked to meditate and write about how they are denying, masking, or avoiding these feelings.

Part III: Participants are asked to meditate and write about the ways these feelings affect their life, and to use examples.
Exercise 1: Emotional visualization followed by writing exercise. Group or private. “Visiting the Room Of Love”.
Goal: To thoroughly explore the emotion of love and cultivate the ability to witness it.

Part I. Like all laying down exercises it begins with a few minutes of relaxation techniques to quiet the mind and relax the body. The coach guides the participants to enter what is called “The Room of Love”. The Room of Love is an imaginary place within the psyche that holds memories, impressions, images and sensations connected to Love. When asked to enter that room, participants should not anticipate what they will find there. They may do this exercise several times and find that each time different things will be revealed. As they enter (with their minds' eyes) their Room of Love, they begin to notice colors, shapes, people and things. The coach guides them to pay attention to the details by asking questions like, “What do you see, there? How do you feel, there? What happens to you, there?” The coach leads them to discover, within The Room of Love, their most loving memories, situations, and moments. As they go through this process they are encouraged to allow sounds, words, spontaneous moments, and emotions to be expressed and possibly released.

There are two important elements in this exercise. One involves the Emotional Self and the release of feelings. The other one involves the Expanded Self, which comforts, supports, guides, and acts as a healing agent. After the release that happens at the end of the exercise, the coach guides participants to invite their Expanded Self into the Room to make a connection with the Emotional Self, since the Emotional Self will at that point be quite raw. The connection is a soothing, comforting, reassuring connection that helps to integrate the feelings. It stabilizes and reorganizes the emotional material.

Part II. Participants are asked to write two “love letters” to two people. The letters are not intended to be seen by the recipients, so the participants should be as open as possible and allow themselves to fully feel the emotions and express themselves.

Part III: Share and discuss in couples: anything they choose to share from the laying down exercise or from the writing of the letter.
Exercise 2: Emotional visualization followed by expressive exercise. Group or private. “Visiting the Room of Joy”.
Goal: To thoroughly explore the emotion of joy and cultivate the ability to witness it.

Part I: This is exercise is done laying down. Like all laying down exercises it begins with a few minutes of relaxation techniques to quiet the mind and relax the body. The coach guides the participants to enter what is called “The Room of Joy”. The Room of Joy is an imaginary place within the psyche that holds memories, impressions, images and sensations connected to Joy. When asked to enter that room, participants should not anticipate what they will find there. They may do this exercise several times and find that each time different things will be revealed. As they enter (with their minds' eyes) their Room of Joy, they begin to notice colors, shapes, people and things. The coach guides them to pay attention to the details by asking questions like, “What do you see, there? How do you feel, there? What happens to you, there?” The coach leads them to discover, within the Room of Joy, their most joyful, fun memories, situations, and moments. As they go through this process they are encouraged to allow sounds, words, spontaneous moments, and emotions to be expressed and possibly released.

There are two important elements in this exercise. One involves the Emotional Self and the release of feelings. The other one involves the Expanded Self, which comforts, supports, guides, and acts as a healing agent. After the release that happens at the end of the exercise, the coach guides participants to invite their Expanded Self into the Room to make a connection with the Emotional Self, since the Emotional Self will at that point be quite raw. The connection is a soothing, comforting, reassuring connection that helps to integrate the feelings. It stabilizes and reorganizes the emotional material.

Part II: The Guessing Game: Participants choose the five most joyful, fun things that make them happy, and they present it to the group. The presentation is done without speaking, as in Charades, and the group has to guess. The objective is to have fun and be silly and childlike.
Exercise 3: Emotional visualization followed by a writing exercise. Group or private. “Visiting the Room of Peace”.
Goal: To thoroughly explore the emotion of peace and cultivate the ability to witness it.

Part I: This is exercise is done laying down. Like all laying down exercises it begins with a few minutes of relaxation techniques to quiet the mind and relax the body. The coach guides the participants to enter what is called “The Room of Peace”. The Room of Peace is an imaginary place within the psyche that holds memories, impressions, images and sensations connected to Peace. When asked to enter that room, participants should not anticipate what they will find there. They may do this exercise several times and find that each time different things will be revealed. As they enter (with their minds' eyes) their Room of Peace, they begin to notice colors, shapes, people and things. The coach guides them to pay attention to the details by asking questions like, “What do you see, there? How do you feel, there? What happens to you, there?” The coach leads them to discover, within the Room of Peace, their most peaceful memories, situations, and moments. As they go through this process they are encouraged to allow sounds, words, spontaneous moments, and emotions to be expressed and possibly released.

There are two important elements in this exercise. One involves the Emotional Self and the release of feelings. The other one involves the Expanded Self, which comforts, supports, guides, and acts as a healing agent. After the release that happens at the end of the exercise, the coach guides participants to invite their Expanded Self into the Room to make a connection with the Emotional Self, since the Emotional Self will at that point be quite raw. The connection is a soothing, comforting, reassuring connection that helps to integrate the feelings. It stabilizes and reorganizes the emotional material.

Part II: Guided Imagery, sitting down (could be done laying down). Like all meditative exercises it begins with a few minutes of relaxation techniques to quiet the mind and relax the body. Participants are asked to revisit their Room of Peace and bring into it the people and situations (can include themselves) that they are at war with—for example, the landlord; a loved one; the self. The coach guides them by telling them to choose a situation in which they are in the worst conflict, and to bring that situation in. The idea is to see if the Room of Peace can in some positive way influence the feelings of conflict. The participants should not force any kind of forgiveness, etc; the exercise is a reflection, and the idea is to look at the situation from the point of view of the Expanded Self. The exercise includes an opportunity to examine two situations.

Part III: Participants are asked to write down what they refused or were not ready or able to forgive and accept, and what they could.

Part IV: Share and discuss.

### Commitments for Level IV:

1. Participants are asked to choose three people in their lives that they feel love toward, and to make a conscious effort to express their love directly to these people in a new and maybe different way from the ways they have been.
2. Participants are asked to consciously create daily time for joy, play, and fun.
3. Participants are asked to designate three times for a meditation in which they take themselves into the Room of Peace and bring into it elements of fear, pain, and anger, and to examine how the Room of Peace affects these elements.

### Level V:

Purpose: Assisting in the process of releasing and forgiving traumatic memories.

Process: Participants are asked to meditate on and write down in detail one to three extremely traumatic events in their life, and the effects of these on their present selves. At the end of the description of these events, participants are asked to pose the question to themselves: “Am I willing to experience these events as a source of empowerment and growth?”
Exercise 1: “The Multifaceted Experience of the Self.” Experiential expressive exercise in four stages. Small groups of three.
Goal: To clear out traumatic events.

Part I: There are three people in a group. The one that is active recreates the event by declaring the place, the time that it happened, and the one most important person that is connected to the event. The active participant designates one other group member to be that person and the other group member to be their own Expanded Self. Once the setting and the characters are established, the active group member attempts to go back emotionally to that moment and place and re-enact the event. The goal of the exercise is to open up to feelings that might have been repressed or not fully expressed at that point in time. For example, if you are five and a teacher is shaming you in front of the class, you might not be able at that moment to respond, and that stays in you as a frozen experience that blocks you. The active group member is playing him- or herself at whatever age they were when the event took place; the antagonist is re-enacting the situation, and the Expanded Self is supporting the active group member on in his or her efforts to express what they need to express. Participants are encouraged to feel the feelings that come with the event—terror, anger, etc—and to express the emotions in any way that they need to.

See FIG. 7, Part I to see a visual representation of the movement throughout this exercise.

Part II: Share and discuss.
Exercise 2: Writing exercise followed by experiential expressive exercise. Group.
Goal: Identifying the needs of the Emotional Self.

Part I: Participants are asked to meditate on and write about the primary need that they found in the situation from the previous exercise. What could have helped them that they didn't get at that moment?

Part II: Participants gather again in the same groups of three as for the previous exercise. They recreate the event, but now, the active participant takes the role of their Expanded Self, and the one that was playing the Expanded Self previously now becomes the Emotional Self. The participants go back to the emotions and conflict in the situation, but this time the active participant has an opportunity to experience giving themselves support, comfort, and help. They are essentially able to protect their fragile Emotional Self and give it a sense of reassurance. They are giving their Emotional Self the very thing that it needs, now in action as a continuation from the writing part of the exercise.

See FIG. 7, Part II to see a visual representation of the movement throughout this exercise.
Exercise 3: Writing exercise followed by a dramatic exercise. Group.
Goal: To experience the traumatic event from the antagonist's point of view.

Part I: Participants are asked to write about how the event they've been working through is a source of empowerment and a lesson in forgiving.

Part II: Participants go back for the third time to the event. This time, the active participant is the “antagonist”, and the one that was the antagonist becomes the Emotional Self. The Expanded Self stays the same. They re-enact the event with the active participant experiencing it from the perspective of the antagonist.

Part III: After a short pause, the group of three gathers for the fourth and last time. This time, they go back to their original roles and re-enact the event. Usually what happens is that when the event is repeated for the fourth time, we find that there is a shift and a transformation in terms of the feelings and attitudes of all three people involved. The traumatic charge of the situation is softened.

See FIG. 7, Part III to see a visual representation of the movement throughout this exercise.

### Commitments for Level V:

1. Participants are asked to write about the process they have gone through in Level V, meditating on any transformation that has occurred for them and the difference in the way they hold the experience within themselves.
2. Participants are asked, if they can, to contact and communicate directly with the person in the event they worked through, especially if they are a parent, sibling, or someone who is still close to them. They are asked to share, if possible, the new perspective they have gained about the experience. If the person is not accessible, participants are asked to write a letter that they can choose to send or to not send, sharing the same thing.
3. Participants are asked to notice the effect of releasing the charge of that event in their life, sense of self-esteem, and personal power, and to begin to practice seeing themselves as someone who is capable of protecting and taking care of themselves. It is very important to slowly but surely release a sense of victimization in as many situations and relationships as possible, and to make a constant commitment to support one's emotional self.

### Level VI:

Purpose: Mastering the ability to release negative beliefs and assumptions about the self, and establishing oneself as a source of confidence and inner power.

Process: Homework. Participants are asked to view all negative judgments, beliefs, feelings, and assumptions about themselves.

Part I: Participants are asked to write down their responses to the above question, and, based on their awareness about themselves, to define the main root for their negative beliefs/feelings. They are also asked to explore in writing: 1.) How that root belief was created and 2.) What effect it has or had on their sense of themselves. For example: “Deep down I feel I was born bad.” Or, “Deep down I feel that no matter what I do I am incapable.”

Part II: Participants are asked to write an overview of their life—past, present, and future visions and goals, and to make a connection between the root of negative beliefs that they have found and life decisions that they have made.
Exercise 1: “Balancing the Inner Aspects”—a discussion followed by experiential expressive exercise. Discussion can be group or private; dramatic exercise is for group.
Goal: To define the central root of personal suffering caused by negative beliefs/feelings. See FIG. 8 for a visual representation of the movement through this exercise.

Part I: Discussion in small groups. Each participant shares the realizations and insights that follow their homework process, especially the central root of for their negativity and suffering.

Part II: Experiential expressive exercise in groups of three. This exercise is a dramatization and physicalization of the inner conflict. The active participant assigns the other two their roles; all of them are a part of the active participant's inner life. One is playing the role of the active participant's “negative voice” (which is a part of their Defensive Self). The other plays the “compassionate listener” (which is a part of the Expanded Self). The participant him/herself is the Emotional Self. Before the exercise starts, the active participant gives each role their “text” and “character”. These are words, feelings, and attitudes known to the active participant as their “inner voices.” The active participant sits in the middle; “the negative voice” stands behind them, and the “compassionate listener” sits in front of them. The exercise starts with the negative voice starting to verbally judge, put down, criticize, offend, shame, or humiliate the active participant, who is the Emotional Self. (See FIG. 8 Part I.) The helper that plays the negative voice is using the specific text, attitude, and feelings that were given to them at the start of the exercise, but are intensifying the negative charge vocally and emotionally. Slowly, they add a physical element of gently pushing down on the active participant's head and shoulders. They continue to torture the active participant with the oppressive movement and the negative phrases. The goal is to help the active participant realize the emotional/physical effect of their own criticalness on the Emotional Self by intensifying and physicalizing the negative voice. After a few minutes, when the active participant starts to feel crushed, sad, devastated, or disturbed by the effect of their own negative voice, the compassionate voice enters the picture by starting to encourage the active participant to respond and fight back to answer, to push away, to protest, in order to free themselves from the negative voice's oppressive grip. (See FIG. 8 part II) With words and gestures, the negative voice should put up resistance to the fight by continuing to gently push down while saying the main negative phrases, in order to give the active participant an opportunity to fight for themselves. The compassionate voice keeps encouraging and rooting for the Emotional Self. All three are going for the goal, which is to empower the active participant to win the battle against the negative voice. The exercise should conclude with a feeling of relief and empowerment. Then, the participants have a few minutes to share within the group, and then they change roles.

Part III: Participants are asked to write about their experiences with this exercise.
Exercise 2: Meditative exercise. Group or private.
Goal: To deepen the energetic release of negative charge and expand the energetic ability to receive positive charge.

Part I: Release exercise using the breath.
1. After a few minutes of relaxation, participants establish breath rhythm of six counts' inhale and six counts' exhale. Then they begin seven rounds in which they inhale and on the exhale, they say out loud “I release the feeling of”—for example, “being incapable.” The participants choose the negative belief they located within the homework part of the initial process.
2. Seven rounds of inhale and exhale to the count of six, but at the end of the inhale, they say “I receive the feeling of being capable”. The purpose of this is to make it seem like the participants are breathing these words in.
3. In silence, in their minds, the participants do the inhale and exhale and say the two statements one after the other. They “inhale the positive and exhale the negative.”

At the end of the breathing exercise, participants are asked to write down what was easy for them to release and what was not, and what was easy for them to receive and what was not.

Share and discuss.

Part II: Movement. Participants are asked to establish by improvising with movement a few gestures for the release sentence they came up with in Part I, and a few gestures for the receiving statement. Once they do this, they use movement, sounds, and words synchronized with their breath to do the breath exercise from Part I, but with fuller expression. Seven rounds of the release phrase, seven rounds of the receive phrase.

Share and discuss.

Part III: “The Water Healing”—an emotional visualization exercise.

After a few minutes of relaxation, participants are asked to re-establish the breath rhythm of six counts' inhale and six counts' exhale, and to visualize themselves laying on the shore with the lower part of their body in the water. They are guided by the coach to do two cycles of release, imagining that when they release, whatever they release comes out of them as a dark colored liquid into the ocean, and is swept away. They should be open to any other images that come to their minds as they are releasing. The idea is to have a visual sense of something coming out of the body and washing away. Then, the participants are instructed to do two cycles of receiving, imagining light blue color water coming from the ocean into their body, nourishing and cleansing. Again, they should be open to any other images that come to them.

Share and discuss.
Exercise 3: Experiential emotional exercise in small groups of three. Group.
Goal: To give voice to the suffering within the Emotional Self and empower it by supporting and guiding it. (Refer to FIG. 9.)

Part I: The active participant is again their Emotional Self. The two others are the two sides of their Expanded Self: one is the Witness, and the other one is the Guide. The first is the passive side of the Expanded Self, and the other is the active. The active participant assigns the others their parts. They sit on both sides of the active participant. The coach encourages the active participant to re-enter their Emotional Self by closing their eyes and moving into the deepest suffering within their Emotional Self. They can use the Room of Fear or the Room of Pain. They do this in silence for a few minutes. Most people tend to either lay down in a fetal position or to curl up in a sitting position with their limbs close. When the two others see that the active participant has entered into their feelings, the Witness asks gently, “What are you feeling?” (See FIG. 9 Part I.) The active participant might or might not be able to answer right away. The Witness continues to ask the same question every few minutes, until the active participant begins to respond. Each time they might describe in more details their feelings of sadness, loneliness, fear, or anger, as those feelings are allowed to surface. When it feels like the active participant is totally immersed in the feelings, the Guide starts to ask “What is it that you need?” (See FIG. 9 Part II.) Again, it takes a few rounds to receive a complete response. When it becomes clear to the two helpers what is needed, they begin to communicate together in a nurturing, supportive, and encouraging way in accordance to the specific needs that the active participant has expressed. (See FIG. 9 Part III.) The two helpers must do their best to communicate the necessary elements and assist in the active participant's process of receiving comfort, courage, and reassurance.

Part II: Share and discuss.

### Commitments for Level VI:

1. Participants are asked to commit to doing the meditative release exercise at least once daily for ten minutes. They are asked to make sure they are varying the exercise by doing rotating the three forms: sitting, moving, and laying down.
2. Participants are asked to choose situations that happen in their daily lives, and commit to writing daily notes from their Expanded Self to their Emotional Self, encouraging, inspiring, comforting, or guiding—whichever one is necessary in response to the specific situation that they choose.
3. Participants are asked to write under the title “I am an Expanded Powerful Leader,” and to continue to describe themselves as a master and a creator of their life, using their imagination and envisioning a life of adventure, possibilities, and contribution.

### Level VII:

Purpose: To become the master and creator of one's life. To learn to see life as a journey of lessons in empowerment and spiritual growth.

Process: Participants are asked to list all the ways that they are committed to express their power as the master and creator of their life. These areas should be covered:
1. In what way are they committed to know, care, and honor themselves—body, mind, spirit, soul—empowered by their Expanded Self?
2. In what way are they committed to create a healthy and beautiful environment—home, work, neighborhood, town, and global?
3. In what way are they committed to their life path? To using their talents and skills? To being a contribution to themselves and others?
4. In what way are they committed to creating harmonious and successful relationships?
5. In what ways are they committed to furthering their learning and education—spiritual, scientific, creative, etc?
6. In what ways are they committed to their sense of play, adventure, joy, and fun?
7. In what ways are they committed to grounding themselves in the Self through the Gate of Silence and the Gate of Knowledge?
Exercise 1: Lecture followed by writing. Group or private.
Goal: To understand the emotional lessons of empowerment through the seven energy centers.

Part I: Lecture and Discussion. The coach presents a detailed body of information about the seven energy centers. These seven energy centers have been identified by the Vedic tradition, the Kabbalist tradition, the Taoist tradition, and even the tradition of Christian Mysticism. They are called by many names, including Chakras, Five Elements, Sefirot, Seven Sacraments, etc. There will be a lecture followed by a discussion, which includes questions and clarifications about the material covered by the coach. The coach's lecture should cover the physical placement of each one of the seven energy centers as well as the emotional and spiritual content and life lessons that are associated with each one of them. For instance, the Root Chakra is about survival. It is located at the base of the spine. So, the content in terms of consciousness within that center has to do with issues of belonging and survival—physical, emotional, etc.

Part II: Writing exercise. Participants are asked to write down their personal emotional lessons and the way they relate to each one of the seven energy centers.

Part III: Share and discuss.
Exercise 2: “Creating Inner Unison”—meditation followed by experiential expressive exercise. Group.
Goal: To understand important personal life lessons and their potential for empowerment. (Refer to FIG. 10)

Part I: Sitting meditation.
1. After a few minutes of relaxation, participants are guided to review the spiritual and emotional lessons that they defined in Exercise 1.
2. Which ones of these lessons have they already learned? Which ones are they learning right now? Which ones still need to be learned? They are given a few minutes to meditate on these three questions.
3. Participants are asked to meditate on and make a connection between their most important lessons and their life path. How are personal lessons empowering to themselves? As a result, how can they be empowering to others?

Part II: “Unifying the Expressive Self and the Emotional Self”—experiential expressive exercise in couples. Can be done in group or private.

The active participant steps into their Expanded Self. The helper plays the active partner's Emotional Self. The active participant stands behind the helper and gently puts their hands on the helper's back as a gesture of support. The active participant, embodying their Expanded Self, begins to verbalize the partnership between the Emotional Self and the Expanded Self as they walk together on their life path. This verbalization comes as a result of all the previous exercises, including the meditation in Part I. For example, the Expanded Self might say to the Emotional Self, “the two of us are life partners, and we are here together to find joy, fulfillment, and to be a contribution to ourselves and others. What you have to give is your beautiful emotions, your innocence and vulnerability, etc, and what I have to give is my wisdom, power, and clarity of vision. Together we're a powerful and capable team. There are some lessons we need to learn,” etc. Here the active participant would discuss his or her individual lessons. The main feeling of this talk is one of a team consisting of two distinct parts that act more powerfully as a whole. At the end of the exercise, the active participant playing the Expanded Self will take the hand of the helper playing the Emotional Self, and they will take a few steps together to physicalize the sense of being a team. (See FIG. 10)

Part III: Share and discuss.
Exercise 3: Group or private.
Goal: To learn to live life from a point of view of being a contribution.

Part I: Writing exercise. Participants are asked to write down what they are here to contribute. What are their unique talents, skills, and strengths? How are they willing, ready, and able to use these talents and skills to actualize their potential and contribute to others? They will share and discuss as a group their observations.

Part II: Final presentation. Participants are asked to prepare a presentation. They are encouraged to use as many materials and media—written words, music, video, paint, photography, slideshow, etc—and to engage others to be a part of their presentation. The presentation needs to be between seven to ten minutes. The theme is “The Way I am Harnessing the Power of My Emotions, Talents, and Skills to Manifest My Life as a Journey of Contribution”.

Part III: Presenting what the participants have created, in small groups, and receiving feedback from the group.

### Commitments for Level VII:

1. Participants are asked to commit on a daily basis to choices, and actions that take them towards fulfilling their life as a contribution. They should choose a project that they make a commitment to—they can engage others from their group to make a commitment to fulfill the project.

### The Gate of Dialogue

### Detailed description of the Processes and Exercises

1. In each level, an exercise or a process can be repeated more than once if needed.
2. Any part of any process or exercise can be repeated more than once if needed.
3. An exercise or a process can be broken down to even smaller excerpts to make it clearer and easier.

### General Goals for the Gate of Dialogue:

1. To understand the three aspects of the self: the Emotional Self, the Defensive Self, and the Expanded Self.
2. To be able to distinguish and recognize between them at any point in time and become aware which one of the three is the main one that one is operating from.
3. To become aware of the unhealthy and destructive patterns of inner dialogue that one is currently operating from, and getting the skills to create new inner dialogue and new patterns of inner relating.
4. To learn to engage in an empowering, healthy dialogue between the three aspects of the self, and to learn the ground rules of healthy dialogue with others.
5. To establish the Expanded Self as the leader of the inner space and life.

There are commitments that participants take on connected to each level of the Gates. These commitments are like assignments to be done between weekly meetings at home. They are noted at the end of each level.

Gates of Power establishes seven different levels of inquiry that support developing, healing, and strengthening healthy relationships with the self and others. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

### Level I:

Purpose: Understanding the three aspects of the self.

Process: Participants are asked to choose a charged situation or a relationship in their life and try to view it from the three different perspectives: the perspective of the Emotional Self, the perspective of the Defensive Self; and the perspective of the Expanded Self. They are asked to write the situation, and then write about it through the eyes of each one of the aspects.
Exercise 1: Group or private.
Goal: To explore the three aspects. (See FIG. 11)

Part I: The coach explains in detail the three aspects of the self, and demonstrates with three different people how the three aspects are positioned and relate to each other.

As stated in the Overview, in the Gates of Power Method, the psyche is divided into three aspects: the “Emotional Self,” the “Defensive Self,” and the “Expanded Self” The Method provides guidance in harmonizing and strengthening the self through the understanding of these three parts of the psyche. When we connect to our Expanded Self, we learn to live life from the most healthy and empowered perspective. Our connection with the Expanded Self helps us to accept the Emotional Self as a source of connection, creativity, and joy, and we learn to guide and redirect it so that difficult feelings do not become destructive to ourselves and others. In this way, our emotional power becomes a constructive force in our lives. Our connection with our Expanded Self also helps us to become aware of the Defensive Self and work towards softening its constricting influence. Gates of Power Method uses inner dialogue exercises to help establish a healthy relationship between all three inner parts.

Part II: Each person creates a triangle with three spaces, one for each aspect, with the Expanded Self at the top of the triangle, and the Defensive Self and the Emotional Self facing each other at the bottom of the triangle. The coach asks participants to sit first in the place of the Defensive Self and to enter the world of the Defensive Self, and they are asked to notice the pattern of thoughts, feelings, attitudes, outlook, the way the body feels, the breath, and lastly, the way that the Defensive Self feels towards and relates to the other two. (See FIG. 11 for a visual representation of the movement through the three aspects, with the asterisk representing the Participant.) This is a way to explore experientially the world of each one of the aspects. After experiencing the Defensive Self, the coach asks the participants to move to the seat of the Emotional Self and do the same: explore the thoughts, feelings, attitudes, outlook, the energy in the body, the breath, and lastly, the way the Emotional Self feels toward and relates to the other two. Then, the participants do the same with the Expanded Self. This is all done in silence; each person gets to experience and explore that for themselves, silently.

Part III: Participants are asked to write down their experience in each one of the places.

Part IV: Share and discuss.
Exercise 2: “The Inner Conflict between the Defensive Self and the Emotional Self” Discussion followed by experiential expressive exercise. Group. (Refer to FIG. 12)
Goal: To uncover and become aware of the dialogue between the Emotional Self and the Defensive Self

Part I: The coach explains about the innate conflict between the two aspects—the Emotional Self and the Defensive Self—and demonstrates it with two participants. The Defensive Self is always trying to project a good image socially. It is always engaged in some kind of criticism or repression of the Emotional Self. Mostly, the parts of the Emotional Self that are vulnerable or “socially unacceptable”. The Defensive Self is the part of us that is constantly attempting to achieve status, a sense of power and control, attention, validation, and a sense of safety. Everything within the Emotional Self that might threaten this is rejected by the Defensive Self, so there is obviously a constant conflict between these two until such conflict can be resolved. (See FIG. 12, part I)

Part II: Couples. Group.

The active participant sits first in the place of the Defensive Self, facing the Emotional Self, represented by the partner. The active partner expresses their feelings to the Emotional Self from the point of view of the Defensive Self, which is many times critical and diminishing or repressive, at times condescending, or, at best, trying to keep the Emotional Self inactive. After the active participant completes the conversation with the Emotional Self, they switch places. The helping partner takes the place of the Defensive Self, and the active participant sits in the place of the Emotional Self The helping partner echoes the attitude of the Defensive Self, and the active partner gets to feel, sitting in the Emotional Self, the effect of the negative, controlling attitude of their own Defensive Self. They also get to respond to it from the point of view of their Emotional Self. The active partner goes back and forth between the two until the conflict and the destructive nature of their dialogue is totally revealed. After a pause, they switch places; the active partner becomes the helper, and vice versa. (See FIG. 12, Part I and II)

Part III: After the exercise, every participant takes a moment to write down what was revealed to them.

Part IV: Share and discuss.
Exercise 3: “Critical Projection and its Negative Effect.” Meditation followed by experiential expressive exercise. Group.
Goal: To realize and understand the connection between one's inner Defensive Self and the defensive ways one lives with when relating to others. (Refer to FIG. 13.)

Part I: Participants are asked to meditate on and write about the connection between the way they treat themselves (that is, the way their Defensive Self treats their Emotional Self), and the way they treat others. They are asked to inquire of themselves: are they projecting their criticism on others? Are they projecting that they are criticized by others the way they criticize themselves? The goal is to understand that a weak Emotional Self brings about insecurity, lack of confidence and lack of self-esteem, and a strong Defensive self, a critical voice, brings about defensiveness and criticism toward others. Participants are asked to give specific examples from their lives where they realize the effects of their internal criticism on the way they feel towards and see others. They are also asked to give examples from their lives where they see the effect of the weak, unsupported, and insecure Emotional Self on their relationships with others.

Part II: Exercise in couples. The active partner chooses someone specific in their life that they criticize and judge, either out loud or internally, and asks the partner to be that person. The active partner has an opportunity to voice their criticism and judgment in the most frank, maybe even brutal way, so that they can actually see and feel the effect of their criticism on themselves and on the other. (See FIG. 13, Part I.) In the second round of the same exercise the active partner chooses someone they feel is criticizing them, and asks the helper to portray that person by voicing the critical words to the active partner so they can feel the effect of criticism from another person on them. (See FIG. 13, Part II.) After a pause, the partners switch roles: the active participant becomes the helper, and vice versa.

### Commitments for Level I:

1. Participants are asked to pay attention to and write notes about three important relationships in their lives. How are they within these relationships? What specifically? What aspect of the three dominates any one of the three relationships that the participant chooses to write about?
2. Participants are asked to keep a journal with three colored pens and write down at least one dialogue daily in which they learn to voice the three different aspects and write each one of them in a different color.

### Level II:

Purpose: To become aware of the Expanded Self. To learn to address the two other aspects from the point of view of the Expanded Self in order to gain the skill of creating a unifying, healthy inner dialogue.

Process: Participants are asked to choose three challenging situations in their lives and to view them through the eyes of their Expanded Self. They are asked to write down in specific details: 1.) How they feel about the situation; 2.) How they perceive the people that are involved; 3.) What is the course of action and the dialogue that springs from the point of view of the Expanded Self.
Exercise 1: “Unifying the Inner Space”—experiential expressive exercise. Group or private.
Goal: Experiencing the Expanded Self and its relationship to the other two aspects, the Emotional Self and the Defensive Self. (Refer to FIG. 14.)

The active partner assigns the two others the roles of the Defensive Self and the Emotional Self. They sit in a triangle with the Expanded Self at the top of the triangle and the others facing each other.

Part I: The active participant takes a minute to ground his/herself in the Expanded Self and to watch the other two from that point of view. (See FIG. 14 Part I, where the dotted lines mean there is observation but no communication.) They should note: 1.) How they feel about the other two aspects; 2.) What they think about them, especially about their conflict with each other; 3.) From the point of view of the Expanded Self, what they are moved to say, do, and create, or how they feel they must intervene in order to balance and unify the “inner space” that all three of them occupy.

Part II: The active participant, the Expanded Self, speaks to the two others, addressing each one of them in a way that would make a difference. (See FIG. 14 Part II, where the solid lines mean speaking.) They need to remember that the Expanded Self is the wise, compassionate, healing agent within them. That aspect does everything possible to find what would help create a healthier balance. As with all exercises involving other participants, after each partner's turn, the three take a short pause and choose the next active participant while the two others occupy the roles of the active participant's Defensive and Emotional Self

Part III: Share and Discuss.
Exercise 2: “Establishing the Relationship between the Selves”—writing followed by experiential expressive exercise. Group or private.
Goal: To learn to create a constructive dialogue between the Expanded Self and the Defensive Self. (Refer to FIG. 15)

Part I: Writing exercise. Participants are asked to write a dialogue between the Expanded Self and the Defensive Self as they would write a dialogue between two people. They should note that the Defensive Self usually has very little trust toward or understanding of the Expanded Self, and is not interested in their point of view. The Expanded Self has to find a constructive way to achieve dialogue with the Defensive Self, which is not an easy task.

Part II: Couples. The active participant reads the written dialogue to the helper in order to give them a sense of the role of the Defensive Self. Once the two are clear about the dialogue, they do it live. They improvise and try to stay as close to the original dialogue as possible. In the first round, the active participant plays their Expanded Self while the helper plays the Defensive Self. The active participant moves into the role of his/her Defensive Self and the helpers sit in the role of the active participant's Expanded Self. They repeat the dialogue. At the end of the two rounds, they switch and the helper becomes the active participant. This exercise is done in order to train the active partner to strengthen their ability to deal with their own Defensive Self constructively. After a pause, they switch. (See FIG. 15, parts I and II.)
Exercise 3:
Goal: To learn to create a healing, supportive dialogue between the Expanded Self and the Emotional Self in order to strengthen and free the Emotional Self (Refer to FIG. 16)

Part I: Participants are asked to write a dialogue between their Expanded Self and their Emotional Self. The dialogue is written as if it were a dialogue between two people.

Part II: Same two partners as the previous exercise. The active partner is the Expanded Self, and the helper is the Emotional Self. As before, the active partner reads the dialogue to the helper in order to give them an idea of how to play the role of the Emotional Self Once clear, the two partners go about actually improvising and acting out the dialogue as closely as possible to the original written dialogue. After the first round, the active participant sits in the Emotional Self and the helper in the Expressive Self. At the end of the two rounds, they switch and the helper becomes the active participant. (See FIG. 16, where the two aspects communicate and then switch.)

### Commitment for Level II:

1. Participants are asked to engage in at least two weekly dialogues about specific issues in their lives. In each dialogue, they are asked to write all three points of view—feelings, thoughts, and behavior. They are then asked to write a dialogue between their Expanded Self, and 1.) the Defensive self and 2.) the Emotional Self, about a specific issue they have chosen.

### Level III:

Purpose: To learn to utilize the supportive dialogue between the Expanded Self and the Emotional Self for the purpose of healing, strengthening, and freeing the Emotional Self

Process: Participants are asked to choose and meditate on three difficult, traumatic, or challenging events in their past and write a dialogue between their Expanded Self and their Emotional Self about these difficult, traumatic events. They are asked to write three separate dialogues, one for each event. When writing the dialogue, they are asked to first let their Emotional Self describe the event, or to describe it through the filter of the Emotional Self. Only after the point of view of the Emotional Self is thoroughly expressed and explored, does the Expanded Self come into the dialogue with the goal in mind to ease, comfort, and guide the Emotional Self so that it can release some of the difficulty or the difficult feelings of the experience.

Exercise 1. Small groups of three.

Goal: To heal the Emotional Self. (Refer to FIG. 17)

Part I: Feeling meditation/laying down exercise. It is best to do this by lying on the side. After a few minutes of relaxation, the coach guides the group by asking each participant to travel into one of the traumatic events they wrote about in their process. They should choose the event that has the greatest charge for them. As they travel into that event in their minds, the coach is asking them to enter the time and space of the event and relive the experience as much as possible by regressing into the person that they were in that time or space and reliving that experience. The coach encourages the participants to feel the feelings and, if they need to, cry or scream or allow the body to move freely—whatever needs to happen in order to feel fully the impact and the feelings of the event. The coach encourages the group to go as deep as possible and to be aware that whoever is around them is going to be crying, screaming, or sobbing. They should try to use the sounds and feelings of others not to distract but to create a safe space, knowing that others are living the same experience.

Part II: “Healing the Emotional Self, Stage I”—experiential expressive exercise. Participants write some notes about what they experienced in the exercise.

Part III: Groups of three. The active participant plays their own Emotional Self. He or she chooses two other partners, each one of them a different aspect of the active participant's Expanded Self. One aspect is called the Witness; the other is called the Guide. The two helpers sit next to the active participant and they all go back to relive the experience the active participant just did. The helper playing the Witness asks them “How do you feel?” and the active participant is encouraged to speak about their feelings as they're going through them. (See FIG. 17, Part I; the Witness is communicating with the Active Participant while the Guide observes.) After a few minutes, the Guide begins to gently guide the active participant, asking him or her, “What is it that you need?” (See FIG. 17, Part II; the Witness silently observes while the Guide speaks to the Active Participant.) The two aspects of the Expanded Self, the Guide and the Witness, are there to facilitate the active participant's ability to speak about their experience and what it is they need.

Exercise 2. “Healing the Emotional Self, Stage II”—experiential exercise. Couples.

Goal: To heal the Emotional Self. (Refer to FIG. 18)

Part I: Participants are asked to write from the point of view of the Expanded Self: “how do I need to guide and nurture my Emotional Self?” Based on what they've learned up to now, they are asked to feel into and intuitively write about this question.

Part II: The active participant plays both sides of the Expanded Self—the Witness and the Guide. The helping partner plays the role of the active participant's Emotional Self. The helper should be played by one of the people who was involved in the previous exercise, so they're familiar with the active partner's Emotional Self and their distress, suffering, and needs. The active participant—now in the role of his/her Expanded Self—repeats the questions first—“What is it that you feel?” and “What is that you need?” and then guide the Emotional Self with loving and comforting words and whatever intuitively feels appropriate. (See FIG. 18, where the Active Participant is addressing both questions vocally to the Emotional Self.) It is very important that the helper, playing the Emotional Self, is deeply engrossed and in the most authentic way representing the active participant's Emotional Self. Most participants by this time would have a deep sense of their own suffering and needs; it should be easy for one participant to be helping another with true representation of their Emotional Self

Part III: Share and discuss in the same groups about the exercise.

Exercise 3: Writing. Group or private.

Goal: Healing the Emotional Self

Part I: Participants are asked to write two letters, one from their Emotional Self to their Expanded Self, and the other from their Expanded Self to their Emotional Self. These two letters are a beginning of a committed, loving, and constructive communication between these two aspects of the self. The Expanded Self reassures the Emotional Self that it will be there to listen, guide, comfort, support, and witness; the letters are a commitment to a deep partnership.

Part II: Share and discuss.

### Commitments for Level III:

1. Participants are asked to find moments two or three times a day where they connect with the Emotional Self from their Expanded Self, and to find out how the Emotional Self feels and what it needs in order to address it.
2. Participants are asked to find two or three times to watch out for defensive reactions and expressions that come out of their Defensive Self. They should be watching their Defensive Self from the point of view of the Expanded Self, and looking for ways to communicate with it, especially in moments where the Defensive Self might be attacking the Emotional Self. They should make a point to stop for a minute and address the situation from the point of view of the Expanded Self

### Level IV:

Purpose: To establish the Expanded Self as the leader of the inner space and life.

Process: Creating relationships that work.
1. Participants are asked to meditate on and write about what shifts within their inner dialogue are needed in order to create a unified, healthy, harmonious inner space.
2. Participants are asked to meditate about their relationships with others. They should choose a few important relationships and write about their way of being and relating within these relationships, especially looking at the ways they might be inauthentic or incomplete or not acting with integrity in the way they relate. They should ask themselves what the necessary shifts are within themselves and in the way that they relate to create healthier, more intimate and authentic relationships with these people, and how they can use their understanding of the three inner aspects to achieve it.
Exercise 1: Discussion followed by writing. Group or private.
Goal: To learn to be authentic, complete, and act with integrity within all relationships.

Part I: Discussion generated by the coach on the theme of patterns in relationships what are the reasons that we aren'table to create intimate, honest relationships with integrity? The coach guides discussion towards the question “What is in our way of creating true and successful relationships?” Some points that need to be emphasized in the discussion are:
1. The illusion of separation that creates fear and defensiveness. On one level the sense of separation deepens the mistrust between people. On the other hand, that illusion of separation creates a sense that we need to make an effort in order to be close and related, and that effort many times is in the way of actually just trusting that we are connected.
2. The discussion should also cover the fact that when people are unable to provide a sense of love and appreciation toward themselves, they put a tremendous amount of expectation on others to fulfill their needs. Unrealistic expectations prevent us from accepting the other; we tend then to make the other “wrong,” fight them, manipulate them etc. Dependency creates a lack of real intimacy.
3. The discussion should also include the need to re-educate the Emotional Self about the fact that we are already one energy, interconnected and related within the oneness of life. Learning to hold relationships in a place of sharing, learning, co-creating, and having fun and joy should be the primary goal.

Part II: Creating authenticity within our relationships. Within this part of the exercise, participants are asked to write about the way they relate ad connect their observations to their understanding of the 3 aspects of the self and their influence on the relationship:
1. To themselves. They are asked to look into their relationship with their own self and see the ways in which they are authentic, responsive, communicative, open, and acting with integrity in the relationship. What ways are they not?
2. To loved ones or the people close to them. They are asked to choose between three and five people who are very close to them and examine those relationships. In what way are they authentic, communicative, responsive, open? Acting with integrity? What ways are they not?
3. To people who are not necessarily close, but are around them. Co-workers, people within the same community, casual acquaintances? In what ways are they authentic, responsive, communicative, open? Acting with integrity? In what ways are they not?
4. To nature. In what ways are they authentic, responsive, communicative, open, and acting with integrity in their relationship with nature? In what ways are they not?
5. To their own concept of the Divine, whether God, Spirit, Creative Intelligence, or something else. In what ways are they authentic, responsive, communicative, open, and acting with integrity in their relationship with the Divine? In what ways are they not?

Part III. Participants are asked to look at everything they wrote in Part II. They are asked to identify a typical way of being in relationships, and to make a connection to where and when this typical behavior started, and what they see and understand about their way of relating. What are some of the insights they gain by looking at the way they are relating?

Share and discuss. The coach should bring up the two concepts—one, the payoff, and two, the cost. The payoff relates to why we stay safe and defensive and non-intimate in our relationships, and the cost relates to the way we “pay” with our aliveness, fulfillment, and joy the “cost” of staying safe. These two concepts need to be discussed in depth.
Exercise 2: “Creating a Sense of Completion about the Past”—a meditative exercise. Group or private.
Goal: To clear and complete the past. (Refer to FIG. 19)

Participants are asked to lie down or sit up. After a few minutes of relaxation, they are asked to begin to review their lives. The coach guides them to review segments of their lives, starting with the first five years. The questions asked include: What do I remember of the first five years of my life? What are the things I feel imprinted themselves within me during those years? What is lingering as an incomplete experience, as something that I have not yet understood, cannot accept, forgive, am puzzled about, hurt about, confused about, etc? Participants are asked to choose a couple of incomplete moments, events, situations, or times, and complete them by first fully accepting the feelings that are there, and then bringing the point of view of the Expanded Self into the situation and looking at the situation from the Expanded Self's point of view. They are asked to find what the lesson is of that moment, event, or situation—what is the opportunity that was presented there? What is the gift of that event or situation? What can be taken and made to be an empowering asset? Who and what needs to be forgiven? What needs to be released and what needs to be appreciated and celebrated? After a few minutes of allowing participants to go through this process, the coach continues by asking them to take the next five years of their lives, between five and ten, and do the same thing. Participants should examine events, memories, and moments that feel incomplete, unsettled, unsettling, confused/confusing, etc, and do the same thing—look at the situation from the point of view of their Expanded Self to find the lesson and the forgiveness in it. This continues in five-year increments until the current age. Some of the younger participants will have less work to do in this exercise. See FIG. 19 where the boxes represent the stations of life 5 years apart.

Part II: At the end, participants are asked to write down what happened for them during the exercise—what transformations occurred, what insights? What parts of their lives were they able to make peace with and gain a different perspective about?.
Exercise 3: Discussion and meditation. Group or private.
Goal: Completing relationships.

Part I: Discussion about the importance of completing relationships. An incomplete relationship means that there are feelings, thoughts, and communications that have not been explored thoroughly, and an incomplete relationship might have residue of unsettling feelings that are not resolved. There is also a sense of not being able to put something to rest to allow it to be complete and finished. Incomplete relationships do not allow us to be in the present moment in our current relationships, or be able to be intimate and open within them. This is why it's necessary to learn to complete relationships to create the kind of communication that puts things to rest and allows us to be in the present and available to the moment.

Part II: “Completing Relationships”—a meditative exercise. Can be done sitting or lying down. Just like in all meditative exercise, participants will take a few minutes to relax and quiet the mind. After these few minutes, the coach guides participants to enter their “heart space”—their feeling space, which is for most people around the chest area. The coach asks participants to bring, one by one, the three relationships that they have chosen as incomplete into their heart space. They allow themselves to imagine the first person entering the space, and to take the time to feel what they need to feel as they look at that person, imagine that person, etc. Specifically, what is incomplete about this relationship? What is not expressed? What is unresolved or frustrating? As the participants do this within the heart space, they should allow themselves to express to that person the truth of their feelings and allow themselves to accept and see that person with fresh eyes. In this exercise, participants are encouraged, if they need, to speak out loud or whisper. Alternately, they can do the communication silently in their minds. The coach gives them a few minutes to be with each one of the people they have chosen. The guiding questions that the coach is going to ask with each person that enters the heart space are: What do I feel towards this person? What is that I want to express—loving or frustrated/angry/hurt/etc? What do I need or want to reach out and ask for? How do I care for and nurture this person? At the end of each process with each person, the coach asks participants to pay attention to whether the feelings associated with this person and relationship have changed. Are they feeling more at ease or at peace with this relationship?

Part III: Participants are asked to write down some of the important communications that they are willing to engage in with the people that they chose.

### Commitments for Level IV:

1. Participants are asked if possible to communicate with the three people that they have chosen for their exercise and to actually sit down and have a conversation—ideally face-to-face—with that person. They should make the attempt to be as communicative, authentic, accepting, and open as possible so that they can complete those relationships.
2. Participants are asked to make sure that if there is any lingering residue of incomplete events, situations, memories, etc, in the past, they should become aware of these incompletes and repeat the process that they went through when they were completing their own past, as many times as necessary. It is very important that the past is completed so that they can begin to live in the present moment rather than remaining stuck.

### Level V:

Purpose: To learn and acquire the skills for intimate communications, or to improve the existing ability and the skills for it.

Process: Participants are asked to meditate and write about what is most important for them in terms of intimate connections with the people that are close to them. A sense of intimacy is a sense of a heart connection—the ability to be comfortable and safe, to express feelings and to understand the other person and accept them/grant them the space to have their truth and feelings. Intimate communication means a sense of mutual support, a sense of honesty, authenticity, and comfort. Participants should write down where in their lives and in what relationships they are able to maintain and develop intimate communication, and in what relationships they are unable to develop and maintain this kind of intimate communication. They should also ask themselves how important intimate communication is for them, why it is important if it is, or why it is not important if it isn't.
Exercise 1: “Effective Emotional Communication”—an experiential expressive exercise in couples. Group or private.
Goal: To realize ways of relating and communicating that enhance closeness and ways of thinking and communicating that frustrate relationships.

Part I. Couples. Intimate communication takes place between two people that share closeness. The coach asks a list of questions about intimate communications, and gives time to respond. While the coach is asking the questions, the active participant shares the answers to the questions. After the questions, the second person becomes the active participant and answers the questions. The questions are as follows:
1. My deepest desire and need within intimate relationships is to: ______
2. In my intimate relationships, I get most frustrated when my partner: ______
3. The feelings I experience are: ______
4. I usually react by: ______
5. This makes my partner: ______
6. My partner's reaction deprives me of: ______
7. Which leaves me feeling: ______
8. What is it that I understand when I look at this pattern of my intimate relating?______

After the second partner has answered the questions, there is a few minutes' free sharing and discussion.

Part II: The same two partners team up again to do a repeat of the exercise; this time, before the exercise, they meditate on how they would want to react and feel so that the end result is fulfillment. The coach repeats the same questions with a couple of little changes, and the active partner answers them. At the end, they switch. The questions are:

1. My deepest desire and need within intimate relating is to: ______

2. In my intimate relationships, I get frustrated most when my partner: ______

3. The feelings I experience are: ______

4. The best way for me to react is by: ______

5. This makes my partner: ______

6. My partner's reaction supports me by: ______

7. Which leaves me feeling: ______

After the second round of questions, the partners have a few minutes of discussion and sharing. The most important point in the sharing is to discuss what they needed to shift in the way they were reacting to create a fulfilling experience rather than a frustrating one.
Exercise 2: “The Three Aspects and how Each Communicates”—an experiential Expressive Exercise in couples.
Goal: To cultivate the ability to share and communicate from a place of truth and vulnerability as opposed to a place of defensiveness.

Part I. Two partners take turns. The active partner chooses a situation from the present that is very charged for them. It could be a relationship with a mate, a child, a parent, a good friend, etc, but it should be a relationship that is at this moment challenged. They take a few minutes to share the relationship and their difficulties within it with their partner. Then, the active partner assigns the other the role of the person with whom they have the difficulty. The first time they do the exercise, they consciously choose to approach from their Defensive Self, and speak to the partner playing the role of the other person from the point of view of their Defensive Self about the situation. After a few minutes of the Defensive Expression towards the partner, the active partner stops and asks for feedback. What was their reaction to the communication? Did they feel compassionate, open, willing to resolve, close? Or, did the defensive way that they approached cause feelings of defensiveness, shutting down, anger, blame, etc in the listener? Most times when we express ourselves from the point of view of the Defensive Self, we create a wall around the other person. Defensive communication does not allow for open and honest intimate conversation, and the exercise is a way to realize that.

Part II. The active partner takes the same situation and tries to communicate the same thing to the other person. This time, however, he/she will approach from the Emotional Self, from a place of vulnerability that is not blaming, attacking, or pointing fingers, but just sharing their feelings in a very honest and truthful way. After they finish, the active partner asks the other partner how they felt this time in the reactions to the communication. Did they feel open, accepting? Was it easier to “hear” the communication? Etc. It is obvious that when one comes from a more vulnerable, honest way of communicating, it is easier for the listener to hear the communication. Because they are not blamed or attacked, they are able to listen better. This exercise is intended to clarify that defensive communication does not work and to help participants distinguish when they are being defensive and when they are being open, truthful, and vulnerable. After the active partner has gone twice, once as Defensive and then as Emotional, the partners switch roles and repeat the exercise a third time to include the Expanded Self as well.

Part III: Share and discuss, in larger group.
Exercise 3: Couples. Group.
Goal: To learn the art of mirroring.

The same two partners from the previous exercise pair up. The active participant goes back to the situation from the previous exercise, and they approach the helper from a place of vulnerability. The helper is playing the role of the active partner's real life partner or friend. The helper is there to learn to mirror; they are listening very carefully to the communication. They listen to the words, gestures, and intentions, and when the active participant finishes expressing, the helper begins to mirror them. Mirroring means echoing back to the speaker what your understanding is of what the other person feels. For example, they could use a sentence like this: “What I understand when I listen to you is that you are feeling really upset and that you're interpreting something that I did as if I don't care about you. I also feel that you're angry,” etc. The person who is mirroring is allowing the active participant to see that they actually understood them. Mirroring is a very important part of communication, and it takes a tremendous amount of skill to know how to mirror and give the expressive partner a sense that they were fully heard and understood. The person who is mirroring needs to ask at the end of the mirroring if they “got it”. They will get a confirmation or a partial confirmation. In case of a partial confirmation, the mirroring must be repeated until a full understanding is achieved. After that happens, the two switch roles, and the active participant becomes the mirror, and the mirroring helper becomes the active participant. After they finish, they take a minute to discuss among themselves how it felt to be mirrored.

### Commitments for Level V:

1. Participants are asked to pay attention to their communication with others, and to practice the ability to speak from honest, true feelings rather than defensive attitudes. They should take every opportunity to practice that ability, and definitely use the exercise within their intimate, close relationships. They should write about their attempts—what was easy and what was difficult? When did they succeed and when did they not?
2. Participants are asked to practice the art of mirroring as much as possible, especially in their intimate and close relationships. Also, they should spend some time writing about specific times when they were able to minor the other person and when they were unable to do so, and why

### Level VI:

Purpose: To practice and understand the Ten Commandments for Successful Communication.

Process: Participants are asked to write down what they think are the ten most important guidelines for successful communication, and next to each one of the ten, write down whether they feel they are successful at doing that guideline. For instance, if a participant chooses “being honest, vulnerable, and coming from emotions” as an important guideline, then next to that guideline, they should grade themselves—how are they doing with it, from 1 to 10, and what would they like to improve in terms of their ability to fulfill this guideline?
Exercise 1: The first three Commandments of Successful Communication.
Goal: To understand the first three commandments and be able to practice them. (Refer to FIG. 20)

Part I: Discussion. The coach discusses the three first commandments with the group. The first is to commit creating a successful dialogue. The second commandment is be with your reactions, and the third is right time, right place. The coach explains and helps to create a discussion about each one of these commandments.
1. Commit to creating a successful dialogue. This is done by creating a safe place for sharing. How do we do that? Each one of the partners in the dialogue needs to be committed to a successful dialogue rather than to being right. They need to be committed to creating a place where both sides are heard and have the right to their feelings and perceptions, and as much as possible, drop expectations, judgments, and desires to control and manipulate. This is a commitment to a successful dialogue and a safe place for both people to share.
2. Be with your reactions. This means before starting to communicate with another person about feelings or thoughts, especially when one is emotionally reactive, one should sit with oneself to find out what is going on. They should find out the source, history, and nature of their feelings, and entertain the idea that they are responsible for their feelings and for attending and supporting them.
3. Right time, right place. It is important to make sure that the partners for a dialogue choose appropriate time and space to have an important conversation, creating together the right conditions for the conversation.

Part II. After the discussion, participants are asked to work in couples and practice those three commandments. They find an important subject. Each one takes a turn to bring to the other a topic that is extremely important to them, trying to follow the three important commandments while discussing the subject. They should take responsibility for a successful dialogue. The topic that each active partner chooses to bring should be something they're struggling with in their life presently. The helper represents the person that the active partner is struggling with in terms of communication. The participants are asked to choose challenging topics of communication and follow the guidelines. Once they're finished, they ask for feedback from their partner. Do you feel that I have committed to creating a successful dialogue? Did you feel that I was taking care of my own feelings and not dumping them on you? Did you feel that I found the right time and the right place to present the topic in a way that felt constructive? In this exercise it's very important that the helper is telling the truth in terms of their feedback. At the end of the exercise, they switch roles—the active participant becomes the helper, and vice versa. (See FIG. 20 where two participants communicate using the first three Commandments.)
Exercise 2: Discussion followed by couples. Group.
Goal: To understand and master the Ten Commandments for Successful Communication: Commandments 4, 5, 6, and 7. (Refer to FIG. 21)

Part I: Discussion. Commandment four: Speak using the four magic I's: I feel, I need, I want, I think. The coach presents the fourth commandment and opens the discussion. This commandment is about talking directly about your experience using I's instead of Yous, to avoid pointing a finger at the other person and talking about their feelings and what they need to do or not do. The goal is to stay with the subjective experience and express that, since our experience is the only thing we really know.

Commandment five: Ask to be mirrored. This commandment is about wanting to be understood, and when a person ask to be mirrored, the listener has a chance to pay careful attention and echo or minor the person in such a way that they can feel understood. They do not have to agree, but they must learn to acknowledge the other's point of view.

Commandment six: Invite your conversation partner to share. After you have expressed feelings and felt that your partner mirrored you, it is time for you to ask them to share while you become the listener. If needed, remind them to speak from their subjective experience (the magic I's).

Commandment seven: Mirror your partner's communication. After your partner is done, mirror back to them as accurately as you can what you heard and how you understand their experience. Find out if what you have understood is what they really meant.

Part II: After the discussion about Commandments 4, 5, 6, and 7, participants are asked to practice speaking using the four magic I's. Again here, they work in couples. They can go back to the same difficult, charged conversation they've been working with, or choose another one. Here again the active partner asks the helper to be the person they have the difficulty communicating with in their life. They practice using the magic I's—I feel, I need, I want, I think—to express what it is that they need to express. This is another way to make sure that one comes from their true feelings rather than defensiveness. After they've expressed themselves, they ask for feedback. Was the way they communicated clear, honest, truthful, and effective? The helper should be as honest as possible when they give feedback. (See FIG. 21.)
Exercise 3: Discussion followed by writing. Group.
Goal: To understand and master the ten commandments for successful communication: commandment eight, nine, and ten.

Part I: discussion about the three remaining Commandments.

Commandment eight: complete communication. This means that the two partners agree that everything that needed to be said at this point in time was communicated and understood. If there are any residues, additional rounds of communication might be necessary until everything that is pertinent to this specific topic has been expressed

Commandment nine: After all is said, acknowledge your partner and sit together in silence for a few minutes. Allow the new space of understanding that was created to breathe.

Commandment ten: Be open to new possibilities. After all has been communicated and both points of view have been accepted and acknowledged (even if not agreed), we need to be open to new possibilities for the relationship to go to a new level. At this stage, being open to create new agreements, negotiations, and solutions.

Each commandment is discussed.

Part II: Participants are asked to look at the challenging relationship or communication that they've been working with in the exercises, and to write down which one of the ten commandments is the most needed in order to complete and resolve the difficult or challenging situation. This is introspective writing where participants view the relationship and try to realize which of the ten commandments is needed most to resolve the relationship. It might be that several of the commandments are equally important. After the period of writing and meditating, there is a share and discuss.

### Commitments for Level VI:

1. Participants are asked to meditate on the Ten Commandments for successful communication, and to choose in daily life to follow as many of them as possible in communications.
2. Participants are asked to practice speaking using the four magic I's.
3. Participants are asked to practice being with their reactions. This means before they begin communicating with others, especially when they find themselves emotionally reacting, they should sit down and write what they're feeling. They should find the source, history, and nature of their feelings and to find what they need to give themselves. They might find that afterward, they're actually a lot calmer, less reactive, and more capable of having a successful communication.

### Level VII:

Purpose: Understanding the rules for creating successful partnerships and relationships.

Process: Participants are asked to meditate on and write about what they find to be the most important ground rules to creating successful, harmonious, and empowering relationships. They're asked to look at all the lessons that they've learned until this point in time: what has worked and hasn't, what is empowering and isn't, what gives them joy and fulfillment in relationships and what is frustrating. With accordance to their understanding until now, participants should define seven ground rules for creating successful partnerships.
Exercise 1: Group. Discussion followed by creative exercise.
Goal: To discuss the Seven Ground rules for Successful, Fulfilling Partnerships as defined by the Gates of Power. Method. Partnerships can mean romantic, creative, business, friendship, etc—anytime two or more people come together to create something greater than themselves.

Part I: Discussion. Participants are asked to share the ground rules for successful partnerships that they came up with during their process. Together as a group, they try to find similarities between ground rules of different participants. While discussing, the group tries to come up with the ground rules that most people need, and how to define them, so that they can create seven ground rules that the group mutually agrees on.

Part II: The coach presents the seven ground rules, according to Gates of Power, for creating successful partnerships.
1: Acceptance. This means acceptance of both ourselves and the other, and the way that both parties of a relationship are at this point in time, including our own feelings, thoughts, state of mind, questions, etc, as well as theirs. Acceptance means embracing the present moment.
2: Being 100% responsible. This means taking full responsibility for everything that happens within the inner and outer lives. This includes taking 100% responsibility for the wellbeing of our relationships. 100% responsibility means guarding, keeping, enhancing and cultivating the relationship in any way possible, at all moments. We should understand that we are the cause and generator of the wellbeing of any relationship we're engaged in, and that we should avoid trying to blame the other for the state of the relationship. Each person within a relationship should see themselves as 100% responsible.
3: Being authentic. This means trying at all times to be as open, honest, vulnerable, direct, and communicative with our thoughts, feelings, needs, desires, etc, and trying for authenticity in all communications with others.
4: Learning to give and receive. It is very important to not get stuck in the role of the giver or the role of the receiver. We should strive to be balanced in terms of the energy of giving and receiving within our relationships.
5: Allow for the possibility. This means keeping an open mind for possibilities in any relationships and trying to avoid getting stuck in old and familiar patterns. Continuously open yourself up for new possibilities in any one of your relationships.
6: Always complete your relationships. This means striving to always complete communications and come to a point of mutual understanding—not necessarily agreement, but acknowledgement—so that issues that come up can be put to rest and not drag on and on, blocking the relationship from the present. Completion means keeping the “house” of the relationship clear and free or blockages, and not harboring unresolved and un-communicated feelings, thoughts, and attitudes.
7: Remember that your Expanded Self is your highest point of view in life. Always be a standard for greatness and see greatness and possibilities in the other and obviously in yourself.

Part III: Participants are asked to sit again in their small groups and create a chart that includes the seven ground rules for successful partnerships as well as their own findings. Each person should come up with a way of verbalizing and personalizing those ground rules, and incorporate them into the seven ground rules and with the other group members' findings. They might find that their own explorations are covered by the seven ground rules; if not, they should weave their own findings into the others. The result should be that each person creates a very solid chart for themselves of ground rules for successful communication and partnerships—a clear, understandable chart that they can commit to in terms of going about creating successful partnerships in their life.

Part IV: Share and discuss.
Exercise 2: Group or private.
Goal: To understand the correlation between the emotional spiritual lessons within the seven energy centers and the ground rules for successful partnerships.

Part I: The coach engages the group in a discussion. Participants take each one of the seven energy centers from the bottom up, and, as a group, with the coach's guidance, they examine the spiritual and emotional content of each one of the energy centers. For example, the first chakra involves survival. When one is in a state of fear, one creates defensiveness, a sense of separation, aggression, distrust, etc. in their life. The lesson of the first chakra is to understand that all is one—nature is one, and we are one with nature. We touch everything, and are touched by everything, and by the fact that we are one energy and consciousness, we are not separate and we can relax into the sense of being secure and safe within life and nature. The highest lesson of the base chakra is the feeling of being one with everything. In the discussion, the coach leads the participants through the seven energy centers and revisits the lowest point of view to the highest point of view within each of the centers.

Part II: Participants are asked to meditate on and write correlations between the seven highest points of view that we can find possible in the energy centers and the ground rules for successful partnership. Another example: the second chakra, located where the sexual organs are, has to do with a sense of personal power. In the lowest point of view of that chakra, we lack that sense and feel physically, creatively, or sexually powerless. In the highest point of view, we realize ourselves as powerful physically, creatively, and sexually. Example of correlation: first chakra—survival, sense of security. When we have a sense of security and safety, it affects our way of creating partnerships. It correlates to the first ground rule, acceptance—we are much more able to accept ourselves and others. It also correlates to ground rule number three—we can be more authentic—and four, in that we are able to relax enough to give and receive. Each participant writes down the correlations they see between the lessons of the energy centers and the ground rules for successful partnership.

Part III: Share and discuss.
Exercise 3: Group or private.
Goal: To practice and master the ability to be a great partner and create successful, harmonious partnerships.

Part I: Participants are asked to choose 5 relationships in 5 different categories:
1: Extremely close relationships. These include mates, children, parents, siblings, et cetera.
2: Friendships. This includes close friends and longtime friends.
3: Work relationships. These include any kind of business-related partnerships that have to do with creating something together.
4: Casual acquaintances—neighbors, people from religious communities, people from classes, etc.
5: Total strangers.

Participants choose one specific relationship from each category and, one by one, go through and examine the relationship from the point of view of the seven ground rules. They write in detail which ones of the ground rules they're able to maintain within that relationship/partnership, and which ones they are unable to maintain. Which ones of the ground rules are they most capable of fulfilling and which ones are they having a harder time with? They should be very honest with themselves. After they examine each, they should write down a summary as to which ones of the ground rules they feel they have mastered, and which ones they still need to work on or with and practice. After the period of writing, participants share and discuss their insights about their abilities within their small groups.

Part II: Final presentation. Participants choose the most important relationship in their life. They examine their way of being in that relationship/partnership, and they very honestly evaluate the shifts they need to make within themselves in order to be the kind of partner that fulfills all seven ground rules. They write down a presentation under the title “I Am A Commitment to Great Partnerships”. In the presentation, they speak of the specific relationships they've chosen and they move from the first ground rule slowly into the seventh, presenting their lessons, the shifts they have to make out of their potential and commitment to being 100% responsible for creating fulfilling partnerships. In other words, the participants show through their presentation their knowledge of themselves, their weak points and their potential, and they present their promise to themselves to master the ability of being a great partner by speaking about each one of the ground rules and pointing out what they're willing to shift, how they're willing to expand their ability to fulfill that ground rule. They do the presentation in small groups and get feedback after the presentation.

Commitment for Level VII:
1. Participants should choose daily one of the ground rules and walk through their day with the commitment to fulfill as much as possible that specific ground rule. For instance, if they choose acceptance, they should walk through their day and see how they can be accepting of themselves and others throughout the day, and realizing when they're not. They should see if they can shift any uncompromising behaviors and fulfill the commitment to acceptance. This one commitment includes all seven ground rules. Participants choose one per day; if they have a hard time with one rule, they should stay with it for three days or even a week until they feel they've mastered it. The commitment in this level is to become a great partner.

### Gate of Creative Expression

### Detailed description of the Processes and Exercises

1. In each level, an exercise or a process can be repeated more than once if needed.
2. Any part of any process or exercise can be repeated more than once if needed.
3. An exercise or a process can be broken down to even smaller excerpts to make it clearer and easier.

### General Goals for the Gate of Creative Expression:

1. To cultivate the ability to create and express.
2. To learn to use creativity and expression to enhance playfulness, joy, and well-being.
3. To learn to use creative expression to enhance relationships and to contribute constructively to work and life projects.

There are commitments that participants take on connected to each level of the Gates. These commitments are like assignments to be done between weekly meetings at home. They are noted at the end of each level.

Gates of Power establishes seven different levels of inquiry to cultivate, expand, and liberate creative expression. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

### Level I:

Purpose: To cultivate the ability to use creative expression by way of movement, sound, writing, drawing, and art making.

Process: Participants are asked to meditate on and write down an honest observation evaluating their creative and expressive ability. They are asked to look specifically into the seven areas of life and to write separately within each one of them how they're being creative and expressive and where they need to expand their ability. The seven areas of life they're asked to examine are as follows:
1. Relationship with the self—the inner relationships between all three aspects, the Emotional, the Defensive, and the Expanded. This should also include anything that is connected to taking care of the self in all the facets of wellbeing, physical, mental, emotional, spiritual, etc.
2. Relationships with others. This includes close, intimate relationships, work relationships, community, etc.
3. Relationship to the Whole (Spirit, God, Oneness, Tao, etc—whatever the participant sees as the greater source of things).
4. Contribution, meaning career, work, service, art, “Life Path,” etc—the way the participant expresses themselves in the world through their talents and skills.
5. Physical, material structure of life—finances, home environment, transportation, property, etc; anything that has to do with the structures around us.
6. New learning and education.
7. Play, fun, and adventure.
Exercise 1: Group or private. Creative expression exercise.
Goal: To explore a specific theme through a creative project in order to achieve a greater understanding of the theme and a sense of transformation.

Part I: Homework. Participants are asked to look over their writing from the Process and choose three important themes in their lives within which they have trouble with their creative expression—ideally, three areas of life with one theme for each area. Out of the three that they have chosen, for Exercise 1, they pick one and explore it through written word, music, art, movement, drawing, or any combination of creative elements. Participants should bear in mind that they will be presenting these explorations within their small groups.

Part II: Each participant presents their themes through the media of their choice to the group. After each presentation, each person in the small group responds creatively. Group members are given 10-15 minutes to come up with a creative response to what they just saw and heard; after this, they present it one by one in response to the active participant.
Exercise 2: Group or private. Creative exercise.
Goal: To explore a specific theme through a creative project in order to achieve a greater understanding of the theme and a sense of transformation.

Part I: Homework. Participants are asked to look over their writing from the Process and the three important chosen themes. (one theme for each area of life). Out of the three that they have chosen, for Exercise 2, they pick the second one and explore it through written word, music, art, movement, drawing, or any combination of creative elements. Participants should not get in a “creative rut”—the mode or material of presentation should be different from the previous exercise to encourage a breadth of creative exploration.

Part II: Each participant presents their themes through the media of their choice to the group. After each presentation, each person in the small group responds creatively. Group members are given 10-15 minutes to come up with a creative response to what they just saw and heard; after this, they present it one by one in response to the active participant.
Exercise 3: Group or private. Creative exercise.
Goal: To explore a specific theme through a creative project in order to achieve a greater understanding of the theme and a sense of transformation.

Part I: Homework. Participants are asked to look over their writing from the Process and the three important chosen themes. (one theme for each area of life). Out of the three that they have chosen, for Exercise 3, they pick the third one and explore it through written word, music, art, movement, drawing, or any combination of creative elements. Again, participants should not get in a “creative rut”—the mode or material of presentation should be different from the previous exercise to encourage a breadth of creative exploration.

Part II: Each participant presents their themes through the media of their choice to the group. After each presentation, each person in the small group responds creatively. Group members are given 10-15 minutes to come up with a creative response to what they just saw and heard; after this, they present it one by one in response to the active participant.

Part III: To bring closure to this level, participants are to engage in a long sharing and discussion period following the three exercises. The point of the discussion should be to see how they are feeling now about those three themes—is there a sense of transformation or discovery? Did a shifting of perspective take place? Do the participants find it easier to express themselves in an area of life in which they had trouble previously?

### Commitments for Level I:

1. Participants should thoroughly complete each one of the homework assignments.

### Level II:

Purpose: To explore the three important steps of transformation, Clearing, Being, and Creating, through creative expression. The three steps are identified in the Method as the “CBC Package”:
1. Clearing and completing. This means releasing and completing the past, specifically and especially negative, difficult, traumatic, unpleasant memories, feelings, beliefs, concepts, etc.
2. Being. This means cultivating the ability to be present in the here and now and to enjoy it.
3. Creating. This means taking the initiative to make creative choices, commitments, and actions in order to create the vision of your life.

Process: Participants are asked to examine their life and do the following: 1. Write down what they need to complete and clear; 2. Assess honestly their ability to be in the present moment, receptive, responsive, and appreciative; and 3. Evaluate honestly their willingness and resistance to be a creator of their lives.

Exercise 1: Group or private. Meditative exercise followed by writing.

Goal: To further the completion process.

Part I: For this exercise, participants can choose to sit or lay down. As in all meditative exercises, the coach leads participants in 10-15 minutes of quieting the mind and relaxing the body. After the relaxation period, participants are asked to choose 3-4 “incompletes”. The coach gives participants a little time for each “incomplete” and leads them through a number of steps, each of them followed by a quiet pause for internal response. The steps are as follows:
1. The coach asks the participants this question: what is the difficult feeling that you're holding onto in regard to this specific “incomplete”?
2. The coach asks participants this question: what do you need in order to be able to release the difficult feeling? For example, do you need to express your feelings? Do you feel that you need an apology, or do you feel that you need to apologize? Do you feel you need support in order to be able to release terror? Etc.
3. The coach asks participants this question: how can you help yourself or what would help you to express, forgive, ask forgiveness, or create support?
4. The coach encourages participants to internally and emotionally take a minute to give themselves whatever they need to be able to complete the “incomplete”. If they need to scream or cry, they should go ahead and do that—participants should do whatever it takes.

5. Finally, the coach asks participants to look for the gift and the empowerment in the completion of the “incomplete”.

There are three rounds of the whole process, one for each “incomplete”—these rounds can be done in different sessions.

Part II: Participants are asked to write down anything meaningful or important that happened to them in the previous part of the exercise.

Part III: Participants are asked to share with the group the most important completion that happened for them in Part I, but to share it through creative expression—write a poem, etc.

Exercise 2: “Being Present”—an experiential expressive exercise in couples.

Goal: To practice the ability to “just be”.

Part I: Two partners sit together facing each other. The coach gives everybody ten minutes of relaxation—they can do it with their eyes closed. Then, they are asked to open their eyes and look at each other, and the coach guides them in the five different steps of this process.
1. Using the senses. The coach asks the participants to look at each other and be present to all the details that they can sense, looking, hearing, smelling, etc, and to take in their partner, the room around them, etc.
2. Feelings and sensations. The partners are still looking at each other but they are asked to note what feelings and sensations they're having, and to try to acknowledge and accept them and possibly let them go.
3. Noting what is present for them as the exercise gets a little more difficult. For example, any discomfort with the intimacy of the moment or any resistance to being in the moment that could express itself as the mind moving away from the present or diverting or avoiding the moment.
4. Focusing on the breath and attempting to relax into the moment, possibly by synchronizing both participants' breaths.
5. Two partners, closing their eyes, attempt to feel the moment and find the impact of the exercise.

This five-step process should be followed by a sharing and discussion between the two partners.

Exercise 3: Group or private. Writing exercise followed by material collecting.

Goal: To cultivate the ability to create the future.

Part I: Participants are asked to meditate and write about the life that they are committed to creating for themselves. They should follow the list of the seven areas of life, and write separate entries for each of the seven areas of life. The writing should include goals, any emotional or spiritual development that they're looking to create, and very specific details of the most important elements they want to manifest in their lives. Participants should also begin to cut and collect pictures from magazines and other sources and file them for later; these pictures should symbolize their vision for themselves in the different life areas.

### Commitments for Level II:

1. Participants are asked to be aware of and diligent with the process of completing old business. They should be helping themselves with all the tools that they have to continue to clear and get out of the way anything that interferes with their ability to be present.
2. Participants should practice being in the present moment by centering on the breath, paying attention to sensory details, relaxing the body and the mind, and to allow giving and receiving.
3. Participants are asked to become aware of what they are passionate about, and what they are willing to create in their life.

### Level III:

Purpose: To explore the three aspects of the self through creative expression.

Process: Homework. Participants are asked to write the “story of their lives” three times, from three different perspectives—those of the three aspects of the self: the Emotional Self, the Defensive Self, and the Expanded Self. The story needs to be comprised of the same factual structure—new facts cannot be introduced in the other versions, and the “skeleton” of the story should remain the same.
Exercise 1: Group exercise. Improv game.
Goal: To cultivate a playful, humorous perspective of the three aspects of the self A creative, expressive exaggeration and a sense of humor are a must!

Part I: “The Party of the Selves.” Round 1. The coach puts on party music and, first, all the Defensive Selves go into the party. For ten to fifteen minutes all the participants socialize and interact as their Defensive Selves with the other Defensive Selves in the room. Round 2. Same party music, but with all the Emotional Selves interacting for ten to fifteen minutes as before, with the other Emotional Selves at the party. Round 3. Same party music, but with all the Expanded Selves interacting for ten to fifteen minutes as before, with the other Expanded Selves at the party.

Part II: The group is divided in half, into audience and participants. The participants each decide on whichever self they want to use, and then they go into a black tie party and proceed to socialize. After about fifteen minutes of this humorous improvisation, the groups switch, and the audience group becomes the participant group.
Exercise 2: Group exercise. Improv game in couples and small groups. A creative, expressive exaggeration and a sense of humor are a must!
Goal: Cultivating a playful, humorous perspective of the three aspects of the self.

Part I: Two couples are working, two couples are watching. Of the active participants, each couple is divided to A and B; A is the Defensive Self and B is the Emotional Self. There is a brief discussion before the exercise where the active participants make a few decisions. The one guideline is that they are meeting on a first romantic date; they discuss the time, place, and other details. Once they decide this, they go ahead and do the improv exercise. After they finish, they take a minute and then switch the roles—A becomes the Emotional Self and B becomes the Defensive Self. All other details stay the same, and they proceed to enact the date again. Following this, the groups switch—the audience members become the active participants and vice versa.

Part II: The group divides into two couples that are watching and two that are participating. Each couple is divided to A and B. On the first round, A is the Expanded and B is the Defensive Self The one guideline they get is that they're both planning a trip to an exotic, possibly dangerous destination. The active participants take a minute to decide the details: where they're going, what they're doing, etc. Once decided, they get about fifteen minutes to do the improv exercise before switching roles—A becomes the Defensive and B becomes the Expanded Self. All other details stay the same, and they proceed to enact the scene again. Following this, the groups switch—the audience members become the active participants and vice versa.

Part III: The group again divides into the audience and the active participants. The participating couples choose A and B; A is the Expanded Self and B is the Emotional Self. The one guideline is that they're both watching a very scary action movie. They get a minute to decide the details—home or theatre, friends or lovers, etc. Once decided, as before, they get about fifteen minutes to do the improv exercise before switching roles—A becomes the Defensive and B becomes the Expanded Self. All other details stay the same, and they proceed to enact the scene again. Following this, the groups switch—the audience members become the active participants and vice versa.

Part IV: Share and discuss in small groups.
Exercise 3: Expressive exercise.
Goal: Cultivating a playful, humorous perspective of the three aspects of the self A creative, expressive exaggeration and a sense of humor are a must!

Part I: Participants are asked to tell the story of their life, 1. as a tragedy, 2. As a comedy, and 3. As a drama. They are also asked to shift between the three selves. Each person stands in front of their small group and chooses a helper. The helper feeds them with the requests—for example, the helper says “we would like to hear you story from the point of view of your Defensive Self It is a comedy.” The active participant then begins to tell the story bearing these two components in mind. They get two minutes, and then the helper switches and gives them the next assignment. The helper should do three combinations, as they choose, but all three aspects have to be covered and all three genres have to be covered. The active participant gets a round of applause, and then another person comes up.

Part II: Share and discuss.

### Commitments for Level III:

1. Participants are asked to focus on the humorous perspective of the three aspects of themselves and write down as many funny, quirky details as they discover about themselves.

### Level IV:

Purpose: Creative exploration of the “Essence” and the “Mask.”

Process: Homework. Participants should meditate on and write down their observations of the “masks” that they wear. To help themselves with this assignment, they are asked to examine the seven areas of their lives and think of frozen attitudes that are habitual, mechanical, and defensive and are present in any one of the areas. For example, some people have a mask that says “everything is great”—whenever you ask them how they're doing, they put on the mask. It is called a mask since it is habitual, mechanical presentation that does not reflect an authentic feeling. Other examples include the mask of a jokester, the mask of the glamour girl/boy, or the mask of “poor little me”. After some exploratory writing, participants are asked to choose three prominent masks that they are clearly using, and write down when, where, and how these masks are operating in their life.
Exercise 1: Group or private.
Goal: Creative exploration of two prominent masks.

Part I: Participants are asked to choose two out of the three masks they defined. Then they are asked to create the two masks on two different sides of a cardboard with a handle, using colors and crayons.

Part II: Participants are asked to create the words that go with each mask and the body language that goes with the words (distil the words to 2-3 sentences and the body language to 3-4 prominent gestures).

Part III: Each participant shares within their small groups the full expression of the masks. They go for two rounds, one for each side of the mask. They do it by wearing the mask, speaking and moving from it, and going around and addressing each person in the group from the mask.

Part IV: “Meeting of the masks.” This improve game involves the whole group; they decide on who is meeting and why they're meeting—is it a business meeting of CEOs, pregnant ladies meeting for support, a book club, etc? Then they socialize holding one of their masks.

Part V: Share and discuss.
Exercise 2: Writing exercise followed by discussion. Group.
Goal: To explore the true feelings behind the mask.

Part I: Participants are asked to write down the feelings that they identify behind the masks.

Part II: Within the small groups, each participant addresses the group members one by one, once from behind the mask and then immediately after, removing the mask and doing the same from the feelings behind the mask. Each participant goes around twice—once for each mask.

Part III: Share and discuss.
Exercise 3: Writing exercise followed by group.
Goal: To explore all three levels—mask (a part of the Defensive Self), the feelings behind the mask (the Emotional Self), and the point of view of the Expanded Self.

Part I: Participants are asked to write down the voice of their Expanded Self that they hear behind the mask and behind the feelings that are behind the mask. Participants need to write down two separate entries—one for each mask.

Part II: Within the small groups, each participant addresses the group members one by one, once from behind the mask, then immediately after, removing the mask and doing the same from the feelings behind the mask, and then expressing the voice of the Expanded Self. Each level, the feelings and self of the mask are expressed fully—I words, attitudes, gestures, etc. Each participant goes around twice—once for each side of the mask.

### Commitments for Level IV:

1. Participants are asked to note down on a daily basis the times/incidents/relationships/events where they found themselves operating from their masks, and times/incidents/relationships/events when they were being open and authentic, operating either from their Emotional Self or the Expanded Self.

### Level V:

Purpose: To cultivate a commitment to happiness as a state of mind. The Gates of Power Method defines happiness as a state of being in which one is present, open, available to giving and receiving, able to feel appreciation and gratitude towards life, and continuously and naturally connected to the feelings of joy, play, and wholesome pleasure. Most people are blocked and contracted to various degrees. They live burdened by unresolved, uncompleted psychological issues, and crippling energetic patterns where all these are prominent. The state of mind of “happiness” is not available. People try to derive excitement from outside stimulation and might a feel temporary feeling of fun or pleasure, but the true sense of inner peace and happiness can only be accomplished by “cleaning house” and freeing the energetic field and resolving psychological knots. Then and only then can they become available to the state of happiness.

Process: Participants are asked to meditate on and examine their availability to the state of mind of happiness. Following these guiding questions, they are asked to write down an overview of their “happiness chart” in the seven areas of life. They are asked to be as honest and specific as possible. The seven areas of life, which were covered in Level I, are: relationship with the self; relationships with others; relationship to the whole; contribution; physical, material structure of life; new learning and education; and play, fun, and adventure. The questions they should ask themselves are as follows:
1. How committed am Ito feel happy and positive in this area?
2. What is my main focus and commitment in this area (check for neurotic or negative commitments like looking good, making the right impression, pleasing, feeling safe at all costs, etc)?
3. How much of my actions, efforts, investments, and planning in this area are contributing to my happiness, and how much of them are not?
4. What are the changes, shifts, and improvements that I am willing and able to make, coming from a greater commitment to my happiness?
Exercise 1: Couples. Group or private.
Goal: To cultivate a commitment to happiness within the first three areas of life—1. relationship to self, 2. relationship to others, and 3. relationship to “the whole”.

Part I: In groups of two, participants are asked to use the homework process and share with their partner the observations and realizations they gathered about each one of the three areas of life, being specific and honest as to in what ways they are committed to their happiness and in what ways they find that they are not. The two partners take turns.

Part II: In groups of two, participants are asked to write down specific commitments, choices, and actions within each one of the three areas of life mentioned above that would begin a process of transformation towards greater happiness.

Part III: Participants are asked to share with their partner the specific commitments, choices, and actions that they are willing to take on to support their happiness and the couple sets up meeting in person or talking on the phone twice a week to support each other with the process. The calls or meetings are not social in nature. They are mutually challenging and supportive and aim to strengthen the partners' responsibility to their happiness.
Exercise 2: Couples followed by writing. Group.
Goal: To cultivate a commitment to happiness within the next two areas of life—4. Contribution, and 5. physical and material structure of life.

Part I: In groups of two (different from the groups in the previous exercise), participants are asked to use the homework process and share with their partner the observations and realizations they gathered about each one of the next two areas of life, being specific and honest as to in what ways they are committed to their happiness and in what ways they are not. The two partners take turns.

Part II: In groups of two, participants are asked to write down specific commitments, choices, and actions within each one of the two areas of life mentioned above that would begin a process of transformation towards greater happiness.

Part III: Participants are asked to share with their partner the specific commitments, choices, and actions that they are willing to take on to support their happiness and the couple sets up meeting in person or talking on the phone twice a week to support each other with the process. The calls or meetings are not social in nature. They are mutually challenging and supportive and aim to strengthen the partners' ability to take responsibility for their happiness.
Exercise 3: Couples followed by writing. Group.
Goal: To cultivate a commitment to happiness within the next two areas of life—6. learning and education, and 7. play, fun, and adventure.

Part I: In groups of two (different from the groups in the previous exercise), participants are asked to use the homework process and share with their partner the observations and realizations they gathered about each one of the next two areas of life, being specific and honest as to in what ways they are committed to their happiness and in what ways they are not. The two partners take turns.

Part II: In groups of two, participants are asked to write down specific commitments, choices, and actions within each one of the two areas of life mentioned above that would begin a process of transformation towards greater happiness.

Part III: Participants are asked to share with their partner the specific commitments, choices, and actions that they are willing to take on to support their happiness and the couple sets up meeting in person or talking on the phone twice a week to support each other with the process. The calls or meetings are not social in nature. They are mutually challenging and supportive and aim to strengthen the partners' ability to take responsibility for their happiness.

Commitments for Level V:
1. Participants should be conscientious and follow through with the commitments they have given themselves, and the discussions with their partners. If they have any difficulty they should get the support they need, from their partner and from other members of their small group, to move on.

### Level VI:

Purpose: To learn to perceive life as a goldmine of happiness.

Process: Part I: participants are asked to look at the seven areas of life and see how they connect potentially to the state of mind of happiness. They should write down their observations.

Part II: They are asked to prepare visual material for the Happiness Vision Board. This material can include clippings, images, objects, music, words, poetry, cloth, etc—material that represents the connection to your happiness derived from the seven areas of life.
Exercise 1: Vision Board making. Group or private.
Goal: To create the Happiness Vision Board, working on the first three areas of life—1. relationship to self, 2. relationship to others, and 3. relationship to “the whole”.

Part I: In small groups, participants work on the Vision Board. Each person is working on their own Board individually, but they will be communicating and sharing ideas, and there will be a communal craft box with additional materials to share. Participants can choose the medium and mode of the piece, but it should incorporate each of the first three areas of life. It is recommended that the art piece be three-dimensional. This creating can take several sessions.

Part II: At the end of the creation for these three areas of life, there will be a sharing and discussion among the small groups.
Exercise 2: Vision Board making. Group or private.
Goal: To create the Happiness Vision Board, working on the next two areas of life—Contribution, and 5. physical and material structure of life.

Part I: In small groups, participants work on the Happiness Vision Board. Each person is working on their own board individually, but they will be communicating and sharing ideas, and there will be a communal craft box with additional materials to share. Participants can choose the medium and mode of the piece, but it should incorporate each of the next two areas of life. It is recommended that the art piece be three-dimensional. This creating can take several sessions.

Part II: At the end of the creation for these two areas of life, there will be a sharing and discussion among the members of the small groups.
Exercise 3: Vision Board making. Group or private.
Goal: To create the Happiness Vision Board, working on the next two areas of life—6. learning and education, and 7. play, fun, and adventure.

Part I: In small groups, participants work on the Happiness Vision Board. Each person is working on their own board individually, but they will be communicating and sharing ideas, and there will be a communal craft box with additional materials to share. Participants can choose the medium and mode of the piece, but it should incorporate each of the last two areas of life. It is recommended that the art piece be three-dimensional. This creating can take several sessions.

At the end of the creation for these two areas of life, there will be a sharing and discussion among the members of their small groups.

### Commitments for Level VI:

1. Participants should actively seek the “gold nuggets”, the “magic moments” of happiness that they encounter in everyday life, and write down each time they observe these moments.

### Level VII:

Purpose: To enjoy creativity as a source of happiness and contribution.

Process: Participants are asked to meditate on and decide on a creative project which will involve a direct contribution to others. For example, organizing a full day of creative entertainment for project kids, or organizing a show—performance or visual art or music etc—as a fundraiser for a cause of their choice.
Exercise 1: Group. (Can be done individually with coach.)
Goal: To crystallize the idea for the creative project within the small group.

Each participant presents their ideas for a project. The group discusses the ideas and decides by voting on the two best ideas. The project chosen would involve all members of the group, each member contributing to the project with their specific talents and skills. The group decides on the leader for each project and the different assignments for each participant.
Exercise 2: Group. (Can be done individually with coach.)
Goal: To create a detailed plan for each project with specific timeline, place, choices, commitments, and actions.

The group discusses the specific plan for each one of their two projects. They should have one member for each project that records all plans in detail—deadlines, how, when, where, and who is doing what, etc.
Exercise 3: Group.
Goal: Bringing the projects to completion.

The groups meet as many times as possible outside of class time to prepare, rehearse, and coordinate for their projects. They will be given three in-class sessions to iron out any challenges, difficulties, and disagreements. By the end of the third session, they should be ready to go ahead with their project.

Level VII ends with a party; the leaders of each team share their victories, successes, and fun stories with the other teams.

### Commitments for Level VII:

1. Participants make a commitment to stay focused, pull their weight, and work toward the success of the projects of their team.

### Gate of Life Path

### Detailed description of the Processes and Exercises

1. In each level, an exercise or a process can be repeated more than once if needed.
2. Any part of any process or exercise can be repeated more than once if needed.
3. An exercise or a process can be, broken down to even smaller excerpts to make it clearer and easier.

### General Goals for the Gate of Life Path:

1. To understand the concept of a “Life Path”.
2. To achieve clarity about the connection between personal talents, gifts, lessons, and contributions, and how all these weave into our life path.
3. To create the focus and ability to follow our life path.
4. To understand the roles of intuition, creativity, choice, and consistent action in our Life Path.
5. To cultivate the ability to become a creator of our Life Path.

There are commitments that participants take on connected to each level of the Gates. These commitments are like assignments to be done between weekly meetings at home. They are noted at the end of each level.

Gates of Power establishes seven different levels of inquiry to cultivate, expand, and liberate our ability to follow our life path. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

### Level I:

Purpose: Understanding the concept of a Life Path.

Process: Participants are asked to write down their ideas and understanding of the concept of a Life Path. They are asked to follow these specific questions as they are writing:
1. What is a Life Path?
2. How does one choose a Life Path? Is it a choice, a destiny, or a coincidence? A combination?

3. How is a Life Path created? What are the important elements that comprise a Life Path?

4. What informs us about our Life Path?

5. How can we be sure we are following the right path for us?

6. When we are sure, how do we stay firmly and effectively on the path?
Exercise 1: Discussion. Group or private.
Goal: To understand the concept of a Life Path.

Part I: The coach leads the discussion based on the questions that were given, plus any additional questions that came up for participants as they were writing the assignment. Important ideas for the coach to insert into the discussion: the role of intuition/inner voice/heart desire (as opposed to defensive desires for status, image, etc); the importance of personal lessons, talents, gifts, tendencies, natural abilities in shaping one's Life Path; the importance of what moves us, gives us joy, and creates a sense of fulfillment.

Part II: Participants are asked to rewrite their understanding of a Life Path after the discussion, with the hope that the concept has become clearer to them.

Part III: Participants create a personal definition for a Life Path and share it within their small groups.
Exercise 2: Meditation followed by writing and discussion. Group or private.
Goal: To learn to identify and work with the inner guidance system.

Part I: Meditative exercise in silence. Participants are asked to choose to sit down or lay down. The coach leads the group in 15 minutes of relaxation of the body and quieting of the mind. Once the beginning is accomplished, the coach asks participants to observe their life. The coach assists them by giving them a period of time for each section. S/he asks them to take a block of their life from 1-7 years, then after 10 minutes a period from 7-14, from 14-21, etc; within each one of the periods of time, participants are asked to remember important experiences, moments, decisions, impressions, and to choose the ones that were connected to following an intuitive inner guidance. The coach guides them to see as they remember the moments and how they felt about the specific choice, decision, experience, etc. At the end of the exercise, they are asked to reflect on the connection between all the experiences and a possible through-line.

Part II: Participants are asked to write down a little bit about each of the moments they chose, how they felt within that moment, and the possible connection between all of them.

Part III: Share and discuss within small groups.
Exercise 3: Meditation followed by writing.
Goal: To understand the resistance and avoidance we experience to our inner guidance system.

Part I: Meditative exercise. Participants are asked to choose to sit down or lay down. The coach leads the group in 15 minutes of relaxation of the body and quieting of the mind. Once the beginning is accomplished, the coach asks participants to observe their life. The coach assists them by giving them a period of time for each section. S/he asks them to take a block of their life from 1-7 years, then after 10 minutes a period from 7-14, from 14-21, etc; within each one of the periods of time, participants are asked to remember important experiences, moments, decisions, impressions, and to choose the ones that were connected to not following an intuitive inner guidance. The coach guides them to see as they remember the moments and how they felt about the specific choice, decision, experience, etc. At the end of the exercise, they are asked to reflect on the connection between all the experiences and a possible through-line.

Part II: Participants are asked to write down a little bit about each of the moments they chose, how they felt within that moment, and the possible connection between all of them.

Part III: Share and discuss within small groups.

### Commitments for Level I:

1. Participants are asked to notice when in their daily life they are following their internal guidance system and when they are not, and to write down what influences their decision to follow the internal guidance system or not.
2. Participants are asked to make two lists. The first one is a list of all their talents, gifts, natural tendencies, things that move them, give them joy, and create a sense of fulfillment and mission for them. The second list includes important lessons that they feel they have learned, are learning, and still need to learn.

### Level II:

Purpose: To cultivate the ability to identify one's Life Path.

Process: Participants are asked to meditate on and write down their sense of understanding of a Life Path and their own Life Path, and while writing, they should consider these elements:
1. Their talents, skills, and natural abilities;
2. Things that make them feel inspired, touch them, give them a sense of joy and fulfillment;
3. Needs, healthy cravings;
4. Lessons they feel they have learned, are learning, and need to learn;
5. How they feel they contribute the most;
6. Who is the person they want to become or who the highest version of themselves is.

After writing, participants are asked to meditate on their loyalty to the above. How much, where, and when are they resisting their talents, skills, the things that inspire them, their needs, lessons, etc? How much/where/when/how do they follow the above?
Exercise 1: Discussion and sharing followed by visualization. Group.
Goal: To learn to distinguish when on the path and when not.

Part I: Participants are asked to discuss and share in small groups their thoughts and discoveries from the process. There will be two questions that will guide the discussion; 1.) what did you discover about yourself and your life path in your writing, and 2.) how much do you live your life path within awareness and inner guidance and how and where do you not? Participants will discuss first and then share parts of their writing with the group.

Part II: Laying-down meditation/visualization. As with all meditations, this one starts with 10 minutes of relaxation, quieting the mind, and centering on the breath. After the relaxation time, the coach explains about the visualization. Like any other visualization, it's important to allow images to come forth without manipulation and intellectualization; the coach should encourage participants to let images come to them intuitively. The coach explains that in this visualization, which is an inner journey (much like an awake dream), the subconscious provides us information through images. In this visualization, participants will be met by a “helper” and taken to a place where they will get guidance about their life path.

Then, the coach starts the visualization by suggesting to the participants that they are sitting on a rock in a clearing in a forest. As they take the steps of visualization, they are given time for each step in the journey. They wait there for a helper that will take them to a place where they'll meet their inner guide, who will help them with important information about their life path. The coach proceeds by saying that they're hearing footsteps and their helper appears. They're given a minute to visualize who their helper is; participants are reminded not to intellectualize the process. The helper can be someone they know, or someone they don't know. They could be a human or a nonhuman. The main thing is that that helper will take them through the woods and onto a path that's winding to a top of a mountain, where they see a building. Again, they should allow the vision of that building to come to them spontaneously, and feel the elements that are interacting with them on the path—nature, animals—and any feelings that they have as they're walking towards the building on the mountain. When they come close to the building, they realize that it is gated and they have to pass through a gate; there is a guard who discusses their entry with their helper, and they're allowed to go in. They go through a door and into a room in which they see their inner guide. Here participants should be open to allowing their subconscious to give them the image of their inner guide. As they come close to their inner guide, there is a short exchange of feelings and words, and they are given a box that contains four things. One is an object, two is a letter, three is a map, and four is a secret gift. They're asked to only open the box later, when they return to their original starting point in the clearing. They should see themselves thanking their inner guide and walking out of the room, into the yard, and through the gate, then down the path accompanied by their helper. They go back through the woods to the place where they started. When they get to the very rock that they were sitting on, the helper bids them goodbye, and there is an exchange and the helper disappears. This is the time when they can open the box and experience the four elements within it, knowing that these elements will give them important information about their life path. They're asked to open the box and examine each element; the coach gives them a few minutes to discover each element and puzzle over the message within it. The visualization ends with them closing the box and imagining that they're taking it with them back to their actual room. The coach gives participants a few minutes to return to the normal state.

Note to coach: There should be constant encouragement of the imagination from the coach as the visualization process happens. For instance, when the helper appears, the coach should help participants by asking them about what the helper is wearing and doing, how they're walking, etc. to assist the participants in visualizing each detail.

Part III: Participants write about their experiences in the visualization, and to try to understand the information that has come to them through the visualization.
Exercise 2: Couples. Group.
Goal: To address the resistance and avoidance to our life path. Note: the refusal to grow, move on, let go, take responsibility, a need for safety, comfort, or control etc are some of the elements that create our resistance to following our inner guidance.

The active participant is asked by the helper the following questions. After each question the active participant gets a time to respond.
1. Tell me about your talents, skills, natural abilities, strong points, and passions. How are you using and enjoying them?
2. Where, when and how are you resisting your talents, gifts, etc?
3. Why are you resisting them?
4. What do you need to feel/do/be in order to let go of your resistance?
5. Are you ready and willing to let go of your resistance?
6. If not, why?

After all the questions, the partners switch. After both have had their turns, the partners have a sharing and discussion about the exercise between the two of them.
Exercise 3: Writing followed by meditation. Group or private.
Goal: To understand the concept of healthy surrender as opposed to unhealthy “giving up”

Part I: Participants are asked to choose the three most prominent “resistance themes” in their life and to bring them to mind one by one. In writing, they should acknowledge the negative charge that lives behind these resistance elements, be specific about it, and feel it as they are writing—spell it out, admit it; accept it, and have an inner dialogue about it.

Part II: Meditative exercise. Participants are asked to choose laying down or sitting. As with all meditative processes, the coach leads them in about 15 minutes of relaxations in order to relax the body and quiet the mind. This meditative exercise is geared toward helping participants to begin the process of releasing their resistance. They are asked, after the first part of the relaxation, to choose the main element of resistance that they uncovered in the previous part of the exercise, and to meditate on their need to resist. What is the feeling, why is the resistance there? The previous exercises should guide them, prepare them, and help them come to the bottom of the cause of their resistance. The coach gives them time to be with that, and after, the coach checks if it's okay to continue with the process, and if so, the coach moves on to the second part. The second part is that the participants meditate on the possibilities that would open up and present themselves to them if and when they release their resistance. The coach gives them ten minutes to enjoy the feeling of possibilities, and then asks them to check whether there is any kind of fear or doubt involved with the sense of possibility and freedom, expansion, and better mobility. Every meditative exercise ends with a little closing relaxation and preparing to coming back to the usual state.

### Commitments for Level II:

1. Participants should write down and pay attention daily to fears and resistance to impulses and inner guidance.
2. Participants should experiment with trusting their intuition daily, and write down their experiences and observations.

### Level III:

Purpose: To gain clarity about one's Life Path—the past.

Process: Participants are asked to create a chart of their Life Path. They should use their creative ability in making this chart. They get a very long (at least 6 ft by 2 ft) cardboard, and, starting on the left side, they are to create the first “station” of their Life Path—their pre-station. In that station, they are to name all their talents, skills, natural abilities, strong points, interests, passions, attributes, etc, that they were given before the starting point (their birth). They call this “my potential gift bag”. After the pre-station, they create the first station of their life, which is their birth. In this process, they are asked to create their birth station plus five other important life path stations, from their birth on to the age of seven. The stations are points of life with defining events and experiences that shaped them and their life—for example, a strained relationship with a parent, the birth of a sibling, moving from one place to another, divorce of parents, starting school, sickness or death in the family, etc. They are asked to find a creative way to describe the stations and the timeline from one station to another. They should include feelings, impressions, memories, and interpretations that they formed as a result of the events and experiences—the lessons they learned, important choices and decisions, etc. They should be working on their Life path chart throughout the Gate of Life Path, so it's also important to create a mini model of it to bring to class; the mini model should include simple writing about the stations and the important points.

Exercise 1: Discussion. Group or private.

Goal: To learn to identify and understand one's Life Path.

Participants are asked to bring to the group session the mini version of their Life Path creation. They share their creation and insights with the members of their small groups and engage in a discussion about any questions or doubts that came up for them while creating the chart.

Exercise 2: Discussion. Group or private.

Goal: To learn to identify and understand one's Life Path.

Open discussion. The whole group, with the coach, discuss questions and answers about the Life Path chart that came up for people throughout the making of the chart. The coach guides participants to understand how the chart can help them realize when and how they are or aren't following the actualization of their potential gift bag, and the influence of events and decisions on their life and on themselves (1-7)

Part II: Each participant continues to work on the small version of their chart in class, creating the next few stations from ages 7-14.

Part III: Sharing in small groups.

Homework: At home, the participants are to put on their actual chart the additional part that they worked on, and to create the next part of the chart, which is ages 14-21.

Exercise 3: Discussion followed by chart making. Group.

Goal: To learn to identify and understand one's life path.

Part I: Open discussion. The coach and group discusses concerns, questions, doubts, or important insights that came up about the work about the chart or as a result of the work about the chart.

Part II: Each participant continues to work on the chart, creating the next few stations from age 21 to age 28.

Part III: Sharing in small groups. Part IV: Creating the next stations, from age 28 to age 35. Sharing in couples.

Homework: Putting the new stations onto the real chart.

### Commitments for Level III:

1. Participants must be committed to creating their charts in the most honest, insightful, accurate way possible, and to making sure that all doubts and questions are cleared and answered for them so that they have a deep sense of their Life Path Chart up to date. Obviously, people who are older than 35 will have to continue working and bringing their chart up to date.

### Level IV:

Purpose: To gain clarity about one's life path—the future.

Process: Participants are asked to finish the past stations on their Life Path Chart. The older participants have more to work on. They should also write some notes about future life path stations—not on the chart yet, but in their notebooks/journals. They are asked to project into the next seven years of their life.

Exercise 1: Discussion followed by writing. Group or private.

Goal: Guidelines to charting the future.

Part I: Guided discussion. The group discusses the important elements to consider when charting the future. These important points should be covered (a note for the coach in terms of the discussion) as guidelines to charting the future:
1. The actualization of the authentic self, which includes freeing the expression of one's essence. Actualizing talents, skills, interests, passions, abilities, etc. Facing and utilizing challenges and lessons.
2. The unification of the three aspects of the self under the leadership of the Expanded Self.
3. The realization and ownership of one's inner power through learning one's specific lessons and owning the responsibility and ability to respond to life from creativity choice and commitment.
4. Creating a life of contribution according to one's talents, skills, abilities, interests, passions, and authentic expression.
5. Learning to empower oneself and others through all relationships, experiences, and events of one's life.

Part II: Participants are asked to write about the important points that were covered in the discussion. How do they relate to each one of the points covered? How do they see themselves working toward achieving them? Participants should be specific.

Exercise 2: Chart making. Group or private.

Goal: Guidelines to charting the future.

Part I: Participants are asked to create on the chart the stations they envision for the next seven years. They should consult the five guidelines provided in the discussion. All five important points—guidelines to charting the future—will be provided, typed, to all participants.

Part II: Sharing in small groups.

Exercise 3: Writing. Group or private.

Goal: Guidelines to charting the future.

They are to try to consult with those guidelines as soon as possible. In exercise 3, participants are asked to look into their envisioned future stations or important points of progress that they have created on their Life Path Chart. They are asked to create a specific list of choices, commitments, and actions that would lead to the progress they envision in each one of the stations. They are to follow the structure of the five specific questions:
1. What are the goals in each one of the areas of life (don't be “safe”—play big)?
2. What are the important commitments?
3. What are the important steps in order to accomplish?
4. What are the important choices to make?
5. What are the actions that need to be taken (be specific)? How many, and by when?

### Commitments for Level IV:

1. Participants are asked to be very thorough in their work when charting their future points of progress. They are asked to make sure that everything is understood and that if they need any kind of support, they are to approach the coach or their group members.
2. Participants are asked to meditate deeply on the meaning of their life—the important, essential, passionate desires and needs that they have, so that their future planning springs from the center of their being rather than from ideas that are intellectual.

### Level V:

Purpose: To master the ability to manifest one's vision.

Process: Participants are asked to meditate on and write down the answers to these questions:
1. What are your governing principles? Governing principles refer to principles that are guidelines to creation a vision; they are essential and govern life. They can be called the “honor code” or the “personal 10 commandments”. These principles are sacred and personally important in terms of how each one of us wants to live our lives. They are the laws by which we are committed to our lives. For instance, a governing principle can be integrity in doing everything thoroughly and in the most complete or excellent way, or, honesty in all aspects and dealings of life.
2. What are the most important elements you feel you must have, achieve, develop, become, explore—your Must-Have-Do-Be List (don't play small! Go for the highest vision).
3. What are your most passionate, wildest visions of yourself as a human being?
4. What is your highest level of contribution?
5. What is your highest vision for your relationships?

As a second part of the process, participants are asked also to gather as many images, writings, small symbolic objects, and any other kind of visual material to represent their vision.

Exercise 1: Sharing and writing. Group or private.

Goal: To create the vision of the future.

Part I: Participants are asked to share their writing within their small groups. They should cover all five points that are covered in the process.

Part II: Participants are asked based on their homework process and on previous work with the Gate of Life Path to write down their highest visions for each area of life.

Part III: Participants share their writing in couples.

Exercise 2: Writing followed by sharing. Group or private.

Goal: To prepare for the creation of the Life Path Vision Board.

Participants can use their Life Path Chart to draw or write their future vision for the next seven years, covering all seven areas of life with all the choices, commitments, and actions necessary.

Share and discuss in small groups.

Exercise 3: Creative exercise followed by sharing. Group.

Goal: To create the Life Path Vision Board.

Participants are asked to bring to class all that they have gathered in terms of images, objects, words, or other things to represent their future vision. Each one of them is given a large, square cardboard and some craft materials are provided to create the Vision Board. All areas of life need to be present; the board is a visual representation of their highest vision for their life, made specific with details of each area of life and its own highest vision. This work can take two to three sessions.

Part II: Each participant takes the time to explain their vision board to their small group members, and a show of all of the vision boards is mounted on the class wall for the rest of the Life Path Gate.

### Commitments for Level V:

1. Participants should be committed to finish their Vision Boards.
2. Participants should share their Vision Board, or parts of it, with friends and family as a way of owning it and beginning to take responsibility for it.
3. Participants should write down any fears, doubts, or resistance that goes along with the process.

### Level VI:

Purpose: To actualize one's vision and “Potential Gift Bag”.

Process: Participants are asked to look at each area of life and choose the next few immediate steps that they need to take in order to begin to actualize their highest vision for each one of the areas. They should create a precise list of steps, commitments, choices, and actions that need to be taken for each one of the areas.
Exercise 1: Couples. (Can also be done privately, with the coach acting as the partner.)
Goal: To take steps to actualize the first three areas of life—1.) relationship with self, 2.) relationships with others, and 3.) relationships with “the whole”.

The active participant shares with his/her partner their next few important goals within each one of the first three life areas, with the choices, commitments, steps and actions that they are ready to take. Then, the partners switch. In this process, the partners should help each other to create a clear definition for themselves. They are encouraged to question, challenge, and help each other focus and clarify their decisions and choices for the next few important steps. Everything should be clearly defined and written down. Both partners have their list as well as their partner's list; in the next weeks to come partners must meet or talk to each other twice a week to support, challenge, and check with each other about their progress.
Exercise 2: Couples. Group.
Goal: To take steps to actualize the next two areas of life—4.) contribution, and 5.) physical/material structure of life.

The active participant shares with his/her partner their next few important goals within each one of the next two life areas, with the steps, choices, commitments, and actions that they are ready to take. The partners should stay the same from Exercise 1. Then, the partners switch. In this process, the partners should help each other to create a clear definition for themselves. They are encouraged to question, challenge, and help each other focus and clarify their decisions and choices for the next few important steps. Everything should be clearly defined and written down. Both partners have their list as well as their partner's list; in the next weeks to come partners must meet or talk to each other twice a week to support, challenge, and check with each other about their progress.
Exercise 3: Couples. Group.
Goal: To take steps to actualize the next two areas of life—6.) new learning/education, and 7.) play, fun, and adventure.

Part I: The active participant shares with his/her partner their next few important goals within each one of the next two life areas, with the steps, choices, commitments, and actions that they are ready to take. The partners should stay the same from Exercise 1. Then, the partners switch. In this process, the partners should help each other to create a clear definition for themselves. They are encouraged to question, challenge, and help each other focus and clarify their decisions and choices for the next few important steps. Everything should be clearly defined and written down. Both partners have their list as well as their partner's list; in the next weeks to come partners must meet or talk to each other twice a week to support, challenge, and check with each other about their progress.

Part II: At the end of Level VI, the whole group gets together for what is called the “Victory Party.” People get to share with the group their accomplishments and breakthroughs in Level VI.

### Commitments for Level VI:

1. The partners must meet or be in communication twice a week, and they must diligently follow their list of things they've chosen to focus on. The partners should use each other for help, support, brainstorming, and anything else they might need in order to accomplish what they set out to accomplish.

### Level VII:

Purpose: To take on areas of life that are most problematic, stuck, or slow-moving, and to create a major breakthrough.

Process: Participants are asked to choose three areas of life within which they feel most “stuck” in terms of achieving their highest vision and/or being able to follow their goals. They're asked to write down what they feel is blocking them or making it difficult to proceed in each one of these areas.

Exercise 1: Group or private. Discussion followed by meditation.

Goal: To create a breakthrough within the first area of choice.

Part I: Discussion. The coach presents to the group the following definitions:
1. The “neurotic payoff,” which includes the need for safety, comfort, avoidance of hurt, etc.
2. The “cost”, which means what it is we pay for to stay safe, contracted, guarded, comfortable, in control, etc.
3. Risk-taking and growth, which means the benefits we gain by venturing out of the comfort zone and expanding towards new possibilities.

Part II: “Claiming Inner Authority”—emotional meditation laying down. As with all meditative exercises, the coach leads the participants in 15 minutes of relaxation of the body and quieting the mind. After that, the coach leads the group in a process that will help them to go deeper into the understanding of what is creating their stuckness, how, and why.

Step 1: Participants are asked to mentally and spiritually contact their emotional center, the home of their Emotional Self, and bring into their minds the first area of life that they chose to examine. They are asked to notice what the most prominent feelings connected with this particular area of life are; for example, if the chosen area is relationships with others, some prominent feelings can be: need for caring, fear of abandonment, self-doubts, and a desire to communicate more expressively. All the feelings, if allowed, might come up together, or one by one, or in groups of two, etc, so the coach needs to give participants time to access these layers of feelings. Participants are asked to first totally allow themselves to feel whatever feelings show up, without judgment, criticism, or need to fix it.

Step 2: Participants are asked to intuitively discern what feelings (feelings are of course always connected to ways of thinking and believing) are in the way of their progress. To follow our example, let's say that the participant in the example realizes that their low sense of self worth is in the way of creating fulfilling relationships.

Step 3: Participants are asked to “feel into” the cause or the root of the difficulty. Most of the time, we hold onto fears or self-doubts because of childhood experiences (or other lifetime experiences); our Emotional Self, when not guided by our Expanded Self, gives the power to others, like parents, teachers, siblings, friends, etc, to define our worth and provide security. What is necessary is to realize that one has the power and authority (the Expanded Self) to define one's worth and provide security and inner strength. Participants are asked to examine whether they are held back by the experience of giving power to others, which is an old residue of a belief that one cannot give oneself what one needs.

Step 4: The coach guides participants in the process of internal dialogue between the Expanded Self and the Emotional Self in order to provide the Emotional Self with guidance and support. Continuous guidance and support from the Expanded Self to the Emotional Self helps to slowly release old limiting notions about self-worth, safety, inner strength, etc.

Step 5: After the meditative process, participants are asked to write about the process, specifically about any communications with the Emotional Self that produced a sense of greater confidence.

Step 6: Sharing and discussion, specifically what they have discovered about their neurotic payoff, the cost, and risk-taking and growth.

Homework: Participants are to continue meeting twice a week with their partner, focusing on the process of actualizing their vision for the specific area of life that they just covered, with the intention to create a strong movement forward.

Exercise 2: “Claiming Inner Authority”—emotional meditation. Group or private.

Goal: To create a breakthrough within the second area of choice.

As with all meditative exercises, the coach leads the participants in 15 minutes of relaxation of the body and quieting the mind. After that, the coach leads the group in a process that will help them to go deeper into the understanding of what is creating their stuckness, how, and why.

Step 1: Participants are asked to mentally and spiritually contact their emotional center, the home of their Emotional Self, and bring into their minds the second area of life that they chose to examine. They are asked to notice what the most prominent feelings connected with this particular area of life are; for example, if the chosen area is relationships with others, some prominent feelings can be: need for caring, fear of abandonment, self-doubts, and a desire to communicate more expressively. All the feelings, if allowed, might come up together, or one by one, or in groups of two, etc, so the coach needs to give participants time to access these layers of feelings. Participants are asked to first totally allow themselves to feel whatever feelings show up, without judgment, criticism, or need to fix it.

Step 2: Participants are asked to intuitively discern what feelings (feelings are of course always connected to ways of thinking and believing) are in the way of their progress. To follow our example, let's say that the participant in the example realizes that their low sense of self worth is in the way of creating fulfilling relationships.

Step 3: Participants are asked to “feel into” the cause or the root of the difficulty. Most of the time, we hold onto fears or self-doubts because of childhood experiences (or other lifetime experiences); our Emotional Self, when not guided by our Expanded Self, gives the power to others, like parents, teachers, siblings, friends, etc, to define our worth and provide security. What is necessary is to realize that one has the power and authority (the Expanded Self) to define one's worth and provide security and inner strength. Participants are asked to examine whether they are held back by the experience of giving power to others, which is an old residue of a belief that one cannot give oneself what one needs.

Step 4: The coach guides participants in the process of internal dialogue between the Expanded Self and the Emotional Self in order to provide the Emotional Self with guidance and support. Continuous guidance and support from the Expanded Self to the Emotional Self will slowly release old limiting notions about self-worth, safety, inner strength, etc.

Step 5: After the meditative process, participants are asked to write about the process, specifically about any communications with the Emotional Self that produced a sense of greater confidence.

Step 6: Sharing and discussion, specifically what they have discovered about their neurotic payoff, the cost, and risk-taking and growth.

Homework: Participants are to continue meeting twice a week with their partner, focusing on the process of actualizing their vision for the specific area of life that they just covered, with the intention to create a strong movement forward.

Exercise 3: Group or private.

Goal: To create a breakthrough within the third area of choice.

Part I: “Claiming Inner Authority”—emotional meditation laying down. As with all meditative exercises, the coach leads the participants in 15 minutes of relaxation of the body and quieting the mind. After that, the coach leads the group in a process that will help them to go deeper into the understanding of what is creating their stuckness, how, and why.

Step 1: Participants are asked to mentally and spiritually contact their emotional center, the home of their Emotional Self, and bring into their minds the third area of life that they chose to examine. They are asked to notice what the most prominent feelings connected with this particular area of life are; for example, if the chosen area is relationships with others, some prominent feelings can be: need for caring, fear of abandonment, self-doubts, and a desire to communicate more expressively. All the feelings, if allowed, might come up together, or one by one, or in groups of two, etc, so the coach needs to give participants time to access these layers of feelings. Participants are asked to first totally allow themselves to feel whatever feelings show up, without judgment, criticism, or need to fix it.

Step 2: Participants are asked to intuitively discern what feelings (feelings are of course always connected to ways of thinking and believing) are in the way of their progress. To follow our example, let's say that the participant in the example realizes that their low sense of self worth is in the way of creating fulfilling relationships.

Step 3: Participants are asked to “feel into” the cause or the root of the difficulty. Most of the time, we hold onto fears or self-doubts because of childhood experiences (or other lifetime experiences); our Emotional Self, when not guided by our Expanded Self, gives the power to others, like parents, teachers, siblings, friends, etc, to define our worth and provide security. What is necessary is to realize that one has the power and authority (the Expanded Self) to define one's worth and provide security and inner strength. Participants are asked to examine whether they are held back by the experience of giving power to others, which is an old residue of a belief that one cannot give oneself what one needs.

Step 4: The coach guides participants in the process of internal dialogue between the Expanded Self and the Emotional Self in order to provide the Emotional Self with guidance and support. Continuous guidance and support from the Expanded Self to the Emotional Self will slowly release old limiting notions about self-worth, safety, inner strength, etc.

Step 5: After the meditative process, participants are asked to write about the process, specifically about any communications with the Emotional Self that produced a sense of greater confidence.

Step 6: Sharing and discussion, specifically what they have discovered about their neurotic payoff, the cost, and risk-taking and growth.

Homework: Participants are to continue meeting twice a week with their partner, focusing on the process of actualizing their vision for the specific area of life that they just covered, with the intention to create a strong movement forward.

Part II: “Breakthrough Party.” The whole group gets together to share and discuss any breakthroughs made in Level VII, especially specific to the three areas of life that each participant chose to focus on for the exercises.

### Commitments for Level VII:

1. Participants must continue with their meetings twice a week and use their partners to push them, challenge them, and support them in their progress within the three most difficult areas of life that they've covered in Level VII.

### Gate of Silence

### Detailed Description of the Processes and Exercises

1. In each level, an exercise or a process can be repeated more than once if needed.
2. Any part of any process or exercise can be repeated more than once if needed.
3. An exercise or a process can be broken down to even smaller excerpts to make it clearer and easier.

### Goals for Gate of Silence:

1. To learn to relax the body.
2. To learn to quiet the mind and be the witness (dropping what Buddhists term the “monkey mind”, and coming into the meditative mind).
3. To ground oneself in the present moment.
4. To cultivate meditative mind in daily life.
5. To learn to be “in the breath.”
6. To cultivate the ability to visualize, sense into important questions and receive guidance within the meditative state.
7. To understand the seven attributes of a peaceful state of mind: acceptance; releasing and receiving; gratitude; surrender; forgiveness; stillness; oneness.

There are commitments that participants take on connected to each level of the Gates. These commitments are like assignments to be done between weekly meetings at home. They are noted at the end of each level.

Gates of Power establishes seven different levels of inquiry to cultivate, expand, and liberate our ability to follow our life path. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

### Level I:

Purpose: To learn to relax the body and quiet the mind.

Process: Participants are asked to engage in a meditation and after, write down their observation about their ability to relax their mind and body. They should be specific as to what was easy for them and what was not.
Exercise 1: “Stages for Effective Meditation”—meditative exercise. Group or private.
Goal: To learn to relax the body.

### Part I:

Step 1: Participants are asked to lie down in the “corpse pose”: feet and legs separated, hands to the sides of the body but not touching it, palms up, neck long (a continuation of the spine), jaw dropped, mouth relaxed and barely open with a little space between the teeth. Eyes should be soft, as if dropping back into two little pillows.

Step 2: Once the proper laying down position is achieved, participants are asked to create an inner space that they can come back to whenever they meditate—a place that feels safe, private, beautiful, and peaceful. They can create a combination of elements that most relax them; the combination does not have to be realistic. For example, it can be a beach house with beautiful rugs and pillows, lots of plants, open roof, and a wall that is open to the ocean. They can always imagine the open roof and wall to be closed automatically by a glass door, or this place can always be full of sunshine—there is no need to close anything. They can arrange their inner space however they want. The coach gives them some time to create the space and put themselves in it.

Step 3: Now that participants are in a meditative space, relaxing, participants are asked to feel into the sensations in their bodies. They should notice any feelings present and where in the body (Emotional Self) and let the feeling drop away as much as possible. They should notice tensions in the body, like gripping, tightness, heaviness (Defensive Self), and to tell themselves, “I am letting go of tightness and tension in my body”. The coach should say out loud: “Many of our tensions are chronic and will not relax immediately at will, so one needs to be patient with this process of letting go.” Next, the coach guides them to feel each part of the body and to imagine that the muscles in that part are melting and sinking into the floor. Then, the bones soften and sink Part by part, until the whole body feels like a part of or one with the rug/sand/grass/whichever surface they are laying on in their meditative space. Then, the coach suggests that they should be open to experiencing the body as streams of energy moving and slowly losing the usual shape and feeling of a “body”. It should feel more like pulsation and breath.

Step 4: As with all meditations, the exercise ends with a few minutes of re-entering the normal state and returning to the body and its shape.

Part II: Participants are asked to write about their experience.

Part III: Sharing and discussion, in small groups, about how participants felt.
Exercise 2: “Dropping the Mind”—sitting down meditation. Group or private.
Goal: To learn to quiet the mind.

Part I: Sitting down exercise.

Step 1: Participants are asked to bring themselves into their meditative space.

Step 2: The coach leads them through a relaxation of the body.

Step 3: Dropping the mind. The coach guides them to imagine a wide window in the place of their third eye (between the eyebrows). They are asked to imagine that they are opening up that window and letting a vast blue sky into their minds. For the rest of this meditation, they are asked to attempt to have their mind stay open, vast and clear like the sky. Thoughts are to be imagined as birds or clouds going across the sky and disappearing. Participants are asked to not attach themselves to their thoughts, just to notice them and let them go, saying to themselves, “I don't need this thought right now. I am letting it go.” After they get the instructions, they begin to experiment with noticing thoughts and dropping them. The coach makes sure that people are not dozing off or daydreaming, and comments on the fact that this is not an easy thing to do and participants should be patient and not discouraged. This step should take about fifteen minutes.

Step 4: Participants take a few minutes to return to a normal state.

Part II: Participants are asked to write about their experience.

Part III: Sharing and discussion, in small groups, about how participants felt.
Exercise 3: “The Art of Witnessing”—meditation laying down or sitting. Group or private.
Goal: To practice the art of witnessing.

Part I: Laying down or sitting exercise.

Step 1: Participants are asked to bring themselves into their meditative space.

Step 2: The coach leads them through a relaxation of the body.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants are asked to begin to cultivate the witnessing ability by witnessing the energy in the body—how it moves, where it moves, where it's stuck—without judgments, comments, or need to change anything. If there is a judgment or a desire to change, they are asked to witness that without judgment. If they're having difficulty in the process of witnessing, they are asked to witness the difficulty without judgment. The coach continues to offer ways of witnessing. Witnessing is the ability of the Expanded Self; by developing the ability to witness, one develops the ability to be aware and accepting.

Step 5: Participants take a few minutes to return to a normal state.

Part II: Participants are asked to write about their experience.

Part III: Sharing and discussion, in small groups, about how they felt.

### Level I Commitments:

1. Participants are asked to commit to a meditation once a day for fifteen to twenty minutes, and after the meditation, to write into their journals about their experience, specifically what part of the meditation feels easy and flowing and what part needs work.

### Level II:

Purpose: To learn to use visualization and breath to expand meditative abilities.

Process: Participants are asked to pay attention to their breath patterns—when, where, how, and why they stop the breath and when, where, how, and why they find themselves breathing freely and fully. They are to write down as much as possible specific breath patterns and their observations.
Exercise 1: “Floating on the Waves of the Breath”—meditative, visualization, and breath exercise. Group or private.
Goal: To learn to rest within the breath.

Part I: After Level I in every meditative exercise within the Gate of Silence the four meditative steps are present; sometimes, steps and new elements are added.

Step 1: Participants are asked to bring themselves into their meditative space.

Step 2: The coach leads them through a relaxation of the body.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants are asked to witness the energy in the body—how it moves, where it moves, where it's stuck—without judgments, comments, or need to change anything. If there is a judgment or a desire to change, they are asked to witness that without judgment. If they're having difficulty in the process of witnessing, they are asked to witness the difficulty without judgment. Any feelings, sensations, thoughts, tensions in the body, etc should be acknowledged and witnessed without judgment.

Step 5: Participants are asked to focus on their breath, feeling it coming in and out and to visualize themselves floating on the waves of their own breath, as if they're laying on a magical carpet or an inflatable mattress in a pool, and peacefully riding the waves. The visualization goes on—the coach asks them to imagine that the carpet or mattress disappears and they become a sea bird sitting on the waves of the ocean. They are encouraged to find a restful state of mind. As they are resting, they will continue to drop away the thoughts and witness themselves resting on the breath.

Step 6: Participants take a few minutes to return to a normal state.

Part II: Participants are asked to write about their experience.

Part III: Sharing and discussion, in small groups, about how they felt.
Exercise 2: “Healing Breath”—meditative exercise, sitting or lying down. Group or private.
Goal: Using the healing power of the breath.

Part I: In every meditative exercise within the Gate of Silence the four meditative steps are present and new elements are added.

Step 1: Participants are asked to bring themselves into their meditative space.

Step 2: The coach leads them through a relaxation of the body.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants are asked to witness the energy in the body—how it moves, where it moves, where it's stuck—without judgments, comments, or need to change anything. If there is a judgment or a desire to change, they are asked to witness that without judgment. If they're having difficulty in the process of witnessing, they are asked to witness the difficulty without judgment. Any feelings, sensations, thoughts, tensions in the body, etc should be acknowledged and witnessed without judgment.

Step 5: The coach guides the participants to visualize that their spine is like a beam of strong light starting from the center of the earth and moving towards the sky—a channel of light and energy that is simultaneously moving up and down. Once they establish this, the participants are to visualize a strong radiating center in the chest, and to visualize the light emanating from their chest pulsating in and out as they breathe. They are asked to visualize a color for the inhalation and a different color for the exhalation. As they notice places in their body or in their mind that are tense; tight, or contracted, they are asked to imagine that place breathing in and out, visualizing the colors of the inhalation and exhalation. The coach guides them to slowly move throughout their body and feel different places pulsate with the light, energy, and breath, until the whole body radiates and pulsates with light, energy, and breath.

Step 6: Participants take a few minutes to return to a normal state.

Part II: Participants are asked to write about their experience.

Part III: Sharing and discussion, in small groups, about how they felt.
Exercise 3: “Release and Receive”—meditative exercise lying down, releasing and receiving. Group or private.
Goal: To use the breath to release and receive.

Part I: In every meditative exercise within the Gate of Silence the four meditative steps are present; sometimes, steps are added.

Step 1: Participants are asked to bring themselves into their meditative space.

Step 2: The coach leads them through a relaxation of the body.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants are asked to witness the energy in the body—how it moves, where it moves, where it's stuck—without judgments, comments, or need to change anything. If there is a judgment or a desire to change, they are asked to witness that without judgment. If they're having difficulty in the process of witnessing, they are asked to witness the difficulty without judgment. Any feelings, sensations, thoughts, tensions in the body, etc should be acknowledged and witnessed without judgment, and then let them go.

Step 5: Participants are asked to visualize themselves lying on a beach, a place that's safe and private. It's a warm day and they have endless time with nowhere to go and nothing to do. They are laying by the water with the water covering their feet. As they breathe out, they are asked to begin a release process—on each out breath, they are asked to release tensions, fears, angers, resentments, worry. They are to choose specific feelings, events, memories, beliefs, etc, each time they're breathing out. If they feel they need to release something more than once, they can repeat the same element a few times and then move on to the next one. They should visualize that whatever energy they're releasing goes through their body to their feet, and through their feet into the water. The water is clearing that energy and removing it. As they continue to release, they are to visualize that the water slowly comes up and washes first over their legs, then their pelvis, chest, arms, and shoulders—the coach should allow a few minutes to allow each body part to adjust and be immersed. The participants are to visualize that they are comfortably soaking in the water, but not in any discomfort or danger. By the time they're immersed in the water, they start the second round—the receiving. Participants begin to concentrate on their in breath and see a color with every in breath as they take in from the water a sense of comfort, trust, love, and joy. They should come up with specific images and feelings of things they want to take in and receive. The coach gives them a few minutes to do this. At the end of this part, participants are asked to just rest, breathing and visualizing the comfort of the water and the sand.

Step 6: Participants take a few minutes to return to a normal state.

Part II: Participants are asked to write about their experience.

Part III: Sharing and discussion, in small groups, about how they felt.

### Commitments for Level II:

1. Participants should commit to practicing the breaths and visualizations on a daily basis and write down their observations.

### Level III:

Purpose: To learn to use movement and sound meditation.

Process: Participants are asked to put on some music and experiment with moving and making sounds, with the goal being that the music and movement become one, and the “monkey mind” does not interfere with their ability to spontaneously move and make whatever sounds come up for them. They should be patient with the process—it is not an easy one, as we are not taught to just move or make sounds. They should observe the difficulty of doing this without any judgments and write about their observations.
Exercise 1: “Spontaneous Movement and Sound Meditation”—moving and sound exercise. Group or private.
Goal: To learn to relax the body, quiet the mind, and witness through movement and sound.

Part I: Participants stand up, softly close their eyes, and take a minute to put themselves into their meditative space and move around to stretch whatever feels tense in their body—move the shoulders and neck, stretch up and down, and consult their body as to what needs to be stretched and moved. As meditative music comes up, they begin to move to it, attempting to drop their thoughts and just follow the music. If there are any sounds that spontaneously emerge—sighs, laughter, etc—they should be allowed. Participants should witness any kind of self-consciousness or self-criticism and drop it, and keep themselves focused on the music and the way it naturally, organically moves the body. This part of the exercise should last 15-20 minutes. After, they are allowed to open their eyes and begin to move with other people. The goal is to be very close to their own natural impulses, in their own center while interacting with other movers without trying to modify, entertain, charm, etc. At the end of the exercise, the coach allows time for the participants to bring their movements to and end, to calm down, center on their breath, and gently come back to a “normal” state.

Part II: Participants are asked to write about their experience.

Part III: Sharing and discussion, in small groups, about how they felt.
Exercise 2: “Becoming All Things”—moving and sound meditation. Group or private.
Goal: To learn to relax the body, quiet the mind, and witness through movement and sound.

Part I: Participants stand up, softly close their eyes, and take a minute to put themselves into their meditative space and move around and stretch whatever feels tense in their body—move the shoulders and neck, stretch up and down, and consult their body as to what needs to be stretched and moved. The coach puts 6-7 different pieces of music, with very different moods and feelings, and with each piece of music, participants are given different suggestions. For example, the coach can choose the themes from seasons of the year, elements of nature, landscapes (mountains, rivers, etc), different cultures—the coach creates this section uniquely. The goal is for the participants to be able to shift rapidly from one mood to another, from one element to another, and become the element that is suggested—for instance, become winter, or become the wind, or become a Spanish flamenco dancer. If there are any sounds that spontaneously emerge—sighs, laughter, etc—they should be allowed. This should be done for fun and to drop self-consciousness and “stuckness” in the mind, and to learn to move spontaneously and organically. Participants have a few minutes to move to each piece of music alone, and then a few minutes of the group all together. At the end of the exercise, the coach allows time for the participants to bring their movements to and end, to calm down, center on their breath, and gently come back to a “normal” state.

Part II: Participants are asked to write about their experience.

Part III: Sharing and discussion, in small groups, about how they felt.
Exercise 3: Moving and sound meditation. Group or private.
Goal: To learn to relax the body, quiet the mind, and witness through movement and sound.

Part I: Participants stand up, softly close their eyes, and take a minute to put themselves into their meditative space and move around and stretch whatever feels tense in their body—move the shoulders and neck, stretch up and down, and consult their body as to what needs to be stretched and moved. Then, the coach asks the participants to choose a theme that is very present for them at that point in time and begin to move from the feeling or mood of that theme. For example, if someone has just gotten a raise at work and is ecstatic, their mood is one of exhilaration. The group begins to move and make sounds from that feeling. The coach gives the participants a little time to find their movements and sounds, and then they create a big circle. One by one, each person moves into the middle of the circle and takes a minute to move and sound within their theme. When they move back to their place, whoever wants to respond to them in movement or sound enters the circle and responds. If there is enough time to allow the original mover to go into the center again after they have witnessed the response, then the coach should allow it to happen. At the end of the exercise, the coach allows time for the participants to bring their movements to and end, to calm down, center on their breath, and gently come back to a “normal” state.

Part II: Participants are asked to write about their experience.

Part III: Sharing and discussion, in small groups, about how they felt.

### Commitments for Level III:

1. Participants are asked to commit to move and make sounds daily to music of their choosing. This is done to develop their ability to drop the mind and become the theme and the music. They should write down their experiences and their observations of the process.

### Level IV:

Purpose: 1.) To learn to be in the present moment and cultivate meditative mind in the moment. 2.) To explore forgiveness and acceptance—two of the attributes of a peaceful mind. Both forgiveness and acceptance allow for compassion and unity—all important elements of cultivating a peaceful mind.

Process: Participants are asked to sit at home in a comfortable sitting position with their eyes open, looking to the front. They're asked to apply the four basic steps of meditation: 1.) Creating an imagined, comfortable meditative space; 2.) Relaxing the body and grounding themselves in the breath; 3.) Quieting the mind; and 4.) Witnessing. The difference in this exercise is that they are actually asked to choose an actual room as their meditative space and keep their eyes open. After taking a moment to relax their body, and grounding themselves in the breath, they are to start the process of quieting the mind, and at the same time, constantly attempting to bring their minds to the present moment. This means noticing objects, colors, and shapes in front of them and sounds around them, and being aware of feelings, sensations, and thoughts. The purpose of the meditation is to keep oneself very much in the moment, place, and sensory reality. After about fifteen minutes of “being present” meditation, participants take a minute to stretch themselves, and then write about the experience.

Exercise 1: “The Garage Sale of the Mind”—laying down meditation. Group or private.

Goal: To empty the mind of old grudges and cultivate forgiveness.

Part I. Participants lay down in the “corpse pose” and repeat the four basic steps.

Step 1: Participants are asked to bring themselves into their meditative space.

Step 2: The coach leads them through a relaxation of the body and connecting to the breath.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants are asked to witness the energy in the body, mind, and emotions—how it moves, where it moves, where it's stuck—without judgments, comments, or need to change anything.

Step 5: Participants are asked to imagine they're having a garage sale of the mind. This means old, unnecessary, burdening memories, feelings, and thoughts are being put out to sell. Participants should imagine a big yard and begin to pull out from their inner storage the memories, feelings, and thoughts that they are willing to let go of—especially grudges, resentments, and lack of forgiveness towards oneself and others. They should imagine each of these feelings, memories, and thoughts as symbolic objects. The objects are transformed to pretty looking things by the action of release and forgiveness. Participants then see themselves putting the objects out in the yard for sale. With each item, the coach gives them time to do a process of release. The participants will be doing this with at least five items. It is very important that they have a sense of letting go of the anger, resentment, or grudge, and feel a sense of true letting go.

Step 6: Participants take a few minutes to return to a normal state.

Part II: Participants are asked to write about their experience, especially about which items they were able to let go and which ones they weren't.

Part III: Sharing and discussion, in small groups, about how they felt.

Exercise 2: “The Movement Dialogue”—meditative exercise. Group.

Goal: To cultivate acceptance through a moving meditation.

Part I:

Step 1: Participants are asked to stand in a group, with their eyes open, and bring themselves to the present moment. They can help themselves do that by noticing details, hearing, smelling, and grounding themselves in a sensory way and in their breath.

Step 2: Participants begin to relax the body by doing gentle stretching. As they move, they begin to drop the mind, quiet the mind, and witness. They're given 10-15 minutes to move alone, however they personally need to move; after this, they pair up and begin to notice their partner—details about them as the two of them move together. Each one of them does whatever they want to do, but they begin to notice any judgments, comments, or criticisms that are being conjured about themselves or their partner. The coach encourages them to begin to let go of the barriers they're putting between themselves and the experience. After a few minutes, the partners begin to move together, finding a way to work through mirroring movements and complementing movements—creating a movement dialogue with each other. They should continuously drop judgments and concerns and come back to the moment, opening up to the experience and the enjoyment of moving together. The coach asks the participants to change three different partners throughout the exercise, with a few minutes for each partner. At the end of the exercise, they bring their movements to and end and sit down quietly.

Part II: Sharing and discussion, in small groups, about how they felt.

Exercise 3: “Being Present”—meditative exercise. Group.

Goal: To cultivate acceptance through meditation.

Part I: The whole group sits together in a wide circle. They are to do the exercise with their eyes open, similar to the process they did at home.

Step 1: Participants bring themselves to the actual place and actual moment. The coach then guides them in the next three steps:

Step 2: Relaxing the body and connecting to the breath.

Step 3: Quieting the mind.

Step 4: Witnessing. While doing this meditation, participants are asked to look around at other people around them and notice any discomfort, self-consciousness, judgments, and criticisms of themselves or others that came up. They are asked to gently try to let go of those and keep practicing acceptance of others, themselves, and the moment. The exercise seems simple, but it is very hard to do because of the intimacy and the stillness of the moment, which brings up a tremendous amount of anxiety and defensiveness in people.

Step 5: Participants are guided to close the meditation by gently stretching.

Part II: Participants are asked to write about their experience, especially about which feelings and thoughts they were able to let go and which ones they weren't.

Part III: Sharing and discussion, in couples, about how they felt.

### Commitments for Level IV:

1. Participants should practice “being present” meditation on a daily basis.
2. Participants should keep journaling about the elements that they need to let go of, forgive, and forget.
3. Participants practice the ability to accept themselves, other people, and their experiences, even though they may be upsetting.

### Level V:

Purpose: To explore surrender gratitude, and stillness—attributes of a peaceful mind. Surrender allows for trust, gratitude, and stillness for clarity—all important elements for cultivating a peaceful mind.

Process: Participants are asked to write down their understanding of surrender (not giving up!), and their observations about their ability to surrender, or not, as well as where, and why they find that they can surrender, and where and why they find that they cannot.

Exercise 1: Discussion followed by sharing and writing. Group.

Goal: To understand the meaning of surrender.

Part I: What is surrender? Participants discuss the ideas and experiences they have written about in their previous process.

Note for the coach: the coach, when guiding the discussion, should be familiar with and clarify the method's definition of surrender: a state of mind in which we choose, even when it's difficult, to let go of fear and defensiveness and allow a feeling of trust in the greater order of the universe allowing things to be as they are. In this state, we become more open to the moment, and our ability to perceive, understand, and allow possibilities is greatly enhanced.

Part II: Couples. The partners take turns sharing specific incidents, times, and experiences where they find that it is hard for them to surrender.

Part III: Writing. Participants are asked to write a list of things that they are grateful for, and notice if they see a connection between gratefulness and the ability to surrender.

Part IV: Participants discuss in small groups: is there a connection between gratitude and surrender? What did they find out about it while writing?

Exercise 2: “Melting the Knots”—laying down meditation. Group or private.

Goal: To practice the art of surrender.

Part I: The coach leads the participants through the four steps of meditation.

Step 1: Participants bring themselves into their meditative space.

Step 2: The coach leads them through a relaxation of the body and connecting to the breath.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants witness the energy in the body, mind, and feelings—how it moves, where it moves, where it's stuck—without judgments, comments, or need to change anything.

Step 5: First, participants are asked to notice chronic tensions in the body and define two or three places that feel heavy, constricted, or uneasy. Then, they're asked, choosing one place at a time, i.e. the neck, to visualize a dark rope around the neck. They are guided to allow the dark rope to begin to melt into a dark liquid, seeing the liquid melting into the earth and disappearing. Then, they take the next tense area and do the same thing, and then the third—the coach gives themtime, and guides them from one part to the next. Next, they move to their heart center and choose three feelings that are chronically haunting—for example, self-doubt, worry, or shame. Again, the coach guides participants from one feeling to another as they visualize the feeling as a dark rope that slowly melts and becomes dark water that seeps down into the earth and disappears. Then participants are asked to enter the mind and choose three haunting thought patterns, for example, “I must rush. There is no time,” or “I can never finish things.” Etc. They should choose three chronic, haunting patterns and then, led by the coach, they pick one at a time and imagine that pattern as a dark rope melting down into dark liquid and slowly disappearing into the earth. After they finish with the very last round, the coach gives them time to rest in their breath. The coach offers the affirmation: “I am a work in progress. I don't need to be perfect. I accept my process and the loving guidance I constantly get. I trust my life evolves in the best way for my highest good.” The coach repeats the affirmation a few times and asks participants to allow it in. After a few moments of silence, participants are asked to notice how they're feeling now that they have released and surrendered. They should notice how the body, heart, and mind feel.

Step 6: Participants take a few minutes to return to a normal state.

Part II: Participants are asked to write about their experience, especially about which items they had a harder time letting go and which ones they did not.

Part III: Sharing and discussion, in couples, about how they felt.

Exercise 3: “Cultivating Gratitude”—Sitting meditation. Group or private.

Goal: To practice the art of gratefulness.

Part I: This exercise is done with the eyes closed.

Step 1: Participants bring themselves into their meditative space.

Step 2: The coach leads them through a relaxation of the body and connecting to the breath.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants witness the energy in the body, mind, and emotions—how it moves, where it moves, where it's stuck—without judgments, comments, or need to change anything.

Step 5: Participants are asked to bring up elements and aspects in their life that they are grateful for—the list can include people, experiences, talents, etc. As they do this, they should take one thing at a time and truly take a minute to enjoy, appreciate, and relish that element fully. Participants are given 15-20 minutes to do this, and then, to notice how they feel now. Most of the time there is a sense of peace, joy, and wellbeing.

Step 6: Participants take a few minutes to return to a normal state.

Part II: Sharing and discussion, in couples, about how they felt.

### Commitments for Level V:

1. Participants are asked to continue cultivating the art of surrender and the art of gratitude. They should practice daily gratitude meditations like the one from Exercise 3, and twice a week they should do the dark rope meditation from Exercise 2.
2. Participants should keep writing in their journals about the process.

### Level VI:

Purpose: To cultivate the experience of oneness—an attribute of a peaceful mind. A sense of oneness allows for a sense of unity, and softly it strengthens all important elements of a peaceful mind.

Process: Participants are asked to write down their experience of oneness, and to depict and describe moments when they felt one with nature, others, themselves, spirit, music, laughter, feelings, etc.

Exercise 1: Discussion followed by writing. Group or private.

Goal: To understand the experience of oneness.

Part I: Participants share with the group their moments of oneness and discuss their observations as to why, where, and when these moments happen or happened. What is the feeling in these moments? What allows them to happen?

Part II: What creates a sense of separation between me, others, and life? Participants are asked to write about this topic, giving examples of times, relationships, and experiences where they felt separate or were aware of isolating themselves.

Part III: Sharing the writing with a partner (couples).

Exercise 2: “I See Myself in You”—sharing. Group.

Goal: To cultivate the experience of oneness.

The whole group sits together in a circle; beginning at one point, the coach asks the first participant to turn to the person sitting left of them. The first participant takes a moment to observe and take in the second person, and then they say “I see myself in you.” They go on to describe in two or three sentences how they see themselves in that person, in terms of emotions, skills, talents, or even difficulties or struggles. Then, that person turns to the one on the left of them and does the same, until all participants have finished their turn. When they have gone around one time, they take a few minutes to just be silent. Then, they repeat the process the other way—the same person starts, but they go to the right of themselves and the circle continues from one person to another. After this exercise, there is 5-10 minutes of silent meditation to let it all absorb.

Exercise 3: “Hands of Light”—laying down meditation. Group or private.

Goal: To release the sense of separation.

Part I. Participants close their eyes, and the coach guides them through the four steps.

Step 1: Participants bring themselves into their meditative space.

Step 2: The coach leads them through a relaxation of the body.

Step 3: Dropping the mind (the process should be the same from the previous exercise: envision a third eye opening to let in the vast blue sky and send each thought away like a bird or a cloud, acknowledging it but letting it disappear.)

Step 4: Witnessing. Participants witness the energy in the body—how it moves, where it moves, where it's stuck—without judgments, comments, or need to change anything.

Step 5: Participants are asked to visualize that they are slowly being lifted from the ground as if held by gentle wind, angels, or hands of light, and they are slowly being lifted up. The coach guides them to hear and see the earth as they are lifting slowly away from it. The noises diminish, and people and things get smaller in size, until they are floating above the earth, seeing the earth like a little tiny ball. Throughout this process, the coach reminds them that they're very safe and that they are relaxed and supported. When they are hanging above the earth, they can feel themselves being one with the energetic field, the sky, clouds, and the whole universe. There is no separation between them and nature; the feeling is of oneness. They are given a few moments to be in that state, and then the coach starts guiding them slowly down. Moving towards the earth, they begin to see things clearly—people, houses, trees, etc. They're gently being rocked, held, and then finally placed back to lay down where they began their meditation, in their meditative space. The coach gives them a few minutes to see how the meditation affected them and how they feel.

Step 6: Participants take a few minutes to return to a normal state.

Part II: Participants are asked to write about their experience.

Part III: Sharing and discussion, in small groups, about how they felt.

### Commitments for Level VI:

1. Participants are asked to practice the feeling and realization of oneness by seeing themselves in others, in nature, animals, and all things.
2. Participants should keep observing, writing, and working to dissolve a sense of separation. They should watch their defensive selves and their fear.

### Level VII:

Purpose: To master the practice of three kinds of healing meditations. 1. For the self; 2. For another person; and 3. For the global mind and earth.

Process: Participants are asked to research and explore three different healing meditations, one for self healing, the second for the healing of another person, and the third for healing groups or environment. They should prepare the first healing meditation fully, writing the steps and practicing it themselves so they can guide the group or a partner through the meditation.

Exercise 1: Couples/group.

Goal: To master the skill of guiding healing meditations.

Participants are presenting and guiding a self-healing meditation using the first person. Example: “I now release all worries,” etc.

Part I (in couples). Each couple is asked to meet in privacy outside of class two separate times. They take turns to guide their partner in the self-healing meditation they have prepared. After each time, they discuss the effects of the meditation. The guiding partner should take notes regarding the effectiveness of the meditation they led.

Part II (in small groups). Participants share the ideas and effects of the meditations they worked on. The group decides on one meditation that appeals to most of them. The participant who presented that meditation guides the whole group in this specific meditation.

Exercise 2: Couples/Group.

Goal: To master the skill to guide healing meditations for another person.

Participants present and guide a healing meditation aimed to help another person. The meditation uses the second person. Example: “You are now ready and willing to let go of . . . ” etc.

The structure is the same as above: participants meet, work on the exercise with their partners, and then in a group. Then the group chooses the most appealing one and that participant presents.

Exercise 3: Group.

Goal: To master the skill of leading a group through a healing meditation.

One participant from each of the small groups is chosen to present and guide a healing meditation. All three kinds of healing meditations should be presented.

Part I: We'll take two or three meetings. Each chosen participant leads the whole group through a healing meditation.

Part II: The group shares the effects of the meditation and provides feedback for the participant who led the meditation.

Part III: The process is repeated with different participants chosen to lead the meditation. Ideally as many participants as possible should have the experience of leading a whole group in a meditation.

### Commitments for Level VII:

1. Participants are asked to practice healing meditations of all three kinds. One can remotely direct a healing meditation toward a loved one or someone in need as well as toward a chosen group of people and/or the environment

### Gate of Knowledge

### Detailed description of the Processes and Exercises

1. In each level, an exercise or a process can be repeated more than once if needed.
2. Any part of any process or exercise can be repeated more than once if needed.
3. An exercise or a process can be broken down to even smaller excerpts to make it clearer and easier if needed.

The exercises in the Gate of Knowledge are entirely discussion-based and so there are no patentable “exercises” per se in this section.

### Goals for Gate of Knowledge:

1. To encourage personal investigation into “life's grand questions.”
2. To create a forum for exploring, pondering, and discussing these questions.
3. To provide a list of suggested reading materials that include all spiritual paths, science, philosophy, and art, in order to help the process of exploration of the questions. Participants can add their own suggestions to the list, with short entries.
4. To train participants to present themes to the group, based on personal writing and observation, in conjunction with reading material.
5. To train participants to create discussion forums, worksheets, and exercises regarding “life's grand questions.”

There are commitments that participants take on connected to each level of the Gates. These commitments are like assignments to be done between weekly meetings at home. They are noted at the end of each level.

Gates of Power establishes seven different levels of inquiry to support our ability to grapple with life's “grand questions”. Some of the following processes and exercises can be taught in a private session; all of them can be and are done in a group. After each exercise and process, a short time should be designated for sharing and discussion.

While there is a specific central focus on the Gate that is being studied at that point, each group meeting covers three to four Gates. Every meeting starts with twenty minutes of meditation (Gate of Silence); the meditations each time are different (sitting; lying down; movement; breath; sound; etc). Every group naturally includes sharing and discussions (Gate of Dialogue). Every group also includes some exercises that use creative expression (Gate of Creative Expression). Every group includes a review of current personal choices, commitments, and actions—a process which assists the ability to stay on target (Gate of Life Path).

General Note about the Gate of Knowledge:

The goal of the Gate of Knowledge is to explore at least three “grand questions” in each level. Gates of Power does not provide answers to these questions; it provides a container for exploration and discussion. All opinions, paths, ideas, and info are welcome, and there is no “right” or “wrong,” just different offerings of ideas. Discussions must stay open; there are no “written in stone” conclusions. Intelligent debates are encouraged, but they are not to be aggressive, defensive, or righteous. A sense of humor and acceptance is a must, as is total respect toward each member's opinions and ideas. Each class starts with a meditation to focus the energy and calm the mind before engaging in these deep intellectual discussions.

Each level in the Gate of Knowledge will have participant presentations. Participants can work together in small teams or solo. The coach must oversee that each member of a small group gets to present or participate in a presentation team. Each level will have at least one total group discussion about the themes presented in that level.

Every class begins with a meditation following the four first steps outlined in the previous Gate. The fifth step is meditative, the Heart, and it ponders the questions that are discussed in class that day.

### Level I:

Purpose: To create a communal list of the “grand questions” and set up the ground rules for discussions, presentations, and homework reading. Choose the first three “grand questions” and create the discussion groups and structure for the exploration.

Process: Participants are asked to ponder the “grand questions” of life that they see as important, questions that they are wrestling with or did in the past. They should write down a list of all these questions, and next to each one, write a short entry with their ideas and insights, as well as confusions, doubts, and the things you would like to clarify when it comes to each of the questions.

Exercise 1: Discussion. Group or private.

Goal: To create a communal list of the “grand questions.”

Part I: Discussion. The coach leads the whole group in a discussion titled “What are the Grand Questions of life?” Everybody chimes in, and one person acts as the note taker, and a master list is formed with all the questions chosen by the group. The list is typed and distributed to each person at the next session. The list should be distilled into concise themes—for instance, “is there evil” and “is there a fight between good and evil” will fit together into one question.

Part II: The coach suggests the three basic questions from which all other questions spring. These questions will probably be on the list; the coach needs to get the group to agree on these first three “grand questions.” The questions are:
1. What moves the universe? How is it operating—what is the glue that keeps it together and moving in what seems like orderly patterns?
2. What are the laws that govern the universe? How much do we know already about them, scientifically and spiritually?
3. What are the laws that support and maintain our life as human beings, physically, mentally, and spiritually?
Each group will be different; they might verbalize the questions a little differently, but the first three questions need to be around the nature of the universe and the laws that govern life.

Note: These questions are profound, and the group of course is not expected to resolve them or come to any finite answers. The goal is the exploration.

Part III: Homework. Participants are asked to do their own reading, research, mediation and pondering about the questions, and write notes. A team of three in each small group is selected to present info, ideas, textual excerpts, suggested exercises and worksheets for their small group. (Small groups are usually 10 to 12 people.)

Part IV: Presentation and discussion.

Exercise 2: Group.

Goal: To discuss the first three “grand questions” that were chosen.

Part I: Homework. Before they present to their small groups, the team that's chosen to present can decide on the amount of times that they need to meet to feel ready for their presentation. Each member of the presenting team has their homework assignment so that when they come together for the team's meeting, they are ready to create a cohesive presentation to the group. Each small group meets at least twice in the next two weeks. The team members present to the group, and then they open the floor for discussion. Someone from the presenting team writes notes about the discussion, ideas, information, etc. Exercise 2 takes places place outside of class; participants meet in someone's house or in a public setting for discussion and exploration.

Exercise 3: Group.

Goal: To discuss and explore the three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and personal insights, and not necessarily to be right. The discussion is open-ended in nature. The coach should make sure that there is a healthy, respectful debate and sharing going on—not a clashing of wills and egos.

Part II: Each participant takes time to write down their intuitive, heartfelt notes about the three “grand questions”—things that ring true or feel right to them personally.

### Commitments for Level 1:

1. Participants should read as much as possible of the suggested material.
2. Participants should make sure the meetings outside of class are organized and productive.
3. Participants should make sure the presentations are thorough (for the people that are presenting).

### Level II:

Purpose: Participants should choose the second three “grand questions” and create the discussion groups and structure for the exploration.

Process: Participants are asked to ponder the next three “grand questions” of life that they see as important, and questions that they are wrestling with or did in the past. They should write a short entry for each, with their ideas and insights, as well as confusions, doubts, and the things they would like to clarify when it comes to each of the questions.

Exercise 1: Discussion. Group or private.

Goal: To examine the next three on the list of “grand questions.”

Part I: Group discussion about what the next three questions are. The coach strongly suggests the next three basic questions from the list, which focus on the self. The questions are:

1. Who am I? What are we made of—body, spirit, mind, and energy?

2. How am I connected to the rest of existence

3. Why am I here?

Each group will be different; they might verbalize the questions a little differently, but the second set of three questions needs to be around the theme of who we are and why we are here.

Note: These questions are profound, and the group of course is not expected to resolve them or come to any finite answers. The goal is the exploration.

Part III: Homework. Participants are asked to do their own reading, research, meditation and pondering about the questions, and write notes. A team of three in each group is selected to present info, ideas, textual excerpts, suggested exercises and worksheets for their small group. (Small groups are usually 10 to 12 people.)

Exercise 2: Group.

Goal: To discuss the second three “grand questions” that were chosen.

Part I: Homework. Before they present to their small groups, the team that's chosen to present can decide on the amount of times that they need to meet in order to feel ready for their presentation. Each member of the presenting team has their homework assignment so that when they come together for the team meeting, they are ready to create a cohesive presentation to the group. Each small group meets at least twice in the next two weeks. The team members present to the group, and then they open the floor for discussion. One member of the presenting team acts as the leader of the discussion, keeping the ground rules; another acts as the note taker. Someone from the presenting team writes notes about the discussion, ideas, information, etc. Exercise 2 takes places place outside of class.

Exercise 3: Group.

Goal: To discuss and explore the second three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and personal insights, and not necessarily to be right. The discussion is open-ended in nature. The coach should make sure that there is a healthy, respectful debate and sharing going on—not a clashing of wills and egos. The coach acts as the leader of the discussion in order to make sure that the ground rules are respected.

Part II: Each participant takes time to write down their intuitive, heartfelt notes about the second three “grand questions”—things that ring true, and feel profound or right to them personally.

### Commitments for Level II:

1. Participants should read as much as possible of the suggested material.
2. Participants should make sure the meetings outside of class are organized and productive.
3. Participants should make sure the presentations are thorough (for the people that are presenting).

### Level III:

Purpose: Participants should choose the next three “grand questions” and create the discussion groups and structure for the exploration.

Process: Participants are asked to ponder the next three “grand questions” of life that they see as important, and questions that they are wrestling with or did in the past. They should write a short entry for each, with their ideas and insights, as well as confusions, doubts, and the things they would like to clarify when it comes to each of the questions.

Exercise 1: Discussion. Group.

Goal: To choose and define the next three on the list of “grand questions.”

Part II: Group discussion about what the next three questions are. The coach strongly suggests the next three basic questions from the list, which focus around the questions of destiny and personal will. The questions are:
1. Who chooses my destiny? Is it pre-ordained? Am I a part of the choosing, and if so, how and how much?
2. Is there a meaning to my life? Is life a meaningful journey?
3. What guides my prominent relationships? When I examine them, is there a pattern that I recognize? What is the meaning of that pattern?

Each group will be different; they might verbalize the questions a little differently, but the first three questions need to be around the questions of destiny and personal will.

Note: These questions are profound, and the group of course is not expected to resolve them or come to any finite answers. The goal is the exploration.

Part III: Homework. Participants are asked to do their own reading, research, meditation and pondering about the questions, and write notes. A team of three in each group is selected to present info, ideas, textual excerpts, suggested exercises and worksheets for their small group. (Small groups are usually 10 to 12 people.)

Exercise 2: Discussion. Group.

Goal: To discuss the next three “grand questions” that were chosen.

Part I: Homework. Before they present to their small groups, the team that's chosen to present can decide on the amount of times that they need to meet in order to feel ready for their presentation. Each member of the presenting team has their homework assignment so that when they come together for the team meeting, they are ready to create a cohesive presentation to the group. Each small group meets at least twice in the next two weeks. The team members present to the group, and then they open the floor for discussion. One member of the presenting team acts as the leader of the discussion, keeping the ground rules; another acts as the note taker. Someone from the presenting team writes notes about the discussion, ideas, information, etc. Exercise 2 takes places place outside of class in participants' homes or in public settings.

Exercise 3: Discussion. Group.

Goal: To discuss and explore the next three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and possible insights, and not necessarily to be right. The discussion is open-ended in nature. The coach should make sure that there is a healthy, respectful debate and sharing going on—not a clashing of wills and egos. The coach acts as the leader of the discussion in order to make sure that the ground rules are respected.

Part II: Each participant takes time to write down their intuitive, heartfelt notes about the chosen three “grand questions”—things that ring true, feel profound or right to them personally.

### Commitments for Level III:

1. Participants should read as much as possible of the suggested material.
2. Participants should make sure the meetings outside of class are organized and productive.
3. Participants should make sure the presentations are thorough (for the people that are presenting).

### Level IV:

Purpose: Participants should choose the next three “grand questions” and create the discussion groups and structure for the exploration.

Process: Participants are asked to ponder the next three “grand questions” of life that they see as important, and questions that they are wrestling with or did in the past. They should write a short entry for each, with their ideas and insights, as well as confusions, doubts, and the things you would like to clarify when it comes to each of the questions.

Exercise 1: Discussion. Group.

Goal: To choose and define the next three on the list of “grand questions.”

Part I: Group discussion about what the next three questions are. The coach strongly suggests the next three basic questions from the list, which focus on good, evil, and personal choice. The questions are:

1. Are good and evil separate forces? How do they relate? Where do they spring from?

2. Is there free will and freedom of choice for us to navigate our lives with?

3. Do I think natural order and justice prevail, or not?

Each group will be different; they might verbalize the questions a little differently, but the first three questions need to be around the nature of good and evil as well as personal choice.

Note: These questions are profound, and the group of course is not expected to resolve them or come to any finite answers. The goal is the exploration.

Part II: Homework. Participants are asked to do their own reading, research, meditation and pondering about the questions, and write notes. A team of three in each group is selected to present info, ideas, textual excerpts, suggested exercises and worksheets for their small group. (Small groups are usually 10 to 12 people.)

Exercise 2: Discussion. Group.

Goal: To discuss the next three “grand questions” that were chosen.

Part I: Homework. Before they present to their small groups, the team that's chosen to present can decide on the amount of times that they need to meet in order to feel ready for their presentation. Each member of the presenting team has their homework assignment so that when they come together for the team meeting, they are ready to create a cohesive presentation to the group. Each small group meets at least twice in the next two weeks. The team members present to the group, and then they open the floor for discussion. One member of the presenting team acts as the leader of the discussion, keeping the ground rules; another acts as the note taker. Someone from the presenting team writes notes about the discussion, ideas, information, etc. Exercise 2 takes places place outside of class, in participants' homes or in public settings.

Exercise 3: Discussion. Group.

Goal: To discuss and explore the next three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and personal insights, and not necessarily to be right. The discussion is open-ended in nature. The coach should make sure that there is a healthy, respectful debate and sharing going on—not a clashing of wills and egos. The coach acts as the leader of the discussion in order to make sure that the ground rules are respected.

Part II: Each participant takes time to write down their intuitive, heartfelt notes about the chosen three “grand questions”—things that ring true, feel profound or right to them personally.

### Commitments for Level IV:

1. Participants should read as much as possible of the suggested material.
2. Participants should make sure the meetings outside of class are organized and productive.
3. Participants should make sure the presentations are thorough (for the people that are presenting).

### Level V:

Purpose: Participants should choose the next three “grand questions” and create the discussion groups and structure for the exploration.

Process: Participants are asked to ponder the next three “grand questions” of life that they see as important, and questions that they are wrestling with or did in the past. They should write a short entry for each, with their ideas and insights, as well as confusions, doubts, and the things you would like to clarify when it comes to each of the questions.

Exercise 1: Discussion. Group.

Goal: To choose and define the next three on the list of “grand questions.”

Part II: Group discussion about what the next three questions are. The coach strongly suggests the next three basic questions from the list, which focus on death and the nature of the spirit or soul. The questions are:

1. Is there life after life? Is the soul eternal? What do I think about death and dying?

2. After we die, what happens to the energy that we are composed of?

3. What are my thoughts about psychic phenomena?

Each group will be different; they might verbalize the questions a little differently, but the first three questions need to be around the topic of death and the nature of the spirit or soul.

Note: These questions are profound, and the group of course is not expected to resolve them or come to any finite answers. The goal is the exploration.

Part III: Homework. Participants are asked to do their own reading, research, meditation and pondering about the questions, and write notes. A team of three in each group is selected to present info, ideas, textual excerpts, suggested exercises and worksheets for their small group. (Small groups are usually 10 to 12 people.)

Exercise 2: Discussion. Group.

Goal: To discuss the next three “grand questions” that were chosen.

Part I: Homework. Before they present to their small groups, the team that's chosen to present can decide on the amount of times that they need to feel ready for their presentation. Each member of the presenting team has their homework assignment so that when they come together for the team meeting, they are ready to create a cohesive presentation to the group. Each small group meets at least twice in the next two weeks. The team members present to the group, and then they open the floor for discussion. One member of the presenting team acts as the leader of the discussion, keeping the ground rules; another acts as the note taker. Someone from the presenting team writes notes about the discussion, ideas, information, etc. Exercise 2 takes places place outside of class, in participants' homes or in public settings.

Exercise 3: Discussion. Group.

Goal: To discuss and explore the next three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and personal insights, and not necessarily to be right. The discussion is open-ended in nature. The coach should make sure that there is a healthy, respectful debate and sharing going on—not a clashing of wills and egos. The coach acts as the leader of the discussion in order to make sure that the ground rules are respected.

Part II: Each participant takes time to write down their intuitive, heartfelt notes about the next three “grand questions”—things that ring true, feel profound or right to them personally.

### Commitments for Level V:

1. Participants should read as much as possible of the suggested material.
2. Participants should make sure the meetings outside of class are organized and productive.
3. Participants should make sure the presentations are thorough (for the people that are presenting).

### Level VI:

Purpose: Participants should choose the next three “grand questions” and create the discussion groups and structure for the exploration.

Process: Participants are asked to ponder the next three “grand questions” of life that they see as important, and questions that they are wrestling with or did in the past. They should write a short entry for each, with their ideas and insights, as well as confusions, doubts, and the things they would like to clarify when it comes to each of the questions.

Exercise 1: Discussion. Group.

Goal: To choose and define the next three on the list of “grand questions.”

Part I: Group discussion about what the next three questions are. The coach strongly suggests the next three basic questions from the list, which focus on art, love, and communication. The questions are:
1. What is the importance and meaning of love and friendship?
2. What is the importance and meaning of art—expression, communication, etc?
3. What is the importance and meaning of prayer, and any other communication with “The Source”?

Each group will be different; they might verbalize the questions a little differently, but the first three questions need to be around the topics of art, love, and communication.

Note: These questions are profound, and the group of course is not expected to resolve them or come to any finite answers. The goal is the exploration.

Part III: Homework. Participants are asked to do their own reading, research, meditation and pondering about the questions, and write notes. A team of three in each group is selected to present info, ideas, textual excerpts, suggested exercises and worksheets for their small group. (Small groups are usually 10 to 12 people.)

Exercise 2: Discussion. Group.

Goal: To discuss the next three “grand questions” that were chosen.

Part I: Homework. Before they present to their small groups, the team that's chosen to present can decide on the amount of times that they need to meet in order to feel ready for their presentation. Each member of the presenting team has their homework assignment so that when they come together for the team meeting, they are ready to create a cohesive presentation to the group. Each small group meets at least twice in the next two weeks. The team members present to the group, and then they open the floor for discussion. Someone from the presenting team writes notes about the discussion, ideas, information, etc. Exercise 2 takes places place outside of class, in participants' homes or in public settings.

Exercise 3: Discussion. Group.

Goal: To discuss and explore the next three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and possible insights, and not necessarily to be right. The discussion is open-ended in nature. The coach should make sure that there is a healthy, respectful debate and sharing going on—not a clashing of wills and egos. The coach acts as the leader of the discussion in order to make sure that the ground rules are respected.

Part II: Each participant takes time to write down their intuitive, heartfelt notes about the next three “grand questions”—things that ring true, feel profound or right to them personally.

### Commitments for Level VI:

1. Participants should read as much as possible of the suggested material.
2. Participants should make sure the meetings outside of class are organized and productive.
3. Participants should make sure the presentations are thorough (for the people that are presenting).

### Level VII:

Purpose: Participants should create the discussion groups and structure for the exploration. The last three questions will be of the group's choosing.

Process: Participants are asked to ponder the next three “grand questions” of life that they see as important, and questions that they are wrestling with or did in the past. They should write a short entry for each, with their ideas and insights, as well as confusions, doubts, and the things they would like to clarify when it comes to each of the questions.

Exercise 1: Discussion. Group.

Goal: To examine the next three on the list of “grand questions.”

Part I: The coach provides the next three basic questions from the list. The questions are to be determined by the group, and should include ones from the list that have not already been discussed.

Each group will be different; they might verbalize the questions a little differently, but the first three questions need to be around the nature of the universe and the laws that govern life.

Note: These questions are profound, and the group of course is not expected to resolve them or come to any finite answers. The goal is the exploration.

Part III: Homework. Participants are asked to do their own reading, research, meditation and pondering about the questions, and write notes. A team of three in each small group is selected to present info, ideas, textual excerpts, suggested exercises and worksheets for their small group. (Small groups are usually 10 to 12 people.)

Exercise 2: Discussion. Group.

Goal: To discuss the next three “grand questions” that were chosen.

Part I: Homework. Before they present to their small groups, the team that's chosen to present can decide on the amount of times that they need to feel ready for their presentation. Each member of the presenting team has their homework assignment so that when they come together for the team meeting, they are ready to create a cohesive presentation to the group. Each small group meets at least twice in the next two weeks. The team members present to the group, and then they open the floor for discussion. Someone from the presenting team writes notes about the discussion, ideas, information, etc. Exercise 2 takes places place outside of class, in participants' homes or in public settings.

Exercise 3: Discussion. Group.

Goal: To discuss and explore the next three “grand questions.”

Part I: The whole group comes together in class and the note takers from each team present a synopsis of ideas that their small group discussed. After all the note takers report (there can be between 4-6 note takers representing small groups), the floor is opened for discussion again, and this discussion includes the whole group. The coach should emphasize that what is important is to open ourselves to the questions and personal insights, and not necessarily to be right. The discussion is open-ended in nature. The coach should make sure that there is a healthy, respectful debate and sharing going on—not a clashing of wills and egos. The coach acts as the leader of the discussion in order to make sure that the ground rules are respected.

Part II: Each participant takes time to write down their intuitive, heartfelt notes about the next three “grand questions”—things that ring true, feel profound or right to them personally.

### Commitments for Level VII:

1. Participants should read as much as possible of the suggested material.
2. Participants should make sure the meetings outside of class are organized and productive.
3. Participants should make sure the presentations are thorough (for the people that are presenting).

### Gates of Power Workshops

The Gates of Power curriculum is framed by workshops. There are four stages in the Gates of Power curriculum: 1.) Beginners, 2.) Intermediate, 3.) Advanced, and 4.) Leadership. At the beginning of each stage and in the middle of each stage, participants attend a weekend workshop that relates to the material covered. The workshops are as follows:

1. Introduction to Gates of Power (Introductory)

2. Study of the Self (Mid-Level Beginners)

3. Who Am I and Why Am I Here? (Beginners when graduating to Intermediate)

4. Cycles of Renewal (Mid-Level Intermediate)

5. Pathways to the Heart (Intermediate when graduating to Advanced)

6. Ways of Celebration (Mid-Level Advanced)

7. The Power of Intimate Relating (Advanced when graduating to Leadership)

8. Authoring Your Life/The Leader Within (Mid-Level Leadership)

9. Life As a Contribution (Leadership end project)

The first workshop is Introduction to Gates of Power, and it occurs at the very beginning of the Gates of Power curriculum. It includes introductions, exercises from the first Levels of each Gate, as well as an intro of the Three Aspects of the Self. The specific exercises for this workshop relate to the material already written and covered in the written descriptions of the Gates of Power processes and exercises.

The Introduction is a three-day weekend workshop; on the first day, participants get information about each of the seven Gates, the Gates of Power Method, and its principles and ideas—the workshop is designed as a general overview to the method. Also, on the first day, participants are introduced to the idea of the three Aspects of the Self—the Emotional Self, the Defensive Self, and the Expanded Self. This is taught as a lecture/discussion and question/answer session.

The second day, the workshop will cover the Gate of the Body, the Gate of Emotions, and the Gate of Dialogue. Exercises from the Gate of Silence are woven throughout the workshop.

On the third day, the workshop will cover the Gate of Creative Expression, the Gate of Life Path, and the Gate of Knowledge.

### Stage I: Beginners.

General theme: the Inner Self Levels 2 and 3 of each one of the seven Gates are covered in this stage.
Mid-Stage Workshop: “The Study of the Self.” (Two-day weekend workshop)
Goal of the Workshop: In-depth study of the three Aspects of the Self, their relationships to each other, and the possibilities of healing and unifying the Self.
Homework Preparation for the Workshop:
I. Homework Thinking Assignment (please take notes):
1. Take a look and define an area in your life where you are acting from lack of power. Write down your feelings and behaviors. If you know the roots of why you are experiencing this lack of power in this area of your life, think about this as well.
2. What do you need to shift, let go of, give up, release, forgive, claim, or allow in order to create a sense of power in this area.
3. Why and how are you resisting transforming that area of your life?
II. Homework Writing assignment (use this assignment creatively by writing a poem or story, etc.):
1. In this area of your life, how do you envision yourself being powerful? Describe in detail the feeling, behaviors and expression you have as a powerful person in this area.
III. Homework Bringing Assignment:
   Choose 5 elements that you see in your vision of power and bring representations of those elements (Bring these items in paper. Examples: print it out from the internet, draw a picture, take a photograph, or cut the example out from a magazine).
   In addition, participants should bring their favorite music for fun, healthy snacks for a Saturday night party, journals and writing implements, musical instruments if they would like to play, walking shoes, and several layers of seasonal, comfortable clothes.
IV. Workshop Structure
Day 1:
   Just like all workshops, there is an intro and welcome that includes the workshop guidelines. 1.) The coach welcomes everyone and speaks about the nature of the workshop. 2.) The participants take a couple minutes to say something about themselves, and 3.) The following guidelines are covered.
1. All participants are asked to be on time all the time.
2. Participants are asked to fully participate in each of the exercises. If they have any problem, they should talk to the coach or the assistants and figure out a way to still participate. Full participation in the workshop is a must.
3. Participants are asked to take every process and exercise to the limit, to go beyond their comfort zone. Expanding and finding the courage to go into frightening places is the point.
4. All participants promise absolute confidentiality about everything in the workshop, even when sharing the workshop experience with loved ones. If they need to speak about someone's experience, they should never mention names or details.
5. All participants must be honest with what they share as well as extremely supportive of themselves and others. The workshops are difficult emotionally and spiritually, and every participant can use the support of the group.
6. All participants must stay focused—no chitchat when it's not necessary.
7. It is advised to not eat heavily while doing a workshop. Participants should drink as much water as possible, wear comfortable clothes, and bring journals and pens.
Section A should take 30 minutes.
   Silent meditation. (The Gate of Silence)
   1. Bring to your mind the area of your life you chose to work with.
   2. Feel the most dominant feelings, give them names. See visual images connected to these feelings. Where in your body do you feel them how long have you had these feelings? Do you know how, why, and when they started?
Section B should take 1 hour and 30 minutes.
   Sharing. (The Gate of Dialogue)
      Each participant should share:
   1. The area in their life in which they don't feel a sense of power.
   2. How and why are they maintaining it? Pay off, cost.
   3. The roots.
   4. What do they need to let go of, to achieve a sense of power?
   5. Why are they resisting it?
   6. Share the writings.
Section C should take 30 minutes
   Writing followed by sharing. (The Gate of Creative Expression)
      Participants write about this question: What am I most afraid of? Each participant should write in the direct voice of their most vulnerable frightened inner feeling.
      Participants share a short paragraph from the writing.
Section D should take 30 minutes.
   Sharing in couples. (The Gate of Creative Expression and Dialogue)
      Exercise in couples. Express to your partner the deep need and fear you have discovered in section C, in the first person. Both partners take turns; the listening partner should just listen with an open heart and offer no comments at this time.
(Lunch Break)
Section E should take 30 minutes.
   Writing. (The Gate of Creative Expression and Dialogue)
      My Powerful self. Write in the voice of your inner parent-Expanded Self. Address the area of fear in the Emotional Self from compassion, acceptance and support; do not teach, preach, or fix.
Section F should take 30 minutes.
   Emotional release process, laying down. (The Gate of Emotions)
      Going into the Room of Fear. A process on the floor. Guided by the coach. The goal is to access and release the fear and connect to the roots of its memories, physical sensations, and emotions.
Section G should take 2 hours.
   “Healing Fear”—a process in couples. (Gate of Emotions and Dialogue)
      Each participant will be both once: the fear emotion within the Emotional Self, and the second time the Expanded Self. In two different times each of the couples will work in front of the group. The goal is for the one being the Expanded Self, to help the one being the Emotional Self feel secure. The Expanded Self should use the question, “what is it that you need?” The question will be repeated a few times. As the Expanded Self, the participant needs to help the Emotional Self come to a place of peace. There should be a building of dialogue between them.
   Note to coach: Be aware of the fact that fear might express itself in a very mute way and the participants might be frozen or almost unable to respond. The coach should encourage the participants that are working in such a way that they find a voice for their fear.
Section H should take 30 minutes
   Sharing and meditation. (The Gate of Dialogue and Silence)
      The participants share their experiences from the previous exercise. After, they lay down to meditation with the goal to integrate what happened in section C. The coach guides them after a short relaxation to let all that happened since in, and to open a place of acceptance and allow time for reflection.
Day 2:
Section A should take 30 minutes.
   Sharing. (The Gate of Dialogue)
      The discussion should be guided with this question: How you are doing thus far?
Section B should take 30 minutes.
   Movement and sound meditation. (The Gate of Silence and Body)
      Participants should choose the strongest feeling and move from it with sounds. Each participant will share the movement and sound that they have created with the rest of the group.
Section C should take 30 minutes.
   Sitting down meditation. (The Gate of Emotions)
      There is a short discussion before the exercise in which each participant defines three things that they need to let go of and three things that they want to receive or become. The exercise is a process sitting down, feeling into what participants need to let go of, the sadness and the resistance that accompanies that.
Section D should take 1 hour.
   “The Courage to Let Go”—sharing in couples. (The Gate of Emotion, the Gate of Dialogue)
   1. Participants should share with their partners what they are willing to let go of, and what they are willing to become.
   2. As couples in front of the group, one participant is the Expanded Self, the other is the fear part of the Emotional Self. Participants should declare from the fear of their Emotional Self the 3 or 4 things they are willing to let go of. The partner who is the Expanded Self will declare the 3 or 4 things they are willing to become.
   Note to coach: There may be some disagreement between the Expanded Self and the fear aspect of the Emotional Self; this should be allowed because it supports dialogue. The exercise might need to repeat several times before authentic declarations can be achieved, and the coach might need to guide participants.
Section E should take 1 hour.
   Writing and sharing. (The Gate of Creative Expression)
   1. Participants write down their “Declaration of Independence,” which includes their vision, their commitment and gifts to themselves, and their ownership of their power and responsibility to life.
   2. Participants read the vision of power to the group. See homework for workshop.
   3. Each participant will make a round of relating to all the others, one at a time from their place of strength and independence. The section will end with a few silent moments sitting back to back.
(Lunch Break)
Section F should take 30 minutes.
   Sharing. (The Gate of Creative Expression)
      Each person will use their Declarations and speak them out loud in front of the group.
Section G should take 30 minutes.
   Sharing. (The Gate of Dialogue)
      Participants share the elements of their vision of power and add commitments they are making and gifts to themselves.
Section H should take 1 hour.
   Creative exercise. (The Gate of Creative Expression, the Gate of Life Path)
      Participants creating their vision board and share it with others.
Section I should take 30 minutes.
   (Combination of Most Gates.)
   Celebration of Power and the closing circle at 5:00 pm.
End of Stage I Workshop: In the Quiet: Who Am I and Why Am I Here? (Two and a half day weekend workshop.)
Goal of the workshop: To understand one's essence and one's life purpose.
I. Homework Thinking Assignment (please take notes):
   Participants are asked to think about the following questions:
   1. Why am I here?
   2. What do I want to give, receive, learn, and create?
   3. What are the ways I maintain my own suffering?
   4. How do I stop myself from loving and receiving love?
II. Homework Writing Assignment:
   The subject of the assignment is “Who Am I? The Different Aspects of Myself.” Use this assignment creatively and reflectively. Participants should write in the first person as if speaking directly from that place:
   1. My Emotional Self—a hidden world of vulnerabilities, desires, needs, hopes, pain, fear, anger, despair, etc.
   2. My Defensive Self/My Strong Suit—the way I conduct myself in the world in order to feel safe and accepted, and how I have to control, repress, and manage my Emotional Self for that purpose.
   3. My Expanded Self—the voice and vision of my highest potential. A place of freedom, wholeness, expression, and creativity.
III. Bringing Assignment:
   Participants are asked to bring a symbol of each one of their commitments:
1. What they are committed to create.
2. What they are committed to give.
3. What they are committed to receive.
4. What they are committed to learn.
   In addition, participants should bring their favorite music for fun, healthy snacks for a Saturday night party, journals and writing implements, musical instruments if they would like to play, walking shoes, and several layers of seasonal, comfortable clothes.
IV. Workshop Structure:
Day 1 (Friday afternoon 6:30-10:30):
   Introduction: Just like all workshops, there is an intro and welcome that includes the workshop guidelines. 1.) The coach welcomes everyone and speaks about the nature of the workshop. 2.) The participants take a couple minutes to say something about themselves, and 3.) The following guidelines are covered.
1. All participants are asked to be on time all the time.
2. Participants are asked to fully participate in each of the exercises. If they have any problem, they should talk to the coach or the assistants and figure out a way to still participate. Full participation in the workshop is a must.
3. Participants are asked to take every process and exercise to the limit, to go beyond their comfort zone. Expanding and finding the courage to go into frightening places is the point.
4. All participants promise absolute confidentiality about everything in the workshop, even when sharing the workshop experience with loved ones. If they need to speak about someone's experience, they should never mention names or details.
5. All participants must be honest with what they share as well as extremely supportive of themselves and others. The workshops are difficult emotionally and spiritually, and every participant can use the support of the group.
6. All participants must stay focused—no chitchat when it's not necessary.
7. It is advised to not eat heavily while doing a workshop. Participants should drink as much water as possible, wear comfortable clothes, and bring journals and pens.
   All the guidelines are covered in the intro of each workshop.
Section A should take 15 minutes.
   Silent sitting meditation. (Gate of Silence)
      All participants are coming into their breath and into the witnessing of their bodies, minds, and emotions. This is a focusing, centering meditation.
Section B should take 30 minutes.
   Sharing. (Gate of Dialogue)
      In the first round, participants introduce themselves through each one of their aspects—for example, the coach asks all Emotional Selves to introduce themselves, and participants will say “I am ______,” and something about who they are from the point of view of their Emotional Selves. Once everyone goes around and speaks from this perspective, the coach will ask everyone to speak from their Defensive Selves, and go through the same process: “I am ______, and I am here to . . . ” and introduce their purpose, mission, desire, etc. And the same with the Expanded Self. In the second round, the coach will ask all Emotional Selves to introduce themselves by using one word and one gesture. Then the group will repeat the process with all Defensive and Expanded Selves.
Section C should take 30-45 minutes.
   Couples. (Gate of Silence, Gate of Emotions, Gate of Dialogue)
      Two partners sit facing each other. The coach asks first to look at the other through the eyes of the Defensive Self participants should be noting all feelings, sensations, attitudes, thoughts, criticisms and comments that come up when they look at another person through the eyes of their Defensive Self. They should also note how their bodies are reacting and what the perception of the other is from the point of view of the Defensive Self. This is a silent, observational process. After about five minutes, the coach asks them to take a deep breath and stretch and then to go on to the Emotional Self. Participants should observe their partners from this point of view, noting how they experience the other person and how they feel physically and emotionally, as well as how they relate. After five or six minutes, they should move on to the Expanded Self. Participants should note how they relate to and perceive the other through the eyes of the Expanded Self. Once all rounds are completed, participants have five or six minutes to stretch and move around. There is no speaking in this part of the exercise.
      The second part of the exercise is to write down the observations about the different ways they were experiencing the other person and feeling and responding to them.
      The third part is sharing with the whole group their important observations.
Section D should take 45 minutes to an hour.
   Meditation laying down. (Gate of Silence, Gate of Emotions, Gate of Creative Expression)
      The exercise begins with a meditation in which the participant will be visiting their life through the perspectives of the three aspects of the self. Laying down, they are guided through a short relaxation by the coach. After that, they are asked to review all important points in their life through the eyes of the Defensive Self. The coach will guide them through parts of their life, each part about seven years in length, and they will be given some time to think about that period from the perspective of their Defensive Self. They should note how they feel in their body and breath, as well as the thoughts and feelings that relate to the events, the people and experiences in their life when observing them through the eyes of the Defensive Self. They will be given five to ten minutes before they move on to the second round, which is observing their life through the Emotional Self. Again, the coach divides the participants' lives into sections of seven years, and participants get some time to reflect on each section through the eyes of their Emotional Self. When they're done with this perspective, the participants move on to the Expanded Self. After the meditation, they are given a few minutes to return to a normal state. The meditation could take 25 minutes.
      The second part is writing. Participants will journal under the title “The Effects of my Defensive Self on my life.” They should write specific events and experiences that they know were deeply affected by their Defensive Self Second, they should journal under the title “The Effects of my Emotional Self on my life,” and following that, “the Effects of my Expanded Self on my life.” This writing part could take 25 minutes.
      The third part is sharing in couples their writing and experiences from the meditation.
Section E should take 10 to 15 minutes.
   Closing circle of the evening, with free time to share whatever participants feel they want to share. If there are any musicians in the group that want to play something soft and meditative, they're invited to do so; otherwise some music will be played and people will have about ten to fifteen minutes to be there, be silent, move, or share, depending on the mood of the group. In the last moment, the coach will ask them to be ready for the next day and give them instructions about when it starts and what they need to bring. The next morning will start at 10 AM and participants will need to bring their journals and pens.
Day 2 starts at LOAM on Saturday and goes until 5:30 PM.
Section A should take about 20 minutes.
   Movement. (Gate of the Body, Gate of Creative Expression, Gate of Silence)
      The coach will put on 3 different pieces of music, one for each aspect of the self, and participants will move to explore physically and expressively how each part feels and moves and expresses itself. This exercise is to reconnect the energies and wake the body.
Section B should take 30 minutes.
   Sitting down meditation. (Gate of Silence, Gate of Emotions)
      After a short relaxation, the coach leads participant to examine the important stations of their life: how they felt in each one of them, and what is important in that specific station. Who were the people connected? What were the feelings and experiences associated with the experiences? For instance, if someone feels that their first school day was important because of something wonderful or traumatic, they should meditate on that moment and its importance. They should define for themselves between 5-7 very important stations of life that were defining moments. The coach will guide them through chunks of their life, in order to give them time to search for the stations. At the end of the meditation, participants take a few minutes to stretch and come back to a normal state.
Section C should take 45 minutes. (Gate of Silence, Gate of Emotions, Gate of Dialogue)
   Writing exercise. With the background of the previous meditation, participants should complete these sentences (they should write as much as they want):
1. I lived my life believing that ______.
2. I maintained my suffering by ______.
3. I stopped myself from being ______.
4. I betrayed myself by ______.
5. I caused pain to myself and others by ______.
6. I have conquered my fears and my limitations by ______.
7. I have supported my true passions and goals by ______.
8. I have brought much happiness and love to myself and others by ______.
9. I have expressed and ventured into new things by ______.
10. I have understood myself and life by ______.
After writing, the participants will share parts of their writing with the group.
Short break of 10 minutes, with something to drink and a light snack. This is because the next section is quite long, and lunch will be served later because of it.
Section D should take 2-3 hours.
“Walk through the Important Stations of my Life.” (Gate of Emotions, Gate of Dialogue)
   This section is long because each participant will do this in front of their small groups. Participants are asked to choose the 5-7 important stations of their lives, and 5-7 people from their small group to sit for them in the stations. The exercise is organized as follows:
5-7 pillows are put on the floor in a long line with the very early stations at the top of the line and the latest station being at the end. There is some space between the pillows, and there should be two empty pillows for future stations. The active participant is doing it from their Expanded Self. They start from the very young station, and the 5-7 people on the pillows are acting as the different parts of the active participant's self, in the age groups that the participant chose them to represent. The active participant starts from the first station; they take a minute to stand behind the first pillow and reflect on what was happening for them at that moment in their lives, and what difficulties or wonderful events they experienced. As their Expanded Self, the active participant lightly touches the head of the person sitting on the pillow and acknowledges out loud their feelings, relationship, and experience, and then gives them supportive, loving, compassionate, forgiving guidance, so the part of their self in that station of their life can feel confident and understood. After the acknowledgement and transformation in that station, the active participant moves on to the next stations, continuing to address themselves from the Expanded Self. By doing so they have an opportunity to heal, complete, and support themselves and past events. The active participant should include the two future stations in which they speak from their visions and goals.
Section E should take 15-25 minutes.
   Meditation to integrate everything that happened in the previous section. (Gate of Silence)
Lunch Break.
Section F should take one hour.
   Choosing Your Name (Gate of Silence and Gate of Creative Expression)
      This section is a one hour walk in solitude. Participants should meditate on the following questions: who is it that I choose to be? Who is it I feel I truly am? What am I ready to release that is not me any longer? What is the life that I am committed to create? Participants are also asked to choose a new name for themselves; there are many cultures where people choose names for themselves that are different from their given names. The name symbolizes their potential, essence, or a very strong quality or attribute that is visible to the community and for which they are honored. Participants are to meditate on the name that will reflect their potential and their contribution. They are also looking for a staff—a piece of wood strong and solid enough to be used as a walking staff. It will symbolize the inner help on their life journey.
Section G should take 30 minutes.
   Nature Walk (Gate of Emotions, Gate of Dialogue)
      This section is done in nature; it is a release walk. All participants walk in a group, but are split up into couples with a little bit of distance in between. Partners should first gather between 7-10 small stones. As they walk, they take turns choosing things that they're willing at this point to release. They share with their partners the story of the experience and about how and why they're willing to let it go; the other partner actively listens. They then switch, and the other partner does the same thing. The whole group stops and casts one stone into the nearby water, to symbolize letting go of the first experience. The couples repeat the process until all the stones are released into the water.
Section H should take 1 hour.
   Naming Ritual (Gate of Life Path, Gate of Dialogue)
      This section is a ritual for claiming the new name in front of the group. One by one, participants stand before the group, and the group asks, as a group, “What is your name? Who are you?” The participant in front of the group answers with their new name, a few words about their name, its meaning and significance, etc, and then they connect it to who they are. The group asks “Why are you here?” (This means the purpose of their life, not why they are in the workshop.) The participants respond. Then the group asks “Where are you going?” meaning what is the future the participant is planning for themselves. After these three questions, there is a circle of affirmations; each group member calls the active participant by their new name, and say “You have given me ______,” naming something they feel they've learned or that they were moved or inspired by in that participant. Then they say “I give you ______,” a spiritual gift. After the name ritual, there is a few minutes of silent meditation, eyes closed. The coach speaks about the day, acknowledging the participants for their work, and explains about the party that night.
Day 3 starts at LOAM on Sunday and goes until 5 PM.
   Section A should take 30 minutes.
   Movement exercise. (Gate of the Body and Gate of Creative Expression).
      The movement exercise includes two movement games, one is called “I am All Things,” and the other one is “The Picture Game.” In “I am All Things,” the coach prepares beforehand a list of things—a combination of foods, elements in nature, mystic figures, famous characters from children's stories or movies, etc. The list should include at least 10-15 things. The whole group moves together as the coach names the things on the list. The coach gives the participants a few minutes to experience “being” each one of the various elements on the list. It would be helpful if the coach organizes the list in such a way that the elements move smoothly from one to another—for example, if the first thing on the list is “Sunflower field on a sunny day,” then the whole group becomes their own interpretation of sunflowers on a sunny day. Each participant brings their own expression into the mix. A sense of play, fun, and silliness has to be a part of this. Then the coach can say “now, a big typhoon sweeps the field,” and everyone becomes that; the coach continues “everything calms down, and there's a stream of water now making its way through,” etc.
      The second game is “The Picture Game,” in which one person comes to the middle of the room and starts a picture by conveying it with his/her body and with sounds—for instance, the first person can choose to be a man brushing his teeth. Then, one by one, spontaneously, people add themselves to the picture—one decides to be the dog, one the wife, one the wastebasket, etc. At some point, the coach says “Freeze,” and the picture freezes.
Section B should take 2 hours
   Creative project (Gate of Creative Expression).
      This section consists of making the “Journey Staff” from the stick that participants were asked to find in their walks. There will be arts and crafts supplies provided; participants will also have their own materials from the Homework of this workshop. The idea is to create the most beautiful staff they can create, by painting, gluing, hanging things on it, wrapping it with fabric, etc. When the staffs are finished, they are put in the center, in a circle, and the group walks around to see all the staffs and share impressions, responses, comments, etc.
Section C should take 30 minutes.
   “Cleaning the Inner Slate”—meditation (Gate of Silence).
   Like all meditations, this one starts with 10-15 minutes of relaxation. After that, the coach starts sentences and participants should allow their personal truth to come up to internally complete the sentence. For example, the coach might say “I am,” and the response someone might come up with is “a creative, joyous, loving being.” The point is to figure out who the participants instinctively sense themselves to be. The coach gives participants a minute or two for each of the sentences. The sentences are as follows:
      1. I am ______.
      2. I am here to ______.
      3. I forgive myself for ______.
      4. I forgive for ______.
      5. I acknowledge myself for ______.
      6. I acknowledge for ______.
      7. I am grateful for ______.
      8. I am creating a life of ______.
         Then, the participants get a few minutes to return to a normal state, and another few minutes to write in their journals about the meditation.
Lunch Break
Section D should take one hour.
   Solitude Walk (Gate of Silence).
      In their solitude walk, participants should meditate on and write about what they perceive to be their inner power, gifts, and abilities, and how they believe they are contributing and giving to themselves and others.
Section E should take an hour and a half to two hours.
   “Initiation into the Path” (Gate of Emotions and Gate of Dialogue).
      Each participant chooses two people to help them in the ritual. They get together with their two helpers and prepare the roles of the three aspects of the self, and, for ten to fifteen minutes, they discuss and organize. One will stand behind them as their Expanded Self, and the other will stand in front of them as their Defensive Self. The active participant portrays their Emotional Self. The Expanded Self holds the active participant's staff in their hand. In some cases, the Defensive Self stands a little to the side, since it's possible they're taller than the active participant. The active participant starts by saying “I have lived my life” and continues by describing the way they have lived their life, from their Emotional Self, especially addressing the painful, unsupportive ways that they have lived their life—ways that they are clearly willing and ready to release and give up. Participants should speak from the heart, and they should allow themselves to be emotional about it. They should be honest and heartfelt when they admit these things to themselves and the group, and it's alright if they get emotional. When the Emotional Self is done, the partner who is acting as the Defensive Self speaks, saying “I lived my life trying to” and then fills in the story from the Defensive Self's point of view. After this, the active participant says “I no longer wish to live” and fills in the blank with their appropriate answer. Then, they say “I long to connect to the source of power within me, and” fill in the blank. Then, the Defensive Self speaks, saying “I am afraid of letting go of” and fills in the blank. At this point, the helper standing for the Expanded Self speaks, saying “I have been here all along. I am here to help us live the life that we deserve, that we envision.” This sentence, like all the others, is open-ended—the Expanded Self can add anything. At this point, the Expanded Self takes the hand of the Emotional Self, letting the Emotional Self hold the staff, and invites the Defensive Self also to hold the staff. Once they're all three holding the staff, the active participant is free to express as the Emotional Self whatever comes up for them.
Section F should take 30 minutes.
   Closing circle (Gate of Dialogue)
      This section is immediately after Section E, and consists of a closing circle for participants to share their experiences. This closing circle ends the workshop.
At the end of this workshop, participants move to Stage 2, the Intermediate stage.

### Stage II: Intermediate.

General theme: The Self and the World; the ability to renew the Self and the ability to relate to the world. This stage covers Level 3 and some of Level 4 of each of the Gates.

Mid-Stage Workshop: Cycles of Renewal (Three-day weekend workshop)
Note to coach: Human beings are a part of nature and thus we are endowed with the same ability to renew. Our bodies are constantly renewing themselves—dead cells are shedding, and new ones are created. If we look around at nature, the seasons show us the power of renewal in nature. Unfortunately our tendency, because of fear, psychological blockages, and trauma, is to get stuck and cripple our natural ability for renewal.

Goals:
1. To investigate why, where, and how we sabotage, block, or avoid our natural cycles of renewal.
2. To cultivate the ability to complete natural cycles and renew emotionally, spiritually, and physically.
Homework Preparation for the Workshop:
I. Homework Thinking Assignment (please write notes):
1. Theme: Look into yourself and your life, at the present moment, and consider the following:
   What are the four (4) things that you need to shed to allow the next stage of your evolution.
   What are the four (4) things you are willing to cultivate to facilitate the next stage of your evolution.
   What within you is stopping you from fully moving into your next cycle of renewal? Consider fears, self doubt, unfinished business, incompletes, etc.
      Exercise: Draft notes in a personal journal about this self-reflection. Please bring your journal to the workshop. You will not be asked to share your journal to the group.
II. Homework Writing assignment (use this assignment creatively by writing a poem or story, etc.):
1. Theme: Cycles that I observe in nature, in my body and in my life.
   Exercise: Meditate on and write about experiences which describe the cycles of nature, your body and your life. Identify and describe past cycles in your life, endings and beginnings, as well as the present moment cycle.
   Use this opportunity as a creative writing exercise to find an original way to express your ideas and feelings. Please choose your own format, i.e., poetry, prose, short story, stream of consciousness, or anything that resonates with you. At the workshop, you will select excerpts from your composition to be read aloud to the group.
III. Homework Bringing Assignment:
   Theme: Images of your self-reflections.
   Exercise: Collect or draw an image that represents each of the eight things identified in the self-reflection exercise. You can use any source you wish, for example, images from magazines, pictures, etc. You should have eight separate images.
IV. Workshop Structure
Day 1 (6:30 PM to 10:30 PM):
   Introduction. Just like all workshops, there is an intro and welcome that includes the workshop guidelines. 1.) The coach welcomes everyone and speaks about the nature of the workshop. 2.) The participants take a couple minutes to say something about themselves, and 3.) The following guidelines are covered.
1. All participants are asked to be on time all the time.
2. Participants are asked to fully participate in each of the exercises. If they have any problem, they should talk to the coach or the assistants and figure out a way to still participate. Full participation in the workshop is a must.
3. Participants are asked to take every process and exercise to the limit, to go beyond their comfort zone. Expanding and finding the courage to go into frightening places is the point.
4. All participants promise absolute confidentiality about everything in the workshop, even when sharing the workshop experience with loved ones. If they need to speak about someone's experience, they should never mention names or details.
5. All participants must be honest with what they share as well as extremely supportive of themselves and others. The workshops are difficult emotionally and spiritually, and every participant can use the support of the group.
6. All participants must stay focused—no chitchat when it's not necessary.
7. It is advised to not eat heavily while doing a workshop. Participants should drink as much water as possible, wear comfortable clothes, and bring journals and pens.
Section A should take 30 minutes.
“Witnessing Contribution”—sitting meditation (Gate of Silence, Gate of Creative Expression).
   Just like all meditations, this section starts with about 10 minutes of relaxation, quieting the mind, and coming into the breath. The exercise is about observing when and how we stop the natural cycles. The coach guides participants by explaining each section and giving them some time for each part.
1. Breath—Participants are asked to begin to observe when they stop their breath and why. Whenever they do, they are asked to say out loud “Stop” as a way of acknowledging that they have just stopped their breath.
2. Body—Participants scan their bodies and name out loud the contracted places—the parts of the body that are to some degree frozen.
3. Feelings—Participants name contracted emotions—anxiety, resistance, shame, fear, etc.
4. Thoughts—Participants name contracted thoughts—“I don't feel I belong,” “I haven't done my homework,” etc.
Section B should take 30-40 minutes.
   Writing and sharing (Gate of Silence, Gate of Dialogue)
      Participants are asked to share their observations from the previous exercise—how are they stopping, what are they holding onto, and why.
      Participants are asked to share what the next cycle of renewal is for them and whether they are creating stagnation in the process of the next cycle.
      Participants are asked to share excerpts of their writings as well as two images of each category from the homework bringing exercise.
Section C should take 30 minutes.
   Discussion (Gate of Dialogue)
      Cycles in our life and in nature. What is the importance and necessity of cycles? Why are we as human beings not able to follow those cycles with the ease that we find in nature? What are the consequences to us as a result of not being able to complete cycles of renewal?
      Note to the coach: the primal fear of death as well as fear of rejection, humiliation, and abandonment need to be covered in the discussion as sources for crippling our cycles.
Section D should take 30-45 minutes (coach judges).
   “Six-Layer Body Scan”—a visualization (Gate of Silence, Gate of the Body, and Gate of Emotions)
      Laying-down meditation/visualization and Six-Layer Body Scan. Part I: After the first ten minutes of initial relaxation, the coach guides participants to enter a place in their bodies that they feel is holding terror and fear. Once they identify this place in their bodies, the coach guides participants through the Six-Layer Body Scan. (The Scan is outlined in the Gate of the Body section in the Gates of Power Overview.)
      Part II: Once this part is covered, the coach guides the participants to enter the world of that place and experience the emotion of terror as well as possibly remember an incident that the terror is connected to—a terrifying experience that is still very emotionally charged even though participants might not be aware of its effects in daily living. The coach will give participants some time to experience; the coach should also encourage emotional expressions (shaking, crying, vocalizing, etc).
      Note to the coach: The coach has to be very sensitive as to how they encourage expression and walk around if someone needs to be touched or addressed, because this is a very difficult experience for most people. The coach should also pace it correctly as to when they move from one section to another and when the group has gone through a wave of expression and can move to the next part.
      Part III; Now that the participants have allowed themselves to experience this emotionally, the coach presents the question “What do you need in order to be able to relax, feel more emotionally secure, and be able to move away from the grip of the terror?” The group is given time to feel into the question and the answer. Then, the participants get some time to return to the normal state.
Section E should take 30 minutes.
   Writing and sharing in couples (Gate of Silence, Gate of Dialogue)
      Part I: Participants write about their experiences in the previous exercise.
      Part II: Participants share their experiences in couples.
Section F should take 20 minutes.
   Closing circle (Gate of Silence).
      The group sits back to back, synchronizing their breaths and watching to see if the breath is freer. The coach explains about the next day.
Day 2 (from 10:00 AM to 5:30 PM):
Section A should take 20-25 minutes.
   “Rivers and Rocks”—a moving meditation (Gate of Silence, Gate of Creative Expression)
      The participants get 10 minutes for personal warm-up. The coach presents the idea/image of rivers and rocks, which symbolize expansion/flow and hardness/contraction. The group is moving, exploring those two ideas, while the coach keeps shifting between the two, calling “Rivers” and “Rocks”, shifting first slowly and then rapidly between the two so that energetically, participants can really experience the difference between flow and hardness as well as explore relationships between themselves moving and others—how do they experience the space and others from each one of the images' perspectives?
Section B should take 30 minutes.
   “Fear: the Great Paralyzer”—emotional meditation (Gate of Emotions, Gate of Silence).
      This laying-down exercise starts in a short meditation and relaxation, and then moves again to the emotional place of great fear—a place the participants have visited the night before in the visualization. The coach gives participants a little time to return to the emotional place and tap into the feelings; when the coach sees that the group is immersed in that space, they present the question “How is this place of fear/terror affecting your life—especially your ability to move forward in your renewal cycles? More specifically your next cycle or the next place you want to experience?” Time is given for the processing of the question and the answer.
      After, there are a few minutes to return to the present with a couple minutes of silence; then, there is a silent break of a light snack and water.
Section C should take 2-2.5 hours.
   “Loosening the Grip of Fear”—experiential expressive exercise (Gate of Dialogue and Gate of Emotions)
      Each participant chooses two other helpers; the active participants are located in the middle, with everyone else in the group around them. One of the helpers is holding the active participant's feet, representing the terror. The other helper represents the active participant's desire for freedom and is the “encourager”. The two helpers need to be very attuned to the process of the active participant. The goal of the process is to re-enact the conflict between the terror and the desire for freedom, and the emotional tug-of-war between those two forces. The encourager needs to do everything that they can to help the active participant fight their terror and win. A note of caution for the person holding the feet: there might be a physical struggle; this helper should use their judgment in terms of keeping the active participant down as much as possible without hurting them. The coach must make sure that each participant has gone through the process successfully and feels a sense of liberation. The process is then repeated for each participant.
Section D should take 20 minutes.
   Sitting down meditation and visualization (Gate of Silence).
      The objective is to experience a sense of freedom and possibility. The coach guides participants to imagine their lives from a place of freedom, ability to express, and a sense of possibility: images, sensations in the body, relationships, etc.
Lunch Break.
Section E should take 1 hour.
   Solitude walk and writing (Gate of Silence)
      This section is a one-hour solitude walk and writing about their experiences in the morning.
      Participants are also to find four things in nature that correlate to or symbolize the four things they have brought with them that they're willing to shed, and four things they are willing to embrace. They come up with a sentence for each one of the eight things
Section F should take 30 minutes.
   Sharing and discussion (Gate of Dialogue).
      Participants share the images, the nature elements, and the sentences with their small groups. Then the participants have a discussion about shedding—what sheds in nature? Why do things shed layers? Etc.
Section G should take about 2 hours.
   “Shedding Skin”—art project (Gate of Creative Expression).
      Participants receive a roll of paper—enough to cover the body. Using the elements they brought as well as the elements from nature and the sentences that they came up with, participants create their “Shedding Skins”, organizing them (one half the shedding images and one half the renewal) half-and-half lengthwise or width-wise, back-and-forth on the paper, or one side of the brown paper with sheddings and one side with renewals. The skins should be a representation of the shedding and renewal cycle.
Section H should take 30 minutes.
   Viewing and sharing (Gate of Dialogue).
      Participants hang their “skins” on the wall and move from one to another, sharing their impressions, responses, and comments.
Section I should take 20 minutes.
   Closing circle. Participants sit back to back, eyes closed in silence, allowing everything that happened to integrate and sink in.
Dinner Break—5:30 PM-6 PM
Party—8 PM-10:30 or 11 PM
   The party includes music, discussion, etc.
Day 3: 10 AM-5 PM
Section A should take 30 minutes.
   “Clearing Fire”—Movement (Gate of Creative Expression).
      If it's nice outside and there is a place, this Section should be done outside, but it can be done inside too. The exercise takes place around an imaginary fire; in the first round, participants release into the fire one by one and spontaneously (with gestures, sounds, and words) anything that they feel they're ready to cast into the fire. In the next round, participants draw from the fire whatever it is that they want to take from it. The fire symbolizes an internal fire of destruction and renewal.
   Note: This is a fun, playful exercise, not somber and serious.
Section B should take about 2-2.5 hours.
   “Walk to the Clearing” (Gate of Emotions, gate of the Body, Gate of Creative Expression, Gate of Silence)
      Part I: Explanation about the exercise. This exercise is done as a long walk in nature; each participant actually walks separately with about 12-14 feet between each other. The exercise is called the Walk to the Clearing because it is an opportunity to clear out whatever was not cleared during the workshop. Any unfinished business, negative emotions, regrets, sadness, etc—anything that the participants feel they want to shake off. It's recommended that participants talk out loud or do whatever they want to do to release any kind of residue, so that when the group gets to “the clearing,” participants feel much lighter, like they really have gotten clear of a lot of things.
      Part II: The walk.
      Part III: When the group gets to the clearing, there are 15 minutes of solitude. Each person finds a corner in nature to sit there and feel what has happened for them.
      Part IV: The group comes together and collects leaves.
      Part V: The walk back. This is an easygoing, lighthearted walk: jokes and songs and talking are allowed.
      Part VI: Sharing in the workshop room about the process and its effects.
      Part VII: Creating the “Clearing Bed”—this means that the group puts two or three blankets onto the floor for people to lie on, and sprinkling leaves around it, creating little pillow. Candles and incense are lit around the room.
Lunch Break.
Section C should take 1 hour.
   Solitude: participants do whatever they want to do.
Section D should take 2.5 hours.
   Energy-clearing work (Gate of Silence, Gate of the Body, Gate of Dialogue)
      Part I: The coach explains about the exercise and its structure.
      Part II: The exercise. Each participant gets to lay on the “clearing bed;” the others sit around them. The active participant chooses one person to be by their head and one to be by their feet; the rest sit around these three. Participants can choose whether they want it to be in silence or with music; they can also choose the kind of music they want. There is a possibility, if they choose, to be “smudged” with burning sage. Participants lie down and are covered—two people cover them with the renewal skin they created the previous day. Throughout the exercise, we do cleansing energy work similar to Reiki in that there is no touching. The helper by the active participant's head might lightly be supporting their head; the person at their feet might be lightly massaging their feet. The active participant chooses if they want to be touched or not.
      Before the energy work starts, the coach speaks for the group and says the name of the person, and then “we are here to give you the best of our love and care.” At the end of the clearing work, the coach says on behalf of the group, the active participant's name and then “may you shed your skins again and again and come to your light.” At the end, the participant says “I free myself to be ______”, filling in the blank with whatever they want, and expressing themselves however they want. Then, two other people help them to get up, and they can take a minute to go and rest. The next person repeats the process.
Section E should take 30 minutes.
   Closing circle. The group sits, and each person chooses two other people to acknowledge them for their courage, honesty, and vulnerability in the work that they have done. The coach should recommend people to make sure that everyone gets acknowledged and not everyone is acknowledging the same two people.
End of Stage II Workshop: Pathways to the Heart (Two and a half day weekend workshop.)
   Note to coach: True relating presents us with the deepest opportunity for mutual self-discovery and self-healing. It is the ground for sharing love, care, and connection. Relationships are an inspiration for the experience of unity as well as individuality; both can be considered among the most important emotional experiences on the journey to self-actualization.
   Goals of the workshop: 1.) To examine the reasons for and the ways that we are avoiding and sabotaging emotional intimacy and fulfillment in our relationships. 2.) To learn to recreate the ability to relate, communicate, and share authentically and effectively. 3.) To recognize the conflict that exists between the need to defend/protect ourselves and the need to open up and share, and to lean to attend to both needs in a healthy way. 4.) To learn effective, constructive dialogue skills.
I. Homework Thinking Assignment (please take notes)
1. Participants are asked to think about two important relationships with two different people. One is a relationship that is unresolved, possibly upsetting, and incomplete. The other is a relationship in which participants feel totally open, comfortable, loving, and loved.
2. Participants are asked to reflect on the following questions: if you imagine your heart as a landscape, where do you see blockages like walls, knots, barbed wire, and rocks? How do you imagine the open, joyful spaces? What things (wings, etc) symbolize these open spaces?
II. Homework Writing Assignment:
   The subject of the assignment is “To set my heart free”. It is a creative writing exercise—the form is free; it can be a story, a poem, a play, etc. but what's important is to consider three things: 1.) What are the most heartfelt, deepest needs, desires, and dreams within your heart? 2.) How do you want to free your heart to communicate with others? 3.) How are you stopping yourself? These elements should go into the writing.
III. Bringing Assignment:
   Participants are asked to bring pictures and symbols of people they love; things that inspire them and move them and are most important to them. They should also bring two poems that speak to them about the heart, and they should learn by heart at least two favorite lines from these poems.
   In addition, participants should bring their favorite music for fun, healthy snacks for a Saturday night party, journals and writing implements, musical instruments if they would like to play, walking shoes, and several layers of seasonal, comfortable clothes.
IV. Workshop Structure:
Day 1 (Friday afternoon 6:30-10:30):
   Introduction: Just like all workshops, there is an intro and welcome that includes the workshop goals and guidelines. 1.) The coach welcomes everyone and speaks about the nature of the workshop. 2.) The participants take a couple minutes to say something about themselves, and 3.) The following guidelines are covered.
1. All participants are asked to be on time all the time.
2. Participants are asked to fully participate in each of the exercises. If they have any problem, they should talk to the coach or the assistants and figure out a way to still participate. Full participation in the workshop is a must.
3. Participants are asked to take every process and exercise to the limit, to go beyond their comfort zone. Expanding and finding the courage to go into frightening places is the point.
4. All participants promise absolute confidentiality about everything in the workshop, even when sharing the workshop experience with loved ones. If they need to speak about someone's experience, they should never mention names or details.
5. All participants must be honest with what they share as well as extremely supportive of themselves and others. The workshops are difficult emotionally and spiritually, and every participant can use the support of the group.
6. All participants must stay focused—no chitchat when it's not necessary.
7. It is advised to not eat heavily while doing a workshop. Participants should drink as much water as possible, wear comfortable clothes, and bring journals and pens.
   All the guidelines are covered in the intro of each workshop.
Section A should take 30 minutes.
   “What is in my Heart?” (Gate of Silence, Gate of Emotions)
      Part I: Silent meditation, eyes closed, with gentle drumming in the background symbolizing a heartbeat. Participants have 5-10 minutes to relax; afterward, they are asked to put one hand on the heart and the other stretched into the middle of the circle. Spontaneously they should mention feelings, thoughts, and impressions. Participants are all talking at the same time. The coach continues to ask “What is in your heart now?” every few minutes, to encourage a flow of expression.
      Part II: After they're done, the coach asks participants to open their eyes; they choose one of the lines from their poems and the coach asks each person to say the sentence. The group responds spontaneously but all together to the line from the poem, using just one word or one sound. Then, the next person speaks the line from the poem, etc.
Section B should take 45 minutes. (Gate of Dialogue)
   Part I: Sharing. “Where is your heart now?” “Wings and the wires.”
   Part II: Sharing the excerpts from the writing in small groups.
Section C is 20 minutes.
   The coach reads the story “The Bird of the Soul”. The group shares their responses about the story.
Section D should take 30-45 minutes.
   “The Rooms of the Heart”—laying-down meditation (Gate of Silence).
      The meditation starts with ten minutes of relaxation, quieting the mind and coming into the breath. Then, the coach guides participants to enter the “home of the heart” with many rooms within it; they are to visualize themselves walking on a path towards that home. They should also visualize the structure of that home (a house on the beach, a castle on the mountain, etc). They slowly approach, visualizing themselves opening the door; the coach asks them to enter and begin to visit different rooms that the coach will call out—for example, “the room of childhood memories”, “the room of creative expression”, “the room of loneliness,” etc. Participants will be visiting at least ten different rooms. The coach needs to give them time to experience each room. When the process is over, the coach gives them a few minutes to return to a normal state.
Section E should take 30 minutes.
   Sharing (Gate of Dialogue
      Part I is sharing in couples. Each person shares their experience in one of the rooms from the previous section.
      Part II is a group sharing. Participants share surprising, unexpected details that came to them in the meditation.
Section F should take 25 minutes.
   Closing circle (Gate of Dialogue)
      Each person picks up a long ribbon from a pile of ribbons that are provided. They take a couple of minutes to sculpt the shape of the ribbon, expressing the state of their heart at that moment. Then they will do a quick share about the shapes they have created with their ribbons. Participants are asked to wear the ribbon on their body (wrist, ankle, neck, etc) throughout the workshop.
      Then, participants sit in silence as one by one each shares the second line of poetry that they brought with them to the workshops. There are no comments or responses during this part. The section ends with a collective poem where one person starts with a word, the next continues, and so on, with the idea being to create a cohesive, collective poem about the heart.
      The coach also explains about the next day.
Day 2 (Saturday 10 AM-5:30 PM):
Section A should take 30 minutes.
   “The Seven Primary Emotions”—movement meditation. (Gate of Creative Expression, Gate of the Body)
      In small groups. First ten minutes are dedicated to stretching and warming up individually. The second ten minutes consist of a collective stretch—each participant contributes a minute of innovative stretch; the group mirrors them. The section ends with the whole group, led by the coach, in a creative expression of the seven primary emotions—fear, pain, anger, need, joy, love, and peace. This last part is intended to be creative, expressive, and fun; participants should be comfortable with expressing these feelings.
Section B should take 30 minutes.
   Writing exercise (Gate of Dialogue, Gate of Creative Expression)
      Each participant gets a colored envelope and a few matching colored pages. They are to write a letter—called the “Completion Letter”—to the person in their life that they feel most unresolved with. Participants must choose a very important relationship. In the letter, participants need to pour their heart out—they should say everything that they haven't said, or things that need to be reiterated, digging down as deeply as they need to find those feelings and express them honestly.
Section C should take 2.5 hours.
   “The Completion Dialogue—experiential expressive exercises (Gate of Emotions, Gate of Dialogue)
      In this process, participants will get a chance to speak their minds and express the feelings to the person that they wrote about in the previous exercise. Participants break into small groups, then choose two people; one represents the person with whom they have incomplete business, and the other one represents a supportive voice. The active participant and the helper representing the other person sit facing one another; the supportive voice sits behind the active participant, gently touching their back as a sign of support. The helper representing the other person is not supposed to talk until the very end; the supporter, however, can intervene gently to help the active participant with the expression of feelings. The coach needs to intervene if/when expressions of feelings are defensive, frozen, inauthentic, or repressed. At the very end, the helper representing the other person is allowed to speak, but only from the heart and from a place of compassion. The process is repeated for each participant. The rest of the group sits quietly in support.
Section D should take 30 minutes.
   Laying-down meditation (Gate of Silence, Gate of Emotions).
      The exercise starts with ten minutes of relaxation, after which participants are asked to feel into the effects of the last two exercises, noticing if their feelings have changed towards the person they addressed. Many times the layers of love or forgiveness come to the surface at this point after the completion exercise. If there is a need to still ask for apology or say that you have forgiven, participants are encouraged to do that. They should also notice if they are still feeling incomplete.
Lunch Break
Section E should take 1 hour.
   Solitude walk (Gate of Silence).
      During this hour, participants should write down a list of people in their life that they loved, that loved them, or that inspired, supported, or contributed to them.
Section F should take 30 minutes.
   Love walk. (Gate of Dialogue, Gate of Emotions)
      This section is a walk in nature done in couples; each person chooses five people from the list they wrote on their solitude walk. Within the walk, each of the partners shares a little story connected to each of the people, switching after each partner has told one story.
Section G should take 30 minutes.
   “The Love Letter”—writing (Gate of Creative Expression, Gate of Emotion)
      Participants get a different color envelope with matching colored paper; they're asked to write a love letter to a person that is extremely important to them and toward whom they feel very deep love. (Some people might find themselves choosing the same person from the completion letter.)
Section H should take 30 minutes.
   Sharing (Gate of Dialogue, Gate of Emotion)
      The group divides into couples; the couples divide themselves to A and B. The coach gives all A′s about ten minutes to share their feelings with their partner, as if that partner is the actual person to whom they wrote the letter. After 10 minutes, they switch. At the end, participants who would like to share can do so in the large group.
Section I should take 20 minutes.
   Emotional meditation (Gate of Emotion, Gate of Silence)
      This section is a private moment. Participants are asked to lie down on their sides and lightly embrace themselves. The coach encourages them to get in touch with feelings of love and compassion that they have for themselves, as well as sadness and regrets. The most important point is to contact a sense of compassion towards oneself.
Section J should take 15 minutes.
   2 options, depending on the group's mood: if the mood is heavy, the coach might want to let people share about the day. If the mood is lighter, then a group back massage is a fun exercise to complete the day. The group stands up in a circle and each person actually massages the back and shoulders of the person before them. The coach also explains about the party; the party theme is “The Passion Cabaret.” People are invited to write or read any poetry and speak about real or imaginary passion stories; this party is lighthearted, fun, playful, and outrageous; it consists of music, dance, performance, etc around the theme of passion.
Day 3 (10 AM to 5 PM):
Section A should take 30 minutes.
   Movement and dance (Gate of the Body, Gate of Creative Expression)
   Part I is a stretch in pairs. Participants should explore all the ways to stretch with each other and near each other. Caution: be careful to not injure your partner by pulling, pushing, or twisting.
   Part II is called “Love around the World.” This part consists of a collection of 8-10 short segments of dance music throughout history. It's done in couples; the partners switch every time a new piece of music comes on.
Section B is 30 minutes.
   Sharing (Gate of Dialogue)
      Participants share the pictures and objects they brought as a part of their homework.
Section C should take about 3 hours.
   Artwork (Gate of Creative Expression)
      The theme of this section is “I set my heart free.” Using clay, feathers, wires, material as well as their objects, pictures, and words, each participant creates a sculpture.
Section D should take 30 minutes.
   Viewing and responding to artwork (Gate of Dialogue).
Lunch Break.
Section E should take 1 hour.
   Participants have one hour to meditate and write. They all get a sheet of paper with points on it that they should cover in their writing. They should be spontaneous but specific. The points to cover are:
1. My deepest heart needs are ______.
2. I am learning to ask for ______.
3. I am learning to express ______.
4. I want to give ______.
5. I want to receive ______.
6. I need to forgive ______.
7. I want to ask forgiveness for ______.
8. I am willing to let go of ______.
9. I am grateful for ______.
10. I am looking forward to the adventure of ______.
Section F should take 30 minutes.
   “The Heart Desires”—sitting meditation and sharing (Gate of Silence, Gate of Dialogue)
      Part I. After 10 minutes of relaxation, the coach reads the pointers out loud and gives participants a couple of minutes in between to feel for the answers, possibly finding a deeper connection to the answers.
      Part II: Sharing in couples. Each couple is divided into A and B; the starting partner will share a few words about each of the pointers, which the coach again will name out loud. There is no chatting. After partner A finishes, they switch.
Section G should take about 2 hours.
   Trust exercise (Gate of the Body, Gate of Silence, Gate of Emotions)
      The exercise is done in small groups with each participant going one by one. The active participant stands in the middle of a circle; the rest of the group holds very tightly to each other. The active participant closes their eyes, and experiments with falling to the back, side, and front, allowing themselves to be supported by the group. They should never fall on the floor; the group has to be there for them. After a few minutes, the leader of the group asks the participant to lay down and tell them that they will be lifted up, gently rocked, and then slowly lowered to the floor. After they explain this, the group does it. The active participant needs to lay back and allow the group to hold them; everybody supports the active participant from underneath, especially the head and feet. There is a gentle rocking, and then very slowly they're placed on the floor. Participants do have a choice—if they feel comfortable being touched, the group will lightly massage the hands, feet, and neck for a few minutes. If not, they just lay there for a minute or two and rest. There might be crying; sometimes people feel overwhelmed by the care and the love. The coach should be encouraging emotional expression.
Section H should take 25 minutes.
   Closing circle (Gate of Dialogue)
      Participants share heartfelt expressions about the workshop, about other participants' efforts, about oneself, etc. The end is another collective poem. The theme can be chosen right there and then.
Mid-Stage Workshop: Ways of Celebration (Three-day weekend workshop.)
   Goal of the workshop: 1.) To deepen the ability for joy, expression, and expansion. 2.) To become aware of the ways that we inhibit our joy and expression, and learn to let go of these ways. 3.) To form a lifelong commitment to one's own happiness and wellbeing.
   Note to the coach: We are instruments of energy, feelings, expression, and creativity; we are meant to fully celebrate our innate nature as joyous, expressive beings. However, life's difficulties, traumas, and fears block our expression and our sense of freedom. Our journey is to continuously and dedicatedly free ourselves so that we can experience our true nature and our abilities as much as possible.
I. Homework Thinking Assignment (please take notes)
1. What is the highest vision of yourself and your life that you can access at this point? This means being fully alive and celebrating your talents, gifts, the people in your life, as well as feeling like you are moving forward, accomplishing your goals and growing (a sense of freedom). It also includes your feelings and your experience of yourself, the way that you're relating to others, the world and life, work/career, your creative and expressive projects, your health, your spiritual state of mind, etc.
2. Where are you caught—your inner prison?
(The place within you that keeps you contracted, unexpressed, critical, negative, despairing, disconnected, and small.)
II. Homework Writing Assignment:
   You can use any form you want: story, poetry, etc. Whichever form you choose, make sure it's grounded in your feelings and experience rather than in your intellect.
   Write on these two subjects:
1. My Life as a Free and Celebrating Self
2. My Life Within My Imprisoned Self
III. Bringing Assignment:
1. Bring a beautiful, long piece of material, enough to cover your whole body.
2. Bring any kind of jewelry or adornment. (These will be used in the final ritual. You are going to want to look your best.)
3. Bring one object that symbolizes freedom for you (it can be a small item).
4. Bring 2 or 3 CDs of beautiful music. (I know you all have iPods, but if you have CDs, it might be easier. I′m hoping to have an iPod with speakers with us, too, so you can bring both.)
   In addition, participants should bring their favorite music for fun, healthy snacks for a Saturday night party, journals and writing implements, musical instruments if they would like to play, walking shoes, and several layers of seasonal, comfortable clothes.
IV. Workshop Structure:
   Introduction: Just like all workshops, there is an intro and welcome that includes the workshop goals and guidelines. 1.) The coach welcomes everyone and speaks about the nature of the workshop. 2.) The participants take a couple minutes to say something about themselves, and 3.) The following guidelines are covered.
1. All participants are asked to be on time all the time.
2. Participants are asked to fully participate in each of the exercises. If they have any problem, they should talk to the coach or the assistants and figure out a way to still participate. Full participation in the workshop is a must.
3. Participants are asked to take every process and exercise to the limit, to go beyond their comfort zone. Expanding and finding the courage to go into frightening places is the point.
4. All participants promise absolute confidentiality about everything in the workshop, even when sharing the workshop experience with loved ones. If they need to speak about someone's experience, they should never mention names or details.
5. All participants must be honest with what they share as well as extremely supportive of themselves and others. The workshops are difficult emotionally and spiritually, and every participant can use the support of the group.
6. All participants must stay focused—no chitchat when it's not necessary.
7. It is advised to not eat heavily while doing a workshop. Participants should drink as much water as possible, wear comfortable clothes, and bring journals and pens.
   All the guidelines are covered in the intro of each workshop.
Day 1: Friday (6:30 PM-10:30 PM)
Section A should take 30 minutes.
   “Being Breathing Becoming”—meditation (Gate of Silence, Gate of Creative Expression)
      Part I. Like all meditations, this one starts with about 10 minutes of relaxation. After, with eyes open, the participants experience the room, look around, and find out as many details as possible. They should look at other people, listen to sounds, observe smells, colors, and lights, and slowly ground themselves into the present moment. At the same time, they should witness resistance, “monkey mind,” anxiety, avoidance, daydreaming, etc.
      Note to the coach: Remember that joy and expression are directly connected to being present.
      Part III: “Ocean breath,” which is a strong, audible breath that sounds like the ocean. The whole group breathes together; the goal is to deepen the breath and to catch yourself when your breath gets stuck or falls out of pattern.
      Part IV: participants should be seated; then the coach asks them to use sounds and gestures to release any kinds of feelings or energies that are present within them at that moment. The coach encourages a subtle shift—it has to be authentic—toward a synchronized, communal, cohesive fabric of sounds and gestures. The sounds and gestures do not need to all be the same, but the group should observe each other and contribute to the interwoven pattern.
Section B should take 30-40 minutes.
   “The Stuck Self and the Celebrating Sell”—discussion (Gate of Dialogue, Gate of Creative Expression)
      Part I: A round of fun expression. Each person has a turn; they express in movement, sounds, and words their “stuck self”. They have to be able to laugh at that part of themselves, and creative exaggeration is very healthy. This is a lighthearted, compassionate caricature. The second round is an expression of their “celebrating self”, where participants lightheartedly express the ways in which they celebrate.
      Part II: Participants share about this question: “What is the meaning of celebration for you? What is your personal prison?”
      Part III: Participants share the freedom objects from their homework.
      Part IV: Participants share their homework writing.
Section C should take 30 minutes.
   “The Inner Prison”—visualization (Gate of Silence, Gate of Emotions).
      The meditation is done laying down. It starts with about ten minutes of relaxation, and then the coach guides participants to go inside their “emotional home”. The coach suggests that within their emotional home, there is a prison—one room within the house that acts as a prison room. A part of their emotional self is behind locked doors, unable to communicate to the world. The room is the most isolated place within the psyche. The coach guides participants to see themselves walking through the corridor, seeing all the different rooms they pass, and actually come to a very heavy metal door. They should realize that there is a guard outside the door; this guard is a part of their own selves. Participants are encouraged to think intuitively as they discuss with this guard if and how they would be able to get in the locked room. The goal is to understand why the guard is not allowing anyone into the room. They are encouraged to have a dialogue with the guard, and hopefully, to be able to take a peek into the room and get a sense of this part of themselves that has been sitting in the dark. Participants are asked to follow the visualization and let things come to them—no manipulations or fabrications. The coach gives participants time, and oversees the group's progress, encouraging them along the way.
      The coach should check in with each person along the way to make sure they haven't become distracted or fallen asleep. To check in, a participant should lift a finger as they hear their name called. This goes for any visualizations that are long and difficult. The coach also checks in at the end to make sure that everyone has followed the visualization and has successfully completed it. At the end, participants get a few minutes to return to a normal state.
Section D should take 25 minutes.
   Writing (Gate of Silence, Gate of Creative Expression)
      Participants write about their experience in the previous visualization.
Section E should take 25 minutes.
   Couples sharing and observation (Gate of Dialogue, Gate of Emotions)
      Part I. The two partners sit facing each other for this section. First, the coach asks them to look at each other from the part of themselves that is imprisoned, and to see how it feels. Second, the partners should look at each other from the part of themselves that is free, joyous, and celebrating.
      Part II: Partners share their experiences in the visualization and in the exercise.
Section F should take 15 minutes.
   Closing circle (Gate of Silence).
      There is 10 minutes of silent meditation. Then the coach speaks about the next day.
Day 2: Saturday (10 AM-5:30 PM)
Section A should take 30 minutes.
   “From Playfulness to Fear”—movement (Gate of Silence, Gate of Creative Expression, Gate of the Body)
      This section begins with the whole group moving together. The first part is stretching individually; then, the coach prefaces the next part by saying “this is a playful, fun, silly part, and it's best to allow yourself to be silly and playful.” The coach then asks participants to imagine being three years old, in a big beautiful playground with a lot of kids. The coach gives participants about 5-7 minutes to just be silly and pretend they're kids.
      Then, the coach slowly begins to introduce ideas of fear, beginning with the idea of being physically hurt. This is done first by turning the playground into a place with rocks, prickly bushes, insects, and so on. Then, the coach introduces the idea of emotional hurt: social isolation, forms of rejection and criticism, etc. The coach then asks the participants to see how these images and ideas affect their body sensations, feelings, and ability to stay playful. At the end, the coach introduces the idea of disapproval from a parent or teacher, and fear of failure. Throughout the exercise, participants stay playful in terms of their approach to the exercise, but allow themselves to actually be affected by the unpleasantries that are being introduced. This section is an exploration of the effect of fear on the energy system.
Section B should take 30 minutes.
   Emotional meditation (Gate of Silence, Gate of Emotions)
      This section starts with about ten minutes of relaxation. Then, participants are led to return to their inner prison—the coach guides them by retracing some of the steps that they took in the visualization in order to return to the same emotional place. The difference in this meditation is that as participants visualize themselves entering the room, they go and sit next to the part of themselves in the room, and they begin to take on the feelings and merge with that part, slowly becoming that part of themselves. Then participants sit there, feeling those feelings fearlessly. The coach must give them time and encouragement to do this; the emotions that arise in this exercise can be very difficult. It is important that the coach leads them to slowly separate themselves from the imprisoned self and then leave the room. At the end of the exercise, the coach gives participants time to return to a normal state.
Section C should take at least two hours.
   “Liberate the Self from the Inner Prison”—experiential process (Gate of Emotions, Gate of Dialogue)
      Small groups. Each participant works in front of their small group, choosing two other helpers. The goal of this process is to re-enact the inner prison. The active participant chooses one person to be the guard; that person will always be the guard. The other person and the active participant will assume the roles of the imprisoned part and the Expanded Self, switching midway through.
      Part I: The active participant assumes the role of the imprisoned self. This is done physically, using a corner of the room to evoke a sense of being cornered. The guard is also there preventing the Expanded Self from entering. The helper in the role of the Expanded Self has to convey a message that would make sense to the guard. The coach has to encourage the person sitting as the imprisoned self to feel their feelings—maybe they have felt the emotions already in the meditation, but most people have a hard time feeling in front of a group and physically and emotionally embodying the feelings. Some kind of a breakthrough is expected—the Expanded Self should eventually be allowed to enter, though it cannot be fabricated.
      Part II: The active participant becomes the Expanded Self and the other person sits as the imprisoned part, emulating the feelings from the previous section. In this part, the active participant should have an easier time passing the guard, coming in, and ideally having a dialogue with the imprisoned part, possibly encouraging them to come out. This is a very delicate process, and shouldn't be manipulated or forced in any kind of inauthentic way.
Section D should take 25 minutes.
   Sharing (Gate of Dialogue)
      The group shares about the process they've just gone through. Lunch Break.
Section E should take 1 hour.
   Solitude (Gate of Silence).
      Participants can walk (if the workshop is near nature); they should remain introspective in solitude, meditating and writing about the following points:
   1. What gives me most pleasure, joy, and fulfillment?
   2. What are the things that I look forward to in terms of fun and adventure?
   3. What would my life be like if I could have it be anything, anywhere, and any way I wanted? (Think big; think beyond your limits, outside of the box.)
Section F should take 30 minutes.
   “Giving and Receiving”—couples (Gate of Dialogue, Gate of Emotions)
      If weather permits and there's suitable space, this section should be done in nature.
      This exercise is about giving and receiving. A note to the coach: this exercise should not become intellectual; the coach might need to demonstrate it before it's done because it tends to get chatty.
      The partners are divided to A and B. The starting participant will find what it is that makes them fulfilled in terms of giving to another person. They will actually find a way to give something to their partner at that moment. Then the partners switch. The coach explains that the first round will be an opportunity to be a giver—to give to the receiving partner something that fulfills the giver as an action. Participants should be creative and come from the heart. At this point they know each other quite well, so they need to come up with something that fulfills them and possibly moves or gladdens the other person. The partners switch.
      In the second round, each partner shares what they long to receive from another person. They have an opportunity to receive that from their partner.
      An example is: someone writes in their homework that it gives them pleasure to make people laugh in a personal way, not just with jokes. Then that person would give that to their partner, and make them laugh or smile in a personal way. If what they want to receive most is kind listening, they would tell their partner that it's the thing they appreciate most, and the partner should attempt to give them that.
Section G should take 2 hours.
   Creative exercise—“My fantasy life” (Gate of Creative Expression)
      Part I: small groups. Each participant has to plan their fantasy life based on what they wrote before. They should think how many people they want to help them in playing out that fantasy, what their roles would be, where it would take place, and more or less the storyline. For example, if someone is an actor and their fantasy life is to be on a movie set with Robert DeNiro, directed by Paul Newman, then they have to figure out who is in the scene and assign people to play the actors, the director, and whoever else is needed, the whole group helps them. Each person gets about five minutes to set the scene and live their fantasy life in a fun planned improv.
Dinner break.
Party. The party theme is “Wild, Crazy, and Outrageous.”
   Participants can think of games, presentations, performances, etc along the theme.
Day 3: Sunday (10 AM-5 PM)
Section A should take 30 minutes.
   “How the Imprisoned Self Found Freedom”—movement/improvisation (Gate of the Body, Gate of Creative Expression).
      Ten minute personal stretch, followed by improvisational movement storytelling. The theme is liberating the imprisoned self; this is done by imitating an action movie. It must be fun; it's a communal creation of an action story about liberating the self. There should be bad guys, heroes, and the imprisoned self; the story should end on a good note.
Section B should take 30 minutes.
   Discussion (Gate of Dialogue)
      The theme is “the most important commitments in life are . . . ”. Note to the coach: it's very important to lead the discussion to the idea of one of the most important commitments, which is to oneself—present the idea of marriage to oneself. The coach will explain that the rest of the afternoon is dedicated to participants creating a ritual and a ceremony in which they will vow commitment to themselves and actually “get married” officially to themselves.
Section C should take 1.5 hours.
   Creative artwork (Gate of Creative Expression)
      This section is about creating an outfit for the ceremony, using the materials that participants brought in. The outfit should be symbolic. After their outfits are made, the participants share with the group.
Lunch Break.
Section D should take 1 hour.
   Solitude (Gate of Silence)
      Participants should meditate on their “marriage ceremony” and its details: who do you want to participate, what music, where in nature you want to have it, etc.
Section E should take 1 hour.
   “The Vows to Myself”—writing/preparing (Gate of Silence, Gate of Dialogue)
      Participants write their vows, speaking to people that they need for their ritual and organizing everything so that they're ready.
Section F should take 2 hours.
   Part I: Participants get dressed and prepare.
   Part II: Each participant goes through their ritual.
Section G should take 20-30 minutes.
   Closing circle (Gate of Dialogue).
      Participants share about the feelings and insights they're taking with them from the workshop.
End of stage III Workshop—The Power of Intimate Relating (Two-day weekend workshop)
   Goal of the workshop: 1.) To realize the natural ever-relatedness of life. 2.) Understand what is in the way of experiencing relatedness, and how this blockage causes suffering. 3.) To explore the difference between healthy and addictive relating. 4.) To learn the Ten Commandments of Successful Communication.
I. Homework Thinking Assignment (please take notes)
   In this homework, consider this quote from Dr. Martin Luther King, Jr: “In a real sense all life is inter-related. All men are caught in an inescapable network of mutuality, tied in a single garment of destiny. Whatever affects one directly affects all indirectly . . . I can never be what I ought to be until you are what you ought to be, and you can never be what you ought to be until I am what I ought to be. This is the inter-related structure of reality.”
1. Observe the world around you and note down examples of connectedness. Example: weather connects to food, connects to health, connects to social systems, connects to education, etc.
2. Think of three important emotionally intimate relationships in your life. At least one of them should be a relationship in which you feel difficulty. It can be a person who is not alive, or a person who is not in your life anymore, like a parent or an ex-mate; it can also be a more abstract personal relationship, such as one with God. Participants should write notes for each.
II. Homework Writing Assignment:
   Part I: Answer the following questions:
1. How do you define relating?
2. Consider: is there something that you know of that is not related to everything?
3. Why are we people feeling lonely, isolated, and unrelated? What are the root causes?
4. How would you define the difference between addicted relating and healthy relating?
   Part II: Observing the three relationships you have chosen to work with, answer these questions (please answer all five for all three relationships):
1. Am I relating to them out of the fear, insecurity, and anxiety of being loved?
2. Am I accepting them and myself, or am I trying to “fix” them or myself?
3. Am I able to see them for who they are, or am I very busy trying to make it “work” “well”, “differently,” etc—so much so that I have a hard time really seeing them?
4. Do I experience emotional intimacy with them?
5. Do I communicate authentically with them?
III. Bringing Assignment:
   Participants should bring their notes and their readiness, and expect to work with these relationships in front of the group.
   In addition, participants should bring their favorite music for fun, healthy snacks for a Saturday night party, journals and writing implements, musical instruments if they would like to play, walking shoes, and several layers of seasonal, comfortable clothes.
IV. Workshop Structure:
   Introduction: Just like all workshops, there is an intro and welcome that includes the workshop goals and guidelines. 1.) The coach welcomes everyone and speaks about the nature of the workshop. 2.) The participants take a couple minutes to say something about themselves, and 3.) The following guidelines are covered.
1. All participants are asked to be on time all the time.
2. Participants are asked to fully participate in each of the exercises. If they have any problem, they should talk to the coach or the assistants and figure out a way to still participate. Full participation in the workshop is a must.
3. Participants are asked to take every process and exercise to the limit, to go beyond their comfort zone. Expanding and finding the courage to go into frightening places is the point.
4. All participants promise absolute confidentiality about everything in the workshop, even when sharing the workshop experience with loved ones. If they need to speak about someone's experience, they should never mention names or details.
5. All participants must be honest with what they share as well as extremely supportive of themselves and others. The workshops are difficult emotionally and spiritually, and every participant can use the support of the group.
6. All participants must stay focused—no chitchat when it's not necessary.
7. It is advised to not eat heavily while doing a workshop. Participants should drink as much water as possible, wear comfortable clothes, and bring journals and pens.
   All the guidelines are covered in the intro of each workshop.
Day 1: Saturday (10 AM-6 PM),
Section A should take 30 minutes.
   Icebreaker (Gate of Emotions, Gate of Dialogue)
      Participants are asked to walk around the room, and when the coach says stop, they find a partner and share in turns. Each turn of sharing gets about a minute and a half; each time they stop, they should find a different partner to share with.
   First stop: Name 3 things that are most enjoyable to you.
   Second stop: Name 3 things that deeply annoy you.
   Third stop: Name 3 things that you are most passionate about.
   Fourth stop: Name 3 things you admire in others.
   Fifth stop: Name 3 things you appreciate in yourself.
   Sixth stop: Name 3 things you hope to accomplish in the next year.
   Seventh stop: Name 3 things you need to learn now.
   Eighth stop: Name 3 things you are most afraid of in intimate relationships.
   Ninth stop: Name 3 things that you feel are your strong points in intimate relationships.
   Tenth stop: Name 3 things you must get better at in your intimate relationships.
Section B should take 30-45 minutes.
   “Three Questions”—meditation and sharing (Gate of Silence, Gate of Dialogue)
      Part I: Sitting meditation. Ten minutes of relaxation, after which the coach repeats the last three questions, with a few minutes in between, and asks the participants to re-engage with them.
      Part II: Participants share in depth in small groups about these three questions. Each person elaborates about themselves regarding these questions.
Section C should take 30 minutes.
   Discussion (Gate of Dialogue)
      Discussion around two other questions: 1.) What are we looking for in an emotionally intimate relationship? What can we name as the important elements that create a loving intimate relationship? 2.) What is in the way? One person should take notes on the important points that are covered in the discussion.
      Note to the coach: It's important that the discussion covers the importance of:
   1. Acceptance, respect, and granting space to be.
   2. A sense of togetherness, and simultaneously, a sense of individualism.
   3. Authentic, honest, from-the-heart communication, which includes good listening skills.
   4. Continuous dialogue to resolve and complete—no storing of unfinished business.
   5. Healthy negotiation and creative way to bring about change.
   6. Openness to passion—emotional, spiritual, and physical—not just in terms of romance, but in general.
   7. Loyalty, commitment, and a sense of responsibility.
   8. Mutual support on the process of transformation and actualization.
   9. Being in the moment, seeing ourselves and the other with fresh eyes.
   10. Attempting to be and give a hundred percent.
Section D should take 30 minutes.
   “Peeling the Layers of Defensive Feelings”—emotional meditation (Gate of Silence, Gate of Emotions)
      Part I. The meditation starts with 10 minutes of relaxation. After, the coach asks participants to choose the one intimate relationship that they have the most difficulty with, and bring that person into their heart space. They should first feel into the frustration that they experience in the relationship—feelings and ideas that are not being communicated, needs that don't feel fulfilled, anger, resentment, etc. The coach gives them a few minutes to feel into the ideas.
      Part II. The coach asks participants to peel the layers of defensive feelings and find within themselves the source of their frustration—the “bottom line feeling.” Then, the coach asks them to see if that is a familiar feeling, and to see if they can trace that feeling to its root. It is important to remember that frustrated needs are many times at the root of difficult feelings. Again, the coach gives them a few minutes.
      Part III: The coach will ask participants to observe if they are able to communicate to their partner this “bottom line feeling”. If yes, how are they communicating it? If no, what is in the way of communicating it? Or, how are they communicating it in a way that doesn't work? After the process, the coach gives them a few minutes to come back to a normal state.
Section E should take 25 minutes.
   Writing exercise (Gate of Silence, Gate of Creative Expression)
      Participants write down their observations and insights from the meditation.
Lunch Break.
Section F should take 30 minutes.
   Communication (Gate of Dialogue)
      In this section, participants sit with one or two people that they did not know before the workshop and get to know them a little better.
Section G should take 2-2.5 hours.
   “Effective Communication—and Knowing the Difference”—experiential process (Gate of Dialogue, Gate of Emotions, Gate of Creative Expression)
      The coach needs to explain in detail the exercise and possibly do a mock version of it. This process is done in front of the group because everyone is learning from it.
      The active participant chooses three other people to help them, and gets a few minutes to prepare. One will represent the person that the active participant has difficulty with; the two others will be the two other aspects of the active participant's self (these roles will shift). The active participant starts as their Defensive Self, and sits facing the person representing the problematic relationship. The two other aspects of the active participant will sit alongside the active participant (Emotional on right, Expanded on left).
      Round one: The active participant will express their frustration, resentment, anger, disappointment, etc from their Defensive Self to their partner. While they're doing that, the Emotional Self is asked to insert one moment of how they feel, and the Expanded Self is asked to insert one moment of how they feel. However, the dominant voice is that of the Defensive Self. When the Defensive Self is done, the person representing the other person in the relationship gives them feedback as to how this defensive expression made them feel.
   Comment: The coach should be pointing out that mostly defensive expressions create stuckness, stagnation, furthering resentment, and deepening of the conflict.
      Round two: The active participant sits as their Emotional Self; the others are the Defensive (right) and the Expanded (left). They express the same frustration and anger from pure feelings—no attacking or defensive modes. Again, the two others have a moment to insert their point of view. At the end of this communication, the helper sitting as the other person in the relationship gets to give them feedback about how they felt and received the communication. Again, the coach takes this moment as a “teaching moment,” explaining that mostly heartfelt communication from a subjective, feeling place is heard better and creates a space for understanding.
      Round three: the active participant sits as their Expanded Self; the others are the Defensive (right) and Emotional (left); the process is repeated.
Section H should take 30 minutes.
   Closing discussion (Gate of Dialogue)
      The discussion covers what works and what doesn't work in intimate relating. It should also cover the concepts of “payoff” and “cost”. In the end of the discussion, each person in small groups says one sentence that they found was most important for them to say in order to create positive movement in the relationship that they chose to work on.
Day 2: Sunday (LOAM to 5 PM)
Section A should take 30 minutes.
   Movement (Gate of the Body, Gate of Creative Expression)
      Theme: Relationships. Participants start by moving alone. Then, guided by the coach, they start moving in couples. Next, guided by the coach, the whole group comes together and moves together.
Section B should take 30 minutes.
   “The Payoff, the Cost, the Benefits”—discussion (Gate of Dialogue).
      What is it in the other person—the one that you chose to work with in the homework assignment—that you do not see or cannot accept? What are you not willing to acknowledge or realize? Why?
      Note to the coach: The idea of the “neurotic payoff” and the “cost” should be brought into the discussion. When we don't want to take responsibility, we tend to want to put it on the other person and have a demand for them to be a certain way. The “neurotic payoff” is the comfort of staying a child, safe, dependent, etc. the “cost” is the fact that relationship cannot flourish, and personal growth is impossible
Section C should take about 2 hours.
   “Effective Communication, Stage 2”—experiential process (Gate of Dialogue, Gate of Emotions)
      Participants should work with the same three people that they worked with the previous day. There are two rounds in this experiential process.
      Part I: A few minutes of preparation time where the active participant reminds the three helpers of what they will be portraying. Since they have gone through a process, they might be able to “see” their point of view more objectively and the active participant can prep the person better.
      In the first round, the helper that represents the other person gets to speak from their point of view and their feelings. They should use their intuition from knowing the story of the previous day.
      Part II: The active participant sits in all three aspects and responds to the other person from all three aspects of themselves. The other two helpers hold the two other spaces. The coach must help the active participant to find a place of resolution and openness.
      Part III: Short sharing about the exercise.
Lunch Break.
Section D should take 30 minutes.
   Solitude (Gate of Silence)
      Participants can walk, sit, write and reflect.
Section E should take 30 minutes.
   “The Love Expression”—couples (Gate of Dialogue, Gate of Emotions)
      Participants are asked to think of someone they love deeply, and to whom they were not able until now to fully express the feelings of gratitude, love, appreciation, compassion, tenderness, etc. This should not be a chitchat session—the helper is actually that person, and the active participant is asked to find a way to express what they were not able to express previously. The helper is asked to listen, receive the expression and, at the end, express how they felt when they were listening.
      Note to the coach: expression of love and tenderness is as difficult as expressing hurt and anger. It is very important to stir the work away from chatting, giggling, joking, etc—these are ways of avoiding intimate sharing.
Section F should take 40 minutes.
   “The Room of Love”—sitting meditation and writing (Gate of Silence, Gate of the Body)
      Part I: After 10 minutes of relaxation, the coach guides participants to bring into their emotional center, the “room of love,” a few people that they feel deep love, appreciation, care, and compassion for. They are guided to feel the feelings that they feel, and to imagine what they would express to them if they could be fully open. They should do this in order—the coach gives them a few minutes of time reflecting on each person, so they should be specific. They should examine how far they're expressing their loving feelings, in words, actions, attitudes, behaviors, etc. towards these people. Out of this meditation, they should choose a couple of people to whom they would like to be able to express their love in a freer way. At the end, the coach gives participants a few minutes to return to a normal state.
      Part II: Writing. Participants should choose 3 people and write a short letter to them expressing their feelings of love, appreciation, care, tenderness, etc. They should be specific to each person, detailing the ways in which they appreciate and care for this person.
Section G should take 1 hour.
   Presentation and discussion (Gate of Dialogue)
      This presentation and discussion covers the 10—Commandments of Successful Communication. The coach takes each one of the commandments, explains it, and provides examples using participants who volunteer. The coach should make sure that the group understands what works and what does not work, and the best way and the bad way. Then, the coach opens the floor for sharing and discussion.
Section H should take 30 minutes.
   Closing circle (Gate of the Body, Gate of Dialogue)
      Part I: Improvisational dance. The whole group moves together to music that is selected by the group.
      Part II: While moving, each participant finds a way to express final words and impressions about the experience they had in the workshop. The closing circle ends in a “group hug.”
Mid-Level Workshop: Authoring Your Life/The Leader Within (3-day weekend workshop)
   The goals of this workshop are:
1. To cultivate the ability to see our life story from different perspectives so that we're not attached to the one or two interpretations/versions that we're currently holding onto.
2. To realize that life can be seen differently and we can choose the way we view our lives which means that we can choose the inspiring and empowering version and author the future accordingly as leaders who are responsibly embarking on a journey of transformation and growth.
I. Homework Thinking Assignment (please take notes)
1. Find a myth with a hero, male or female, that you identify with, and bring it to the workshop in its original form or, if that is unavailable, take notes of the storyline as you remember it.
2. Think of the story of your life as a myth.
II. Homework Writing Assignment:
   Write the story of your life, but write down only the facts or bare bones. For example, “I was born in New York on (date) in (hospital) to (names of parents),” etc. No comments, interpretations, or flourishes. Note in your fact list at least five important “crossroads” or changes or choices. You will be using the same facts with different interpretations.
III. Bringing Assignment:
   Bring five objects that symbolize the five important crossroads/choices/changes.
IV. Workshop Structure:
   The workshop will include meditations, movement exercises, and sharing, but writing is a major part in this workshop. It will follow a similar structure to other workshops—introduction; meditation followed by sharing; each of the two mornings will have a movement exercise; on the third day there is a creative art project. The workshop will conclude with a final storytelling of the final version, with other participants being part of each person's story.
   Note to coach: There are several important elements that need to be covered.
I. Participants will share the myth they chose, as well as why they chose it and how they see themselves in it. They will also throughout the workshop use the “bones” structure of their life story to write it from six different perspectives. It will include the past and the future. Each time they write a story, they will share the story itself, and how they feel about their life as they're looking at it from the specific perspective. They will get feedback from other participants as to how they are perceived by others when they tell the story from that perspective.
   The six perspectives:
1. The Victim
2. The Survivor
3. The Warrior
4. The Hero
5. The Sage
6. The Leader
II. The idea of the archetypes within oneself will be discussed. The archetypes are “colors” within one's being, tendencies that helping us to learn to become whole. We all have a certain number of archetypes within our essence, and it is helpful to identify them and understand their benefits and effects on our journey.
   Examples of archetypes: The Mother, The Artist, The Mystic, The Prostitute, The Saboteur, The Warrior, The Monk, etc. Each participant will have the time and opportunity to meditate on the possible archetypes within their psyche, and how these connect to their life story.
III: The choice of viewing your life from the point of view of the leader is most important for this workshop; everything leads to that, and the final ritual/storytelling is a declaration by each participant of recognizing themselves as a leader that is creating their own life.
End-of-level Workshop: Life as a Contribution (2-day weekend workshop)
   Goal: To be able to take on major projects that reflect your contribution in the world, and follow through with them, learning to inspire, engage, and enroll other people in your vision and organize creative and productive ways of realizing your vision.
I. Homework Assignment (please take notes)
1. Choose the project that you're committing to, and write down your plan of accomplishing it in details. Explain your vision, your mission statement, and the goals you want to achieve. Then, break down the steps in as much detail as possible, and be ready to present it to the group and inspire other people with your vision.
   Note to coach: This workshop is different from all other workshops. There is some time for meditations, discussions, and sharing, but the most important element of the workshop is for participants to share their project and vision with others, create teams, and begin to actualize their plans. They should assume the leadership position in their own project, and other positions in someone else's vision.
   Day 1: Participants will be sharing their ideas of the project they chose, one by one, and getting feedback from the group as well as some time for open discussion. They will need to pitch their idea in such a way that would move, inspire, and enroll others to join their team. They present the vision, goals, the importance, and the benefits of their project, as well as the details, choices, and steps of their plan of action. After each presentation, there will be an election of team members and their roles. By the end of Day 1, all participants should have presented their ideas and accomplished enrolling their team.
   Day 2: Teams come together to work on the details of the plans. The second part of the day is presentations by the teams to other teams, and discussion and feedback. The last part of the day is to elect the Leaders' Round Table—a team of leaders who support all projects. These leaders are at the head of the whole group. The time limit for projects should be about 3 months. If more time is needed, a discussion with the Round Table would be facilitated. Every 3 months, there should be an election for the Round Table leaders. The idea is to give as many people the opportunity to be leaders of leaders.
   From here on, the participants are leaders. They assist the coaches in the curriculum. They cannot be a coach because the coaches are certified psychotherapists, but they can teach certain courses and classes. They keep meeting once a week and create their own self-growth project-oriented group.

I claim:

1. A curriculum and method for self-transformation and self-actualization comprising a body of information, processes and exercises that cover several of life's most important aspects, called gates, comprising gates of the body, of emotions, of dialog, of creative expression, of life path, of silence, and of knowledge and each gate provides a series of processes and exercises that deepen the awareness of that aspect and its potential to promote well-being, the method serves to identify, understand, and release feelings, attitudes, behaviors, habits, and beliefs that diminish inner power and wholeness, and having a purpose to identify, understand, and reclaim feelings, attitudes, behaviors, habits and beliefs that enhance inner power and wholeness.

2. A method as in claim 1 wherein the psyche is divided into three aspects referred to as the Emotional Self, the Defensive Self, and the Expanded Self, and the processes and exercises of the method provide guidance in harmonizing and strengthening the self through understanding of these three parts of the psyche and their relationship to each other.

3. A method as in claim 1 wherein the gate of the body comprises exploring the body, its expression and its energetic patterns through different processes and exercises.

4. A method as in claim 1 wherein exercises in the gate of emotions encourage emotional openness, integration and expression.

5. The method of claim 1 wherein the gate of dialog is used to explore the importance of relating consciously and constructively with oneself, others, and living things.

6. A method as in claim 1 wherein the gate of creative expressions is used to develop creative and expressive abilities, using movement, sound, writing, drawing and other forms of creating art to express and explore important life themes.

7. A method of claim 1 wherein the gate of life path is intended to support the process of finding a personal life path and guides an individual in creating a clear vision, leading to steps to make choices leading to commitments and actions.

8. The method of claim 1 wherein the gate of silence helps to emphasize the importance of learning how to be truly silent, and comprising different kinds of meditations and silent processes to train the mind to let go.

9. A curriculum and method for self-transformation and self-actualization comprising a body of information, processes and exercises that cover several of life's most important aspects, comprising gates of the body, of emotions, and of dialog, and each gate provides a series of processes and exercises that deepen the awareness of that aspect and its potential to promote well-being, the method serves to identify, understand, and release feelings, attitudes, behaviors, habits, and beliefs that diminish inner power and wholeness, and having a purpose to identify, understand, and reclaim feelings, attitudes, behaviors, habits and beliefs that enhance inner power and wholeness.

10. A method as in claim 9 wherein the gate of the body comprises exploring the body, its expression and its energetic patterns through different processes and exercises.

11. A method as in claim 9 wherein exercises in the gate of emotions encourage emotional openness, integration and expression.

12. The method of claim 9 wherein the gate of dialog is used to explore the importance of relating consciously and constructively with oneself, others, and living things.

13. A curriculum and method for self-transformation and self-actualization comprising a body of information, processes and exercises that cover several of life's most important aspects, comprising gates of creative expression, of life path, and of silence, and each gate provides a series of processes and exercises that deepen the awareness of that aspect and its potential to promote well-being, the method serves to identify, understand, and release feelings, attitudes, behaviors, habits, and beliefs that diminish inner power and wholeness, and having a purpose to identify, understand, and reclaim feelings, attitudes, behaviors, habits and beliefs that enhance inner power and wholeness.

14. A method as in claim 13 wherein the gate of creative expressions is used to develop creative and expressive abilities, using movement, sound, writing, drawing and other forms of creating art to express and explore important life themes.

15. A method as in claim 13 wherein the gate of life path is intended to support the process of finding a personal life path and guides an individual in creating a clear vision, leading to steps to make choices leading to commitments and actions.

16. The method as in claim 13 wherein the gate of silence helps to emphasize the importance of learning how to be truly silent, and comprising different kinds of meditations and silent processes to train the mind to let go.

17. A method for self-transformation and self-actualization referred to as the gate of the body for becoming aware of one's relationship to their body, and where the individuals take some time to look at themselves to notice feelings, judgments, comments and beliefs about various parts of the body, and wherein individuals write and review a list of comments and feelings they have discovered and experienced, and wherein memories that are connected with any parts of the body are explored in a guided imagery exercise, and learn to feel and understand unresolved experiences and difficult feelings with regard to the body, and to release and reorganize emotional/physical map of stresses through the work with the body, and exploring patterns of breath.

18. A Method as in claim 17 wherein the understanding of the body/mind/emotion connection is experienced through a six-layer meditative body scan including six components: physical/energetic sensations, colors, images, feelings, memories, insights, and an internal journey is followed to reveal and resolve conscious and unconscious material.

19. A method as in claim 17 for self-transformation and self-actualization comprising a body of information, processes and exercises to help identify and understand one's emotions, to gain the capacity to experience, explore and express them and to experience emotions as a guiding tool in understanding one's healthy needs and ways to fulfill them, there being seven primary emotions of which three are dark emotions, three are light emotions and one in between is a bridge emotion, a person is to describe the experience of each one of the seven emotions, where in the body they feel each one of the emotions, when and how does each of the emotions arise or expressed, and what is the influence of each emotion on one's life.

20. A method as in claim 17 wherein the three dark emotions are fear, pain and anger, the bridge between the dark and the light is the emotion of need, and three light emotions are love, joy and peace.

21. A method as in claim 17 for analyzing emotions and which emotions comprise dark emotions of fear, pain, anger, and a bridge emotion of need, and three light emotions of love, joy and peace, comprising the steps of:
writing a personal description of each one of these seven emotions using five categories give an examples for each including describing the experience of each one of the seven emotions, where in the body do they feel each one of the emotions, when does each of the particular emotions arise for them, how does one expresses each emotion and what is the influence and effect of each emotion on each person's life, of an emotional guided imagery process wherein one visits each one of the seven emotions as if visiting a room within the body/mind in order to experience, explore, and express the emotional elements present, and further comprising
creating words, sounds, gestures or sentences describing each one of the emotions, and each person choosing one easiest emotion and one hardest or most difficult emotion, and further comprising writing which ones of the seven emotions are the most difficult for them to experience and why,
keeping a daily journal entries about one's emotions and the effect of each emotion on their daily life,
and noticing fear, pain, or anger in all of one's different shades and degrees and to try as much as possible to feel them rather than masking, denying or escaping them.

22. A method as in claim 13 wherein participants categorize needs under physical, emotional, professional/educational, fun/adventurous, spiritual, and other, and to differentiate which ones of their needs they respect, honor and fulfill, and which ones they neglect, ignore and deny, and further to identify reasons why they respect certain needs and do not respect others.

23. A method as in claim 13 wherein two or more participants share their answers to what I need most from myself is, what I need most from others is, and the ways I can take care of these needs are.

24. A method as in claim 13 wherein participants describe the moments, relationships, and situations in which they have experienced and expressed the light emotions of love, joy and peace, and to describe how they are denying, masking or avoiding feelings, and how the feelings affect their lives.

25. A method as in claim 13 wherein participants detail one to three extremely traumatic events in their life and the effects of these on their present selves, further comprising a process wherein participants are helped by two other participants who personalize for them and with them the three aspects of the self facilitating a confrontation with and the resolution of a traumatic event by rotating the three aspects

26. A method as in claim 13 wherein participants achieve balance within the three inner aspects by dramatizing with the help of two other people the inner conflict between the negative voice of the defensive self and its effects on the emotional self, learning to create a positive intervention of the expanded self to harmonize the three aspects, further involving a healing loving dialogue with the help of two others where the participant embodies their emotional self and the two helpers represent the two sides of the participant's Expanded Self 1) healing voice and 2) the witness, in a process assisting the well being of the emotional self.

27. A method as in claim 17 for self-transformation and self-actualization comprising a body of information, processes and exercises to better understand one's emotional self, defensive self and expanded self, and be able to distinguish and recognize between them and become aware of which one of the three is the main one that the person is operating from, and each person creates a triangle with expanded self at the top of the triangle and defensive and emotional self facing each other at the bottom of the triangle, and each person is asked to notice the pattern of thoughts, feelings, attitudes, outlook, the way the body feels, the breath and the way that one self feels towards and relates to the other two, and further to become aware of unhealthy and destructive patterns of inner dialog that one is operating from,
via a process where a participant with two other helpers dramatize all three aspects of their self, switching roles to embody each of the three aspects, in order to become clear about the dialogue,
further involving a dialogue where a participant is embodying their expanded self, and with the help of two other people learns to create a constructive dialogue between the emotional self, the defensive self, and the expanded self,
and by doing so getting the skill to create new inner dialog and new patterns of inner-relating and wherein there are several different levels of inquiry that support developing, healing and strengthening healthy relationships with one's self and others.

28. A method as in claim 17 wherein participants study and practice the Ten Commandments of Effective Communication, consisting of 1) committing to creating successful dialogue; 2) being with one's reactions; 3) right time, right place; 4) speaking using the four magic I's; 5) asking to be mirrored; 6) inviting one's partner to share; 7) mirroring one's partner; 8) complete communication; 9) sitting in silence; and 10) creating new possibilities.

29. A method as in claim 17 wherein participants choose a charged situation in their life and try to view it from the emotional self, the defensive self and the expanded self, by way of a study of how each aspect relates to the situation, and doing so with the help of two others who help the participant embody the three aspects and by rotation become aware of the conversations and attitudes of each self towards the situation in order to realize the most constructive and effective way to resolve the situation.

30. A method as in claim 13 for self-transformation and self-actualization comprising a body of information, processes and exercises for one to cultivate the ability to create and express, through the fusion of written word, music, art, movement, sounds, and/or any other creative elements, in order to learn to use creativity and expression to enhance well-being and relationships and to contribute constructively to life projects, and to understand relationships with others, with a spiritual being and physical and material structure of life by exploring a specific theme through a created project in order to achieve a greater understanding of the theme and sense of transformation, and to explore the three steps of transformation namely, clearing, being, and creating through creative expression, to see magic moments and commit to happiness in everyday life by staying focused, taking action, and observing the following areas of life:
the inner relationships between the emotional, the defensive and the expanded self,
relationships with others,
relationships to what everyone sees as the greater source of things,
the way one expresses oneself through talents and skills,
the physical material structure of life,
the way one expands one's education and new learning,
the way one enjoys playtime, adventure, fun, and one's creativity.

31. A method as in claim 13 for self-transformation and self-actualization comprising a body of information, processes and exercises for one to understand the concept of a life path by listing one's talents, gifts, natural tendencies, things that move them, give them joy and/or create a sense of fulfillment and mission for them, and to identify important lessons they feel that have learned, are learning and/or still need to learn, and to examine their past, their anticipated future, examine the most important elements one feels they must have, achieve, develop, become and/or explore, and to consider the steps needed to be taken in order to begin to actualize a high vision of commitments, choices and/or actions, and to consider areas of life within which they feel most stuck in terms of achieving their highest vision and/or being able to follow their goals.

32. A method as in claim 13 for self-transformation and self-actualization comprising a body of information, processes and exercises to understand the concept of silence by learning to relax the body and to quiet the mind, to learn to focus on the breath, to cultivate the ability to witness, and practice meditative mind in daily life and understand the attributes of a peaceful state of mind, naming acceptance, releasing and receiving, gratitude, surrender, forgiveness, stillness and oneness by means of specific visualizations and meditations by participants being asked to bring themselves into a meditative space, and coaching them through a relaxation of the body, and the participant's writing about their experiences, including a movement/feeling/sound meditation called “Becoming All Things” in which participants practice shifting rapidly from one element to another, becoming the elements that are suggested, and a feeling meditation called “the Garage Sale of the Mind” in which participants bring forth negative emotional memories, feelings, and thoughts from their inner storage in a process that helps them release, express, forgive and resolve, and an emotional visualization called “Melting the Knots” in which participants notice several chronic tensions in the body/mind/feelings and are encouraged to visualize the tensions as dark ropes tightening that area, and, identifying the ropes and the feelings present within the area, participants visualize the ropes melting and a dark water seeping down and disappearing, allowing the feeling to be freely experienced, dealt with, and resolved, and by participants writing and sharing about their experience.

33. A method as in claim 13 wherein participants explore the freedom and spontaneity of creating expression through a series of group improvisations comprising of playful dramatization of how the 3 selves of each individual interact with those of the other participants, in order to study the social and communal impact of each self.

34. A method as in claim 13 wherein participants explore their Essence, defined as the authentic self (Emotional Self and Expanded Self), as opposed to their Masks (Defensive Self), defined as the face they present to the world for means of survival and in order to be accepted and/or appreciated, by means of creating two physical masks and presenting to the group the masks and their intentions, the emotions behind the masks, and the spiritual intention that is behind the emotion, for the purpose of eventually being able to let the masks go and be able to relate from the authentic self.

35. A method as in claim 32 wherein participants explore their whole life past, present, and future by means of specific meditative visualizations in which they revisit their life in sections of 7 years each for the purpose of identifying the most life- and self-defining situations, people, events, and experiences, in order to understand how their psychological structure was formed and what they need to undo to create the future that they visualize, and taking notes at all the stations within the sections, and incorporating additional healing meditations and inner dialogues to help resolution of each section, and creating a 2- or 3-dimensional creative representation of their life path and a vision board to represent their future.

36. A method as in claim 32 wherein participants write their guidelines for charting the future including their personal ten commandments relating to the ten most important elements or personal governing principles that the participant feels they must be, have, achieve, develop, become, explore and do, informed by their highest vision of themselves and their future, and upon completion of these ten elements, choosing specific present goals, choices, commitments, and actions to manifest their vision.

37. A method as in claim 32 wherein participants claim inner authority over areas of life that feel stuck or unworkable by means of emotional meditation and confrontations with that area inside of themselves with internal dialogues or dialogues with other members in the group, in order to create breakthroughs.
